(19) United States
(12) Patent Application Publication
(10) Pub. No.: US 2003/0055769 A1
(43) Pub. Date: Mar. 20, 2003

(54) System, method and article of manufacture for a library-based hardware configuration service

(76) Inventor: Daryl RuDusky, Campbell, CA (US)

Correspondence Address: C. Douglas McDonald, Esq., Carlton Fields, et al., P.O. Box 3239, Tampa, FL, 33601-3239, US

(21) Appl. No.: 09/791,241

(22) Filed: Feb. 23, 2001

(51) Int. Cl. G06F 17/60

(52) U.S. Cl. 705/37

(57) ABSTRACT

A system, method and article of manufacture are provided for generating revenue by charging for access to a library having a pre-compiled hardware configuration module therein. A plurality of hardware configuration modules are stored in a library. A customer is prompted for hardware configuration criteria, which can include such things as desired functionality, a desired clock speed, a price, a description of an I/O or other device that will be attached to the hardware to be configured, etc. The selected module is sent to the customer. The customer is charged an amount of money.

### FIELD OF THE INVENTION

The present invention relates to a business method for providing hardware configuration data and more particularly to generating revenue by charging a fee for providing hardware description modules.

### BACKGROUND OF THE INVENTION

In traditional IC design flows, designers rely on a hardware description language (HDL) such as Verilog or VHDL to build structural representations of circuits. However, the industry has been slow to achieve its full potential primarily due to difficulties in using proprietary technology in complex design work. For high-integration designs such as System-on-Chips (SoCs), designers face a challenge in completing the required interfaces between the proprietary technology and the rest of their design. Rather than spending time designing commodity functions, they find themselves spending time integrating proprietary technology blocks into system designs. To address this problem, industry groups such as the Virtual Socket Interface Alliance (VSIA) as well as individual proprietary technology providers are offering standard interface protocols intended to offer an interface roadmap for proprietary technology developers and a simplified integration task for proprietary technology users.

More recently, the emergence of C-based design methods has introduced an important new element in the proprietary technology supply chain. With these design methods, developers work at a higher level of abstraction-using C-based languages to describe functions at the algorithmic rather than structural level. Nearly all these methods require designers to complete work at the structural level by converting C-based code to HDL-level designs. After completing functional design using C-based descriptions, designers using those methods need to work with corresponding HDL-level representations of their designs to complete their work. The need to switch between these markedly distinct levels abrogates the advantages gained in using a high-level language early in design.

What is needed is a methodology that facilitates design development by making technology modules that are useful for hardware design readily available to designers and other consumers. What is also needed is a way to provide design flexibility to consumers who are not skilled in hardware design. Further, there is a need for allowing selection of a hardware configuration and corresponding configuration of the hardware.

### SUMMARY OF THE INVENTION

A system, method and article of manufacture are provided for generating revenue by charging for access to a library having a pre-compiled hardware configuration module therein. A plurality of hardware configuration modules are stored in a library. A customer is prompted for hardware configuration criteria, which can include such things as desired functionality, a desired clock speed, a price, a description of an I/O or other device that will be attached to the hardware to be configured, etc. A module is selected from the library based on the criteria. The selected module is sent to the customer over a network, on a disc, etc. The customer is charged an amount of money for the module. This amount may also include royalties, etc. Note that the “module” can include any portion up to and including the entire instruction set necessary to completely configure/reconfigure hardware, or any portion thereof.

In one aspect of the present invention, the listing also includes modules stored in additional libraries. The customer can be a contractor using the module to generate a hardware description. The customer can also be a reseller of hardware configuration modules. The customer can be allowed to submit a bid price for the module in an auction-type system. As an option, the bid can be submitted to an auction system that is managed by a third party such as eBAY™.

As an option, a listing of modules stored in the library can be provided to the customer. The customer is then allowed to select the module from the list. As another option, the customer is prompted for further criteria if multiple modules match the criteria. Preferably, the customer is allowed to select multiple modules, where the user is prompted for further criteria for selecting one of the multiple modules. A help function can be provided.

### BRIEF DESCRIPTION OF THE DRAWINGS

The invention will be better understood when consideration is given to the following detailed description thereof. Such description makes reference to the annexed drawings wherein:

FIG. 1 is a schematic diagram of a hardware implementation of one embodiment of the present invention;

FIG. 2A illustrates a while construct and a do while construct according to an embodiment of the present invention;

FIG. 2B depicts an illustrative design flow according to one embodiment of the present invention;

FIG. 2C illustrates a process for configuring a device according to user-input/user-selected parameters;

FIG. 2D depicts a process for configuring a device according to user-input information;

FIG. 2E illustrates a process for providing one or more modules conforming to a hardware design specification;

FIG. 2F illustrates a system for generating revenue by providing hardware configuration-related services;

FIG. 2G illustrates a process for conducting an auction for a hardware configuration module utilizing a network;

FIG. 2H depicts a process for conducting a network-based reverse-auction for a hardware configuration module;

FIG. 2I illustrates a process for generating revenue by charging for access to a library having a pre-compiled hardware configuration module therein;

FIG. 2J depicts a process for providing hardware configuration data for generating revenue;

FIG. 2K depicts a process for providing a hardware configuration module for generating revenue;

FIG. 3A is a flow diagram of a process for providing an interface for transferring configuration data to a reconfigurable logic device;

FIG. 3B depicts a display according to an exemplary embodiment of the present invention;

FIG. 4 illustrates an illustrative procedure for initiating a reconfigurable logic device according to the illustrative embodiment of FIG. 3B;

FIG. 5 depicts a process for using a reconfigurable logic device to place a call over the Internet according to the illustrative embodiment of FIG. 3B;

FIG. 6 illustrates a process for answering a call over the Internet;

FIG. 7 depicts a configuration screen for setting various parameters of telephony functions according to the illustrative embodiment of FIG. 3B;

FIG. 8A depicts an illustrative screen displayed upon reconfiguration of a reconfigurable logic device according to the illustrative embodiment of FIG. 3B;

FIG. 8B depicts a process for providing a user interface for a decoder of audio data in the MPEG 1 Layer III (MP3) format;

FIG. 8C illustrates a process for decoding compressed audio data according to an embodiment of the present invention;

FIG. 8D illustrates the discrete modules and data flow in an MP3 decoder according to a preferred embodiment of the present invention;

FIG. 8E shows sample code for the implementation of the memory-mapped hardware control;

FIG. 8F illustrates a system for encoding (compressing) audio data;

FIG. 9A depicts a process for providing a hardware-based reconfigurable multimedia device;

FIG. 9B is a diagrammatic overview of a board of the resource management device according to an illustrative embodiment of the present invention;

FIG. 10 depicts a JTAG chain for the board of FIG. 9B;

FIG. 11 shows a structure of a Parallel Port Data Transmission System according to an embodiment of the present invention;

FIG. 12 is a flowchart that shows the typical series of procedure calls when receiving data;

FIG. 13 is a flow diagram depicting the typical series of procedure calls when transmitting data;

FIG. 14 is a flow diagram illustrating several processes running in parallel;

FIG. 15 is a block diagram of an FPGA device according to an exemplary embodiment of the present invention;

FIG. 16 is a flowchart of a process for network-based configuration of a programmable logic device;

FIG. 17 illustrates a process for remote altering of a configuration of a hardware device; and

FIG. 18 illustrates a process for processing data and controlling peripheral hardware.

### DETAILED DESCRIPTION OF THE PREFERRED EMBODIMENTS

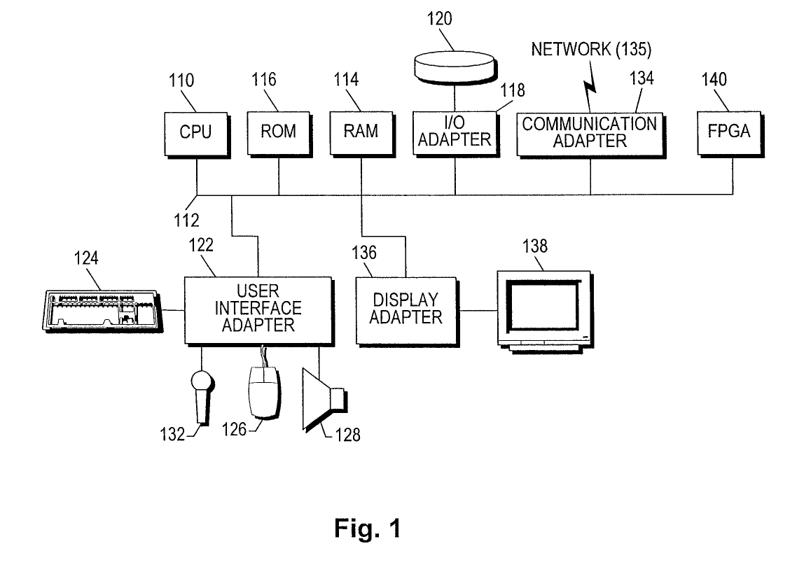

A preferred embodiment of a system in accordance with the present invention is preferably practiced in the context of a personal computer such as an IBM compatible personal computer, Apple Macintosh computer or UNIX based workstation. A representative hardware environment is depicted in FIG. 1, which illustrates a typical hardware configuration of a workstation in accordance with a preferred embodiment having a central processing unit 110, such as a microprocessor, and a number of other units interconnected via a system bus 112. The workstation shown in FIG. 1 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 128, a microphone 132, and/or other user interface devices such as a touch screen (not shown) to the bus 112, communication adapter 134 for connecting the workstation to a communication network (e.g., a data processing network) and a display adapter 136 for connecting the bus 112 to a display device 138. The workstation also includes a Field Programmable Gate Array (FPGA) 140 with a complete or a portion of an operating system thereon such as the Microsoft Windows NT or Windows/98 Operating System (OS), the IBM OS/2 operating system, the MAC OS, or UNIX operating system. Those skilled in the art will appreciate that the present invention may also be implemented on platforms and operating systems other than those mentioned.

A preferred embodiment of the present invention utilizes a configurable hardware device such as a Field Programmable Gate Array (FPGA) device. Examples of such FPGA devices include the XC2000™ and XC3000™ families of FPGA devices introduced by Xilinx, Inc. of San Jose, Calif. The architectures of these devices are exemplified in U.S. Pat. Nos. 4,642,487; 4,706,216; 4,713,557; and 4,758,985; each of which is originally assigned to Xilinx, Inc. and which are herein incorporated by reference for all purposes. It should be noted, however, that FPGA's of any type may be employed in the context of the present invention.

Examples of such FPGA devices include the XC2000™ and XC3000™ families of FPGA devices introduced by Xilinx, Inc. of San Jose, Calif. The architectures of these devices are exemplified in U.S. Pat. Nos. 4,642,487; 4,706,216; 4,713,557; and 4,758,985; each of which is originally assigned to Xilinx, Inc. and which are herein incorporated by reference for all purposes. It should be noted, however, that FPGA's of any type may be employed in the context of the present invention.

An FPGA device can be characterized as an integrated circuit that has four major features as follows.

(1) A user-accessible, configuration-defining memory means, such as SRAM, PROM, EPROM, EEPROM, anti-fused, fused, or other, is provided in the FPGA device so as to be at least once-programmable by device users for defining user-provided configuration instructions. Static Random Access Memory or SRAM is of course, a form of reprogrammable memory that can be differently programmed many times. Electrically Erasable and reprogrammed ROM or EEPROM is an example of nonvolatile reprogrammable memory. The configuration-defining memory of an FPGA device can be formed of mixture of different kinds of memory elements if desired (e.g., SRAM and EEPROM) although this is not a popular approach.

(2) Input/Output Blocks (IOB's) are provided for interconnecting other internal circuit components of the FPGA device with external circuitry. The IOB's may have fixed configurations or they may be configurable in accordance with user-provided configuration instructions stored in the configuration-defining memory means.

(3) Configurable Logic Blocks (CLB's) are provided for carrying out user-programmed logic functions as defined by user-provided configuration instructions stored in the configuration-defining memory means.

Typically, each of the many CLB's of an FPGA has at least one lookup table (LUT) that is user-configurable to define any desired truth table,—to the extent allowed by the address space of the LUT. Each CLB may have other resources such as LUT input signal pre-processing resources and LUT output signal post-processing resources. Although the term ‘CLB’ was adopted by early pioneers of FPGA technology, it is not uncommon to see other names being given to the repeated portion of the FPGA that carries out user-programmed logic functions. The term, ‘LAB’ is used for example in U.S. Pat. No. 5,260,611 to refer to a repeated unit having a 4-input LUT.

(4) An interconnect network is provided for carrying signal traffic within the FPGA device between various CLB's and/or between various IOB's and/or between various IOB's and CLB's. At least part of the interconnect network is typically configurable so as to allow for programmably-defined routing of signals between various CLB's and/or IOB's in accordance with user-defined routing instructions stored in the configuration-defining memory means.

In some instances, FPGA devices may additionally include embedded volatile memory for serving as scratchpad memory for the CLB's or as FIFO or LIFO circuitry. The embedded volatile memory may be fairly sizable and can have 1 million or more storage bits in addition to the storage bits of the device's configuration memory.

Modern FPGA's tend to be fairly complex. They typically offer a large spectrum of user-configurable options with respect to how each of many CLB's should be configured, how each of many interconnect resources should be configured, and/or how each of many IOB's should be configured. This means that there can be thousands or millions of configurable bits that may need to be individually set or cleared during configuration of each FPGA device.

Rather than determining with pencil and paper how each of the configurable resources of an FPGA device should be programmed, it is common practice to employ a computer and appropriate FPGA-configuring software to automatically generate the configuration instruction signals that will be supplied to, and that will ultimately cause an unprogrammed FPGA to implement a specific design. (The configuration instruction signals may also define an initial state for the implemented design, that is, initial set and reset states for embedded flip flops and/or embedded scratchpad memory cells.)

The number of logic bits that are used for defining the configuration instructions of a given FPGA device tends to be fairly large (e.g., 1 Megabits or more) and usually grows with the size and complexity of the target FPGA. Time spent in loading configuration instructions and verifying that the instructions have been correctly loaded can become significant, particularly when such loading is carried out in the field.

For many reasons, it is often desirable to have in-system reprogramming capabilities so that reconfiguration of FPGA's can be carried out in the field.

FPGA devices that have configuration memories of the reprogrammable kind are, at least in theory, ‘in-system programmable’ (ISP). This means no more than that a possibility exists for changing the configuration instructions within the FPGA device while the FPGA device is ‘in-system’ because the configuration memory is inherently reprogrammable. The term, ‘in-system’ as used herein indicates that the FPGA device remains connected to an application-specific printed circuit board or to another form of end-use system during reprogramming. The end-use system is of course, one which contains the FPGA device and for which the FPGA device is to be at least once configured to operate within in accordance with predefined, end-use or ‘in the field’ application specifications.

The possibility of reconfiguring such inherently reprogrammable FPGA's does not mean that configuration changes can always be made with any end-use system. Nor does it mean that, where in-system reprogramming is possible, that reconfiguration of the FPGA can be made in timely fashion or convenient fashion from the perspective of the end-use system or its users. (Users of the end-use system can be located either locally or remotely relative to the end-use system.)

Although there may be many instances in which it is desirable to alter a pre-existing configuration of an ‘in the field’ FPGA (with the alteration commands coming either from a remote site or from the local site of the FPGA), there are certain practical considerations that may make such in-system reprogrammability of FPGA's more difficult than first apparent (that is, when conventional techniques for FPGA reconfiguration are followed).

A popular class of FPGA integrated circuits (IC's) relies on volatile memory technologies such as SRAM (static random access memory) for implementing on-chip configuration memory cells. The popularity of such volatile memory technologies is owed primarily to the inherent reprogrammability of the memory over a device lifetime that can include an essentially unlimited number of reprogramming cycles.

There is a price to be paid for these advantageous features, however. The price is the inherent volatility of the configuration data as stored in the FPGA device. Each time power to the FPGA device is shut off, the volatile configuration memory cells lose their configuration data. Other events may also cause corruption or loss of data from volatile memory cells within the FPGA device.

Some form of configuration restoration means is needed to restore the lost data when power is shut off and then re-applied to the FPGA or when another like event calls for configuration restoration (e.g., corruption of state data within scratchpad memory).

The configuration restoration means can take many forms. If the FPGA device resides in a relatively large system that has a magnetic or optical or opto-magnetic form of nonvolatile memory (e.g., a hard magnetic disk)—and the latency of powering up such a optical/magnetic device and/or of loading configuration instructions from such an optical/magnetic form of nonvolatile memory can be tolerated—then the optical/magnetic memory device can be used as a nonvolatile configuration restoration means that redundantly stores the configuration data and is used to reload the same into the system's FPGA device(s) during power-up operations (and/or other restoration cycles).

On the other hand, if the FPGA device(s) resides in a relatively small system that does not have such optical/magnetic devices, and/or if the latency of loading configuration memory data from such an optical/magnetic device is not tolerable, then a smaller and/or faster configuration restoration means may be called for.

Many end-use systems such as cable-TV set tops, satellite receiver boxes, and communications switching boxes are constrained by prespecified design limitations on physical size and/or power-up timing and/or security provisions and/or other provisions such that they cannot rely on magnetic or optical technologies (or on network/satellite downloads) for performing configuration restoration. Their designs instead call for a relatively small and fast acting, non-volatile memory device (such as a securely-packaged EPROM IC), for performing the configuration restoration function. The small/fast device is expected to satisfy application-specific criteria such as: (1) being securely retained within the end-use system; (2) being able to store FPGA configuration data during prolonged power outage periods; and (3) being able to quickly and automatically re-load the configuration instructions back into the volatile configuration memory (SRAM) of the FPGA device each time power is turned back on or another event calls for configuration restoration.

The term ‘CROP device’ will be used herein to refer in a general way to this form of compact, nonvolatile, and fast-acting device that performs ‘Configuration-Restoring On Power-up’ services for an associated FPGA device.

Unlike its supported, volatilely reprogrammable FPGA device, the corresponding CROP device is not volatile, and it is generally not ‘in-system programmable’. Instead, the CROP device is generally of a completely nonprogrammable type such as exemplified by mask-programmed ROM IC's or by once-only programmable, fuse-based PROM IC's. Examples of such CROP devices include a product family that the Xilinx company provides under the designation ‘Serial Configuration PROMs’ and under the trade name, XC1700D.TM. These serial CROP devices employ one-time programmable PROM (Programmable Read Only Memory) cells for storing configuration instructions in nonvolatile fashion.

A preferred embodiment is written using Handel-C. Handel-C is a programming language marketed by Celoxica Limited, 7-8 Milton Park, Abingdon, Oxfordshire, OX14 4RT, United Kingdom. Handel-C is a programming language that enables a software or hardware engineer to target directly FPGAs (Field Programmable Gate Arrays) in a similar fashion to classical microprocessor cross-compiler development tools, without recourse to a Hardware Description Language. Thereby allowing the designer to directly realize the raw real-time computing capability of the FPGA.

Handel-C is designed to enable the compilation of programs into synchronous hardware; it is aimed at compiling high level algorithms directly into gate level hardware.

The Handel-C syntax is based on that of conventional C so programmers familiar with conventional C will recognize almost all the constructs in the Handel-C language.

Sequential programs can be written in Handel-C just as in conventional C but to gain the most benefit in performance from the target hardware its inherent parallelism must be exploited.

Handel-C includes parallel constructs that provide the means for the programmer to exploit this benefit in his applications. The compiler compiles and optimizes Handel-C source code into a file suitable for simulation or a net list which can be placed and routed on a real FPGA.

More information regarding the Handel-C programming language may be found in “EMBEDDED SOLUTIONS Handel-C Language Reference Manual: Version 3,” “EMBEDDED SOLUTIONS Handel-C User Manual: Version 3.0,” “EMBEDDED SOLUTIONS Handel-C Interfacing to other language code blocks: Version 3.0,” each authored by Rachel Ganz, and published by Celoxica Limited in the year of 2001; and “EMBEDDED SOLUTIONS Handel-C Preprocessor Reference Manual: Version 2.1,” also authored by Rachel Ganz and published by Embedded Solutions Limited in the year of 2000; and which are each incorporated herein by reference in their entirety. Also, United States Patent Application entitled SYSTEM, METHOD AND ARTICLE OF MANUFACTURE FOR INTERFACE CONSTRUCTS IN A PROGRAMMING LANGUAGE CAPABLE OF PROGRAMMING HARDWARE ARCHITECTURES and assigned to common assignee Celoxica Limited provides more detail about programming hardware using Handel-C and is herein incorporated by reference in its entirety for all purposes.

It should be noted that other programming and hardware description languages can be utilized as well, such as VHDL.

Another embodiment of the present invention may be written at least in part using JAVA, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general-purpose secure communication protocol for a transport medium between the client and the Newco. HTTP or other protocols could be readily substituted for HTML without undue experimentation. Information on these products is available in T. Berners-Lee, D. Connoly, “RFC 1866: Hypertext Markup Language—2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystem's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

System Design

Handel-C, offers a significant advantage over conventional RTL-based design methods in its ability to compile Handel-C code to hardware. The Handel-C compiler converts source code into an optimized representation that can be simulated or to generate a netlist, allowing designers to use FPGA manufacturer conversion tools to produce FPGA-based hardware rapidly. The compiler generates either XNF files for Xilinx FPGAs or industry-standard EDIF netlist files for use with Xilinx or Altera devices. For designers, this unique advantage means they can efficiently create hardware without resorting to HDLs and target FPGAs for design implementation in a manner that is much faster than with alternate methods.

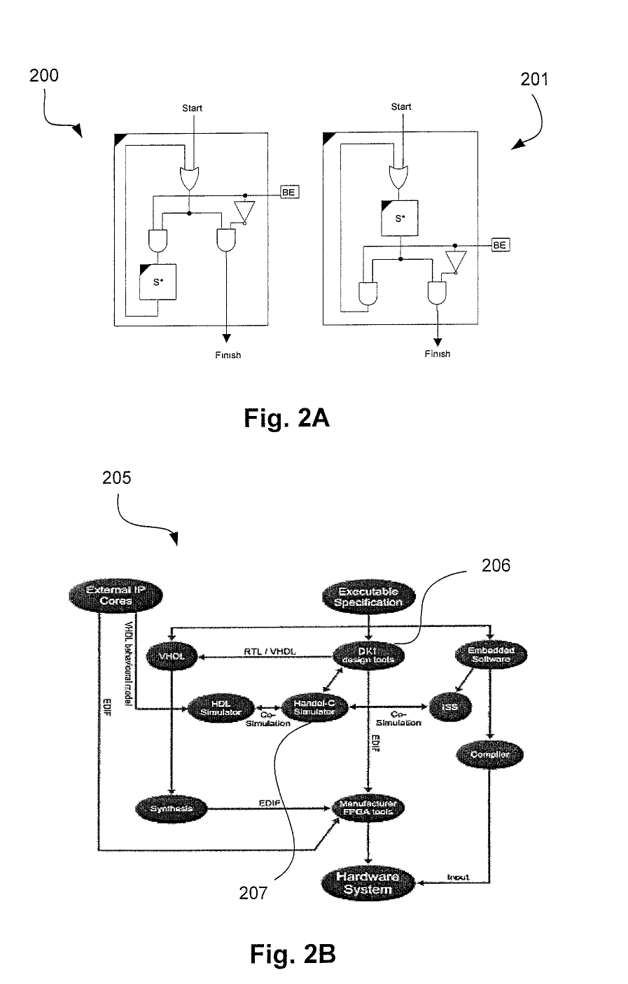

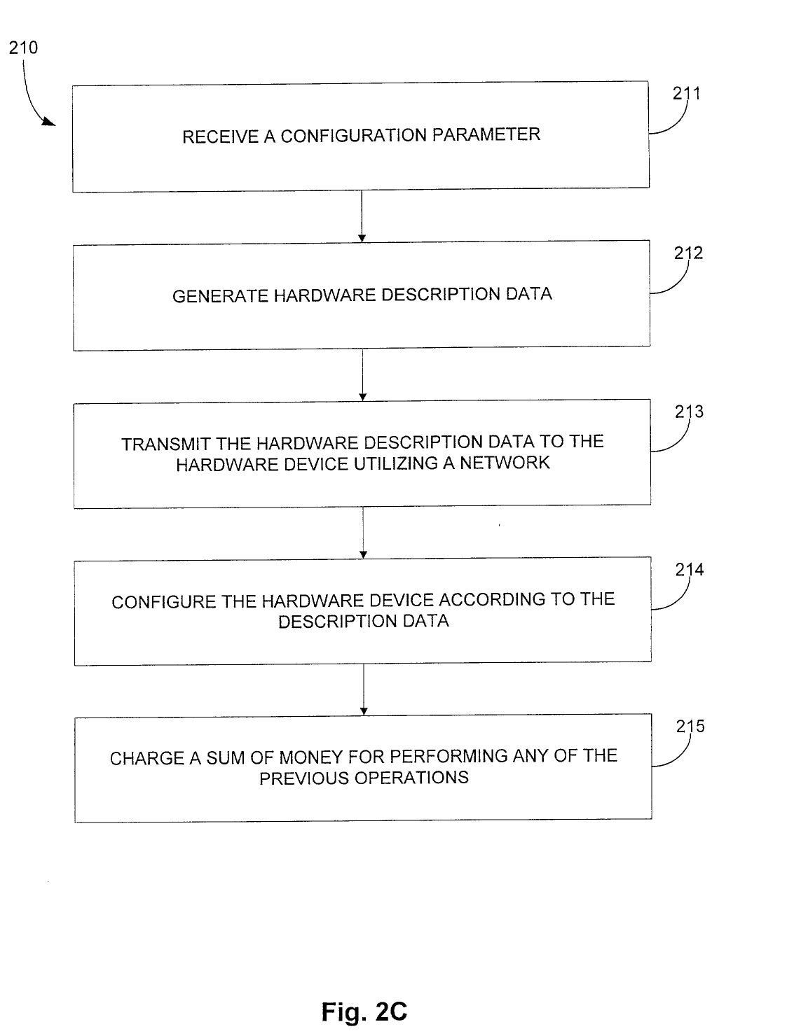

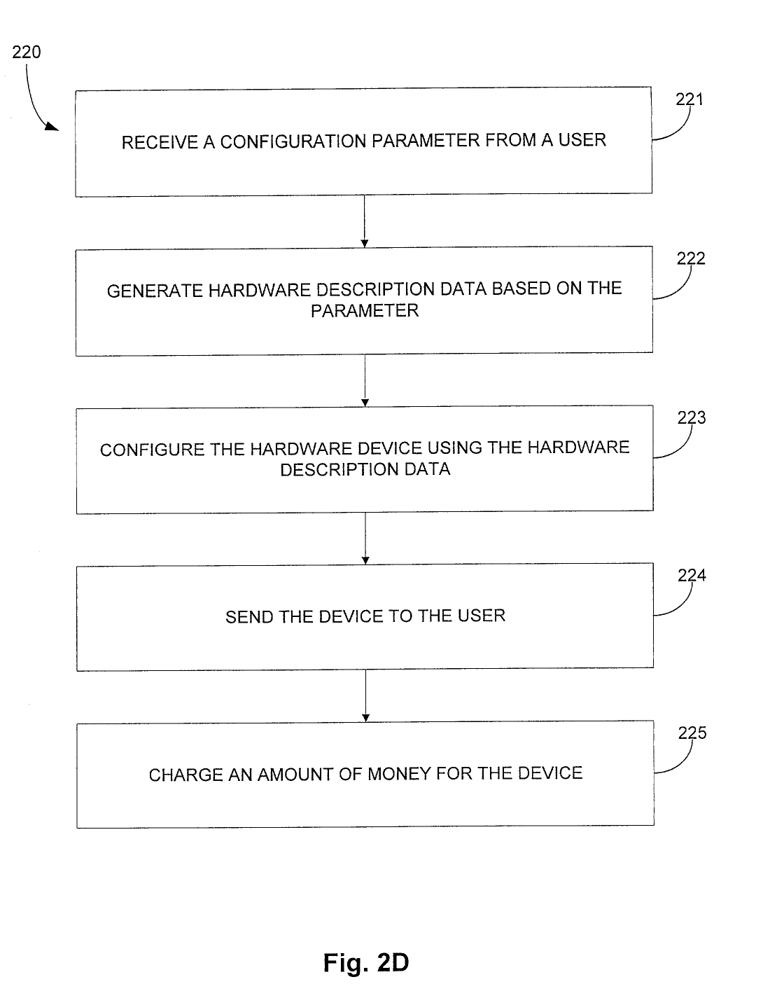

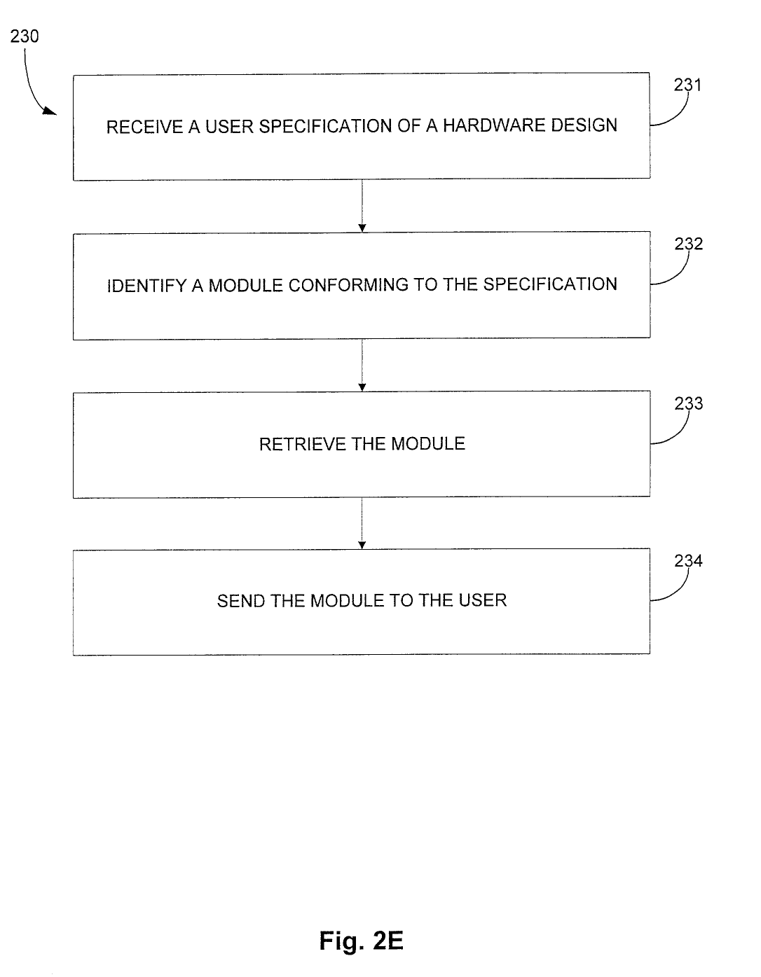

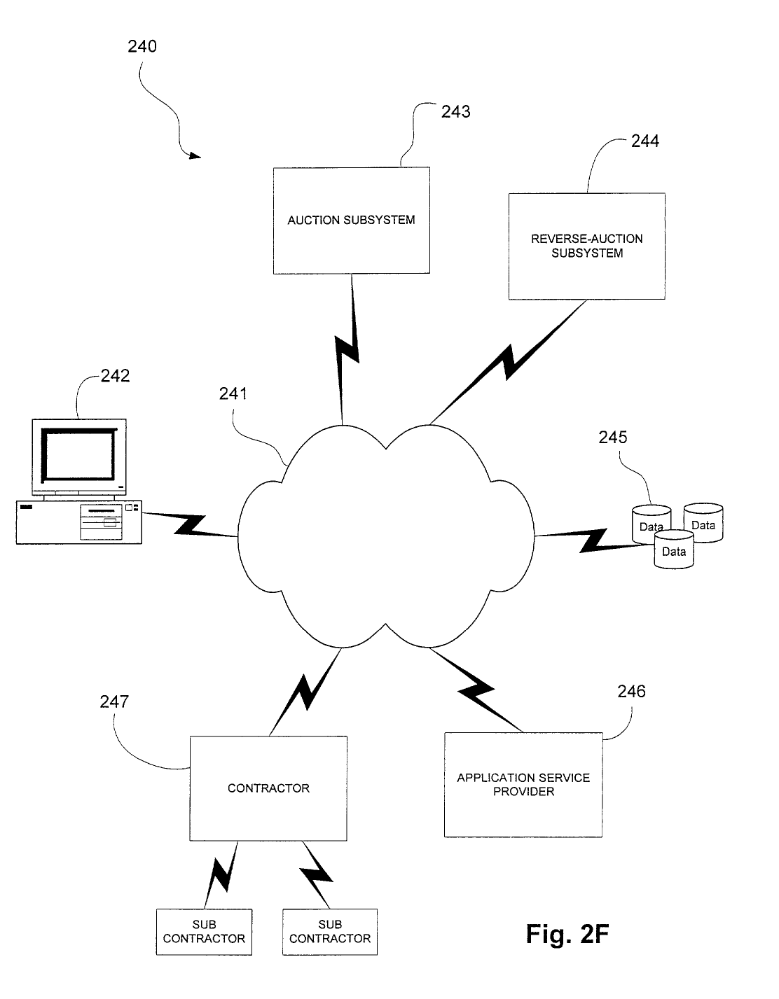

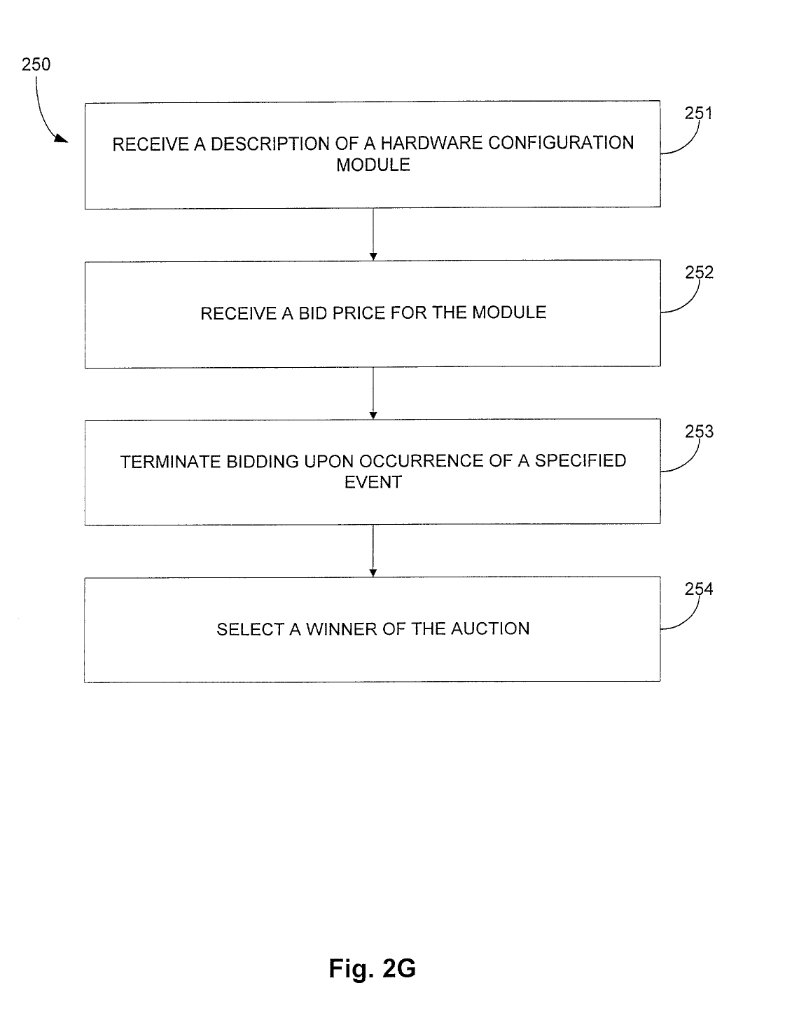

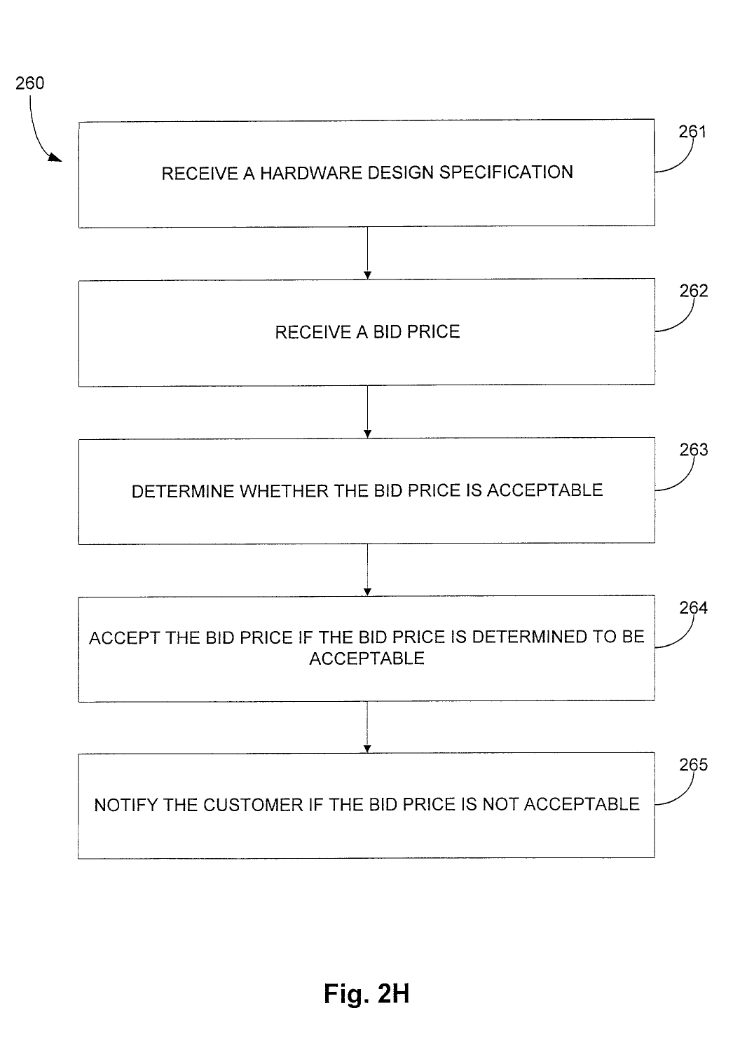

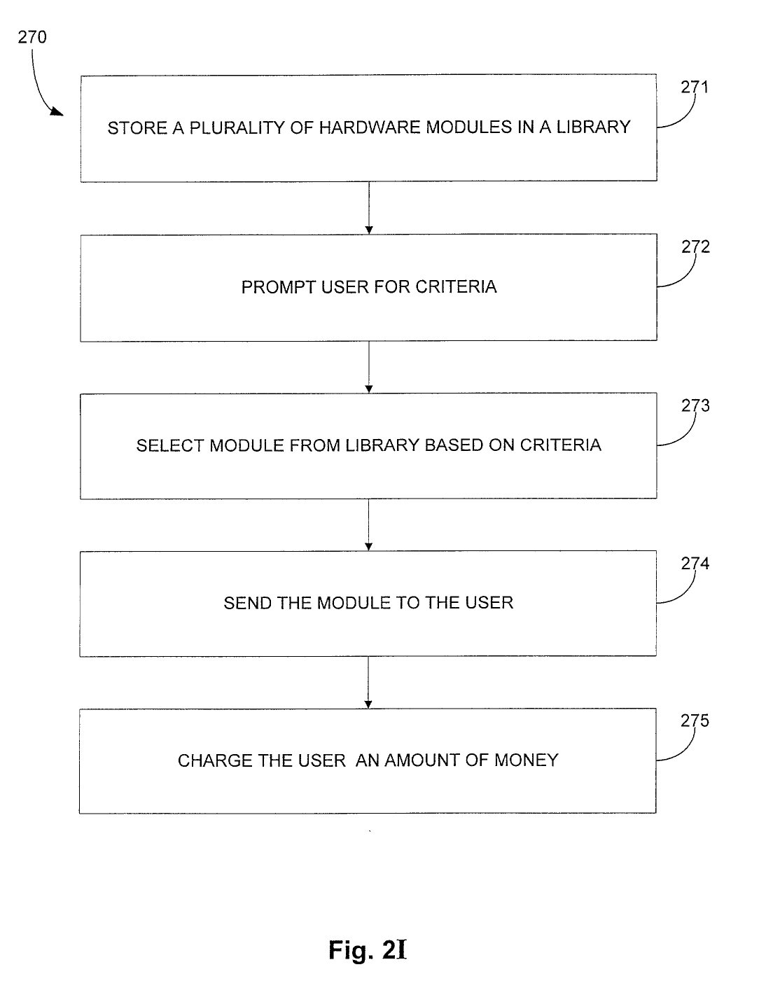

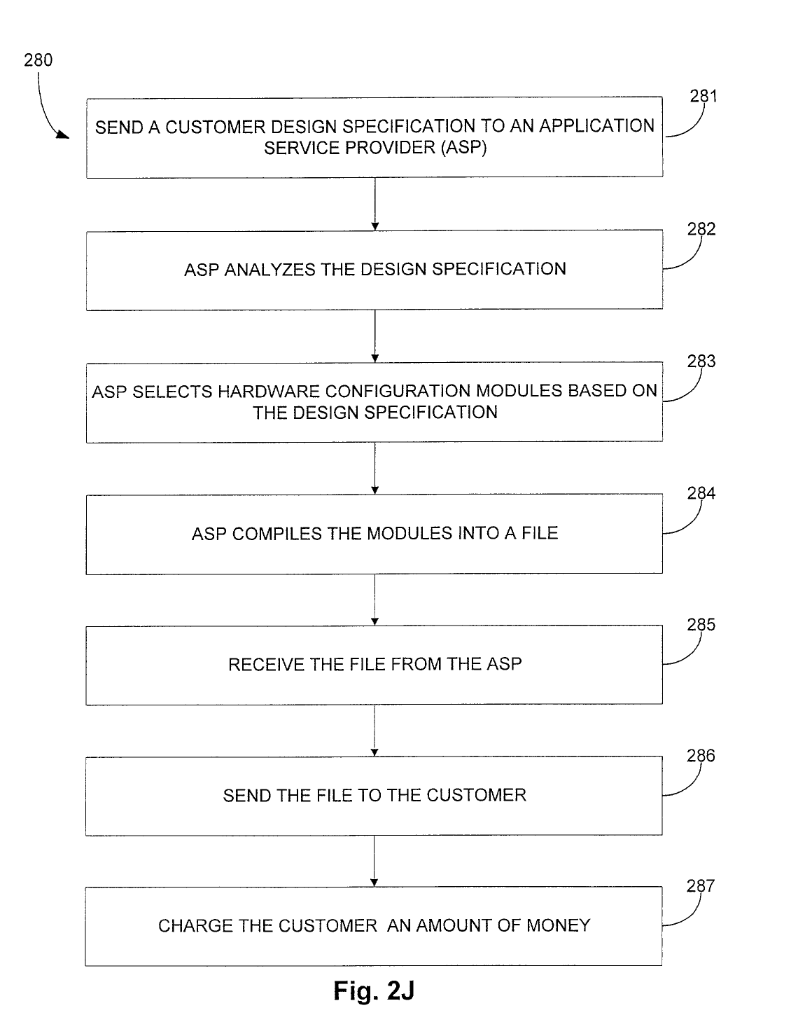

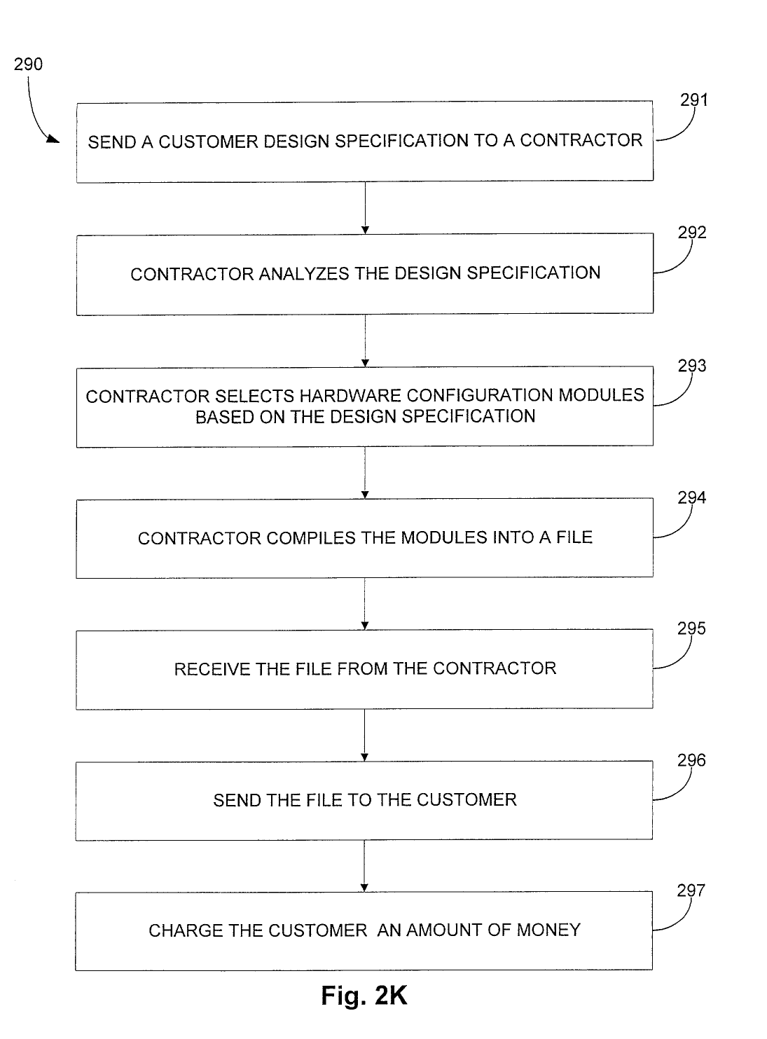

Handel-C extends ANSI/ISO-C with semantics based on Communicating Sequential Processes, which provides a formal framework that helps ensure deterministic parallel behavior. Each familiar language construct corresponds to specific logic structures generated at compile time. See FIG. 2A, which illustrates a while construct 200 and a do while construct 201. For specialized hardware concepts such as parallel data paths, designers use simple intuitive extensions such as the parallel construct par. As a result, developers design hardware using language syntax, semantics and design methods that are familiar to any C programmer.

FIG. 2B depicts an illustrative design flow 205 according to one embodiment of the present invention. Such new design flows let designers at a higher functional level by writing Handel-C functional descriptions and algorithms much as they create C software programs. Using a design environment 206, developers work with a design flow for simulation and debugging environment using methods and procedures familiar to any code developer. While the environment's simulator 207 provides fast cycle-accurate functional simulation, the debugger displays the state of each software variable—corresponding to registers in the hardware domain.

Although Handel-C relieves the strict requirement to work through the HDL level, it by no means precludes it. Handel-C's strengths for functional product design complement the strengths of HDLs for low-level interface and timing design. Indeed, these new flows allow designers to combine external technology along with Handel-C code in target designs. The design environment of the present invention supports co-simulation with both existing HDL code blocks and embedded software, permitting developers to leverage both C and HDL-based behavioral models.

For IP providers and consumers alike, C-based hardware design environments such as Handel-C and design environment 206 represent the next evolution of the IP supply chain: This new approach facilitates the creation and use of application expertise that complements the intellectual capital captured today at the logic or structural level in current technology. With this approach, developers are now able to work in an environment that lets them capture their design expertise at a higher level of abstract representation and corresponding higher productivity. In turn, these developers can release their technology developments in a form required by designers.

For consumers, C-based approaches such as Handel-C offer an important new addition to the technology source stream. Now, developers have the option to acquire not only hard and soft technology, but also technology in this new form that promises to facilitate custom extensions and features in a manner that is much more difficult to attain at the HDL level. Furthermore, within an organization, developers can share Handel-C code for hardware elements with the same ease once reserved for software code. The resulting growth of more application-level expertise made available as highly useable IP promises to further accelerate designers' abilities to deploy hardware rapidly, while using these C-based approaches to dramatically differentiate that hardware.

It is also important to note that Handel-C uses successive compilation and parameterization of variables to allow the creation of portable modules, as set forth below.

Product Fulfillment

FIG. 2C illustrates a process 210 for configuring a device according to user-input/user-selected parameters. This process allows such things as allowing a user to order a custom hardware device having only those options the user desires. In operation 211, one or more configuration parameters for a configurable hardware device are received from a user, a computer system, etc. Note that as used throughout the description of this and other preferred embodiments, a “configurable hardware device” can also refer to a programmable logic device, a reconfigurable logic device capable of being partially or fully reconfigured, etc. Preferably, the hardware device includes at least one Field Programmable Gate Array (FPGA). Hardware description data is generated in operation 212, preferably in the Handel-C programming language, based on the received parameters.

With continued reference to FIG. 2C, in operation 213, the hardware description data is transmitted to the hardware device utilizing a network such as the Internet, a telephone network, satellite or other wireless network, etc. Further, the hardware device can be located at the user's site, or can be located at a third party site. Note that the hardware description data may be stored on a host system such as the user's personal computer, and may be further manipulated, prior to being finally transferred to the hardware device. In operation 214, the hardware device is configured according to the hardware description data. Note that the present invention also encompasses hardware/software co-design. In operation 215, a sum of money is preferably charged for performing any portion, or all, of the process.

FIG. 2D depicts a process 220 for configuring a device according to user-input information. In operation 221, one or more configuration parameters for a configurable hardware device are received from a user. Preferably, the hardware device includes at least one Field Programmable Gate Array (FPGA). Hardware description data is generated in operation 222, preferably in the Handel-C programming language, based on the received parameters. The hardware device is configured in operation 223 according to the hardware description data. Preferably, the hardware device is located locally (i.e., at the site where the hardware description data is generated). After configuration of the device, the device is sent to the user in operation 224. Note that the “user” encompasses a third party designated by the user who selected the configuration parameters. In operation 225, an amount of money is charged to the user for the cost of the hardware device. This can include merely a cost for the actual hardware, but can also include additional charges for any of allowing the user to select the parameters, the generation of the hardware description data, the configuration of the device itself, shipping and handling charges, etc.

The configuration parameter can be selected from a plurality of configuration parameters presented to a user via a Graphical User Interface (GUI). Preferably, an assortment of capabilities and product features are presented to the user. The configuration parameter(s) selected can be for a new capability of the hardware device, a new capability added to an existing capability, a new capability replacing an existing capability, an upgrade to an existing capability, etc.

As an option, the current configuration of the hardware device can be determined prior to generating the hardware description data. Items such as FPGA type, amount of memory, whether peripherals are attached, etc. are examples of configuration data than can be obtained over the network. Once the results are known, for example, they can be used to confirm that the desired configuration is feasible and to generate the appropriate hardware description data, select appropriate modules from libraries, etc. For example, during communication between a gate array and a host, a request to execute an operation on the gate array is received. First, a type of the gate array is identified. Thereafter, it is determined whether the gate array is capable of the operation based on the type thereof. Further, the operation is conditionally executed on the gate array based on the previous step. The type of the gate array may be identified by receiving an identifier from the gate array. Further, the identifier may be received during an initialization stage. Still yet, the gate array may be programmed utilizing Handel-C. As an option, the step of determining may include comparing parameters corresponding to the operation with capabilities associated with the type of the gate array. More information is provided in United States Patent Application entitled UNIVERSAL DOWNLOAD PROGRAM FOR ESTABLISHING COMMUNICATION WITH A GATE ARRAY, assigned to common assignee Celoxica Ltd. and having Attorney Docket number EMB1P033, which is herein incorporated by reference for all purposes.

The hardware description data may include at least one precompiled module. The module can, for example, be selected from libraries of Handel C cores, and/or can be remotely located from the rest. These might be owned by third party and involve a separate fee for their use.

In the case of selection from a library, a library map can be used. In general, a plurality of macros which specify an interface is determined. During the execution of each of macro, one of a plurality of libraries is utilized. Each macro is capable of being executed utilizing different libraries. The macros may be executed on a co-processor which is capable of executing the macros utilizing different libraries. In another aspect, the macros may be compiled in a file. In one aspect of the present invention, the libraries may be written in Handel-C. In another aspect, each macro may correspond to a unique graphics adapter. A plurality of first variables in the macros may also be defined with reference to variable widths and a plurality of second variables in the macros may be defined without reference to variable widths so that the variable widths of the second variables may be inferred from the variable widths of the first variables. More information is provided in United States Patent Application entitled SYSTEM, METHOD AND ARTICLE OF MANUFACTURE FOR USING A LIBRARY MAP TO CREATE AND MAINTAIN IP CORES EFFECTIVELY, assigned to common assignee Celoxica Ltd. and filed Jan. 29, 2001, which is herein incorporated by reference for all purposes.

Such libraries can be generated utilizing pre-compiler macros. In general, a library is accessed that includes a plurality of functions. A precompiler constant is tested so that one or more of the functions of the library can be selected based on the testing. In one aspect, the precompiler constant may include a plurality of versions. As an option, the version may be selected utilizing a precompiler macro. In another aspect, the precompiler constant is tested to determine a state of an apparatus on which the functions are executed. In such an aspect, the state of the apparatus may be based on a current bit size. In a further aspect, the library may be written in Handel-C. More information is provided in United States Patent Application entitled SYSTEM, METHOD AND ARTICLE OF MANUFACTURE FOR GENERATING LIBRARIES UTILIZING PRE-COMPILER MACROS, assigned to common assignee Celoxica Ltd. and filed Jan. 29, 2001, which is herein incorporated by reference for all purposes.

These techniques, as well as others set forth herein, further allow for an automated process of selecting, compiling, and downloading modules which can be ready to use, or can have unspecified variables that are resolved later, such as when compiled with the user's own modules. More information is provided in United States Patent Applications entitled SYSTEM, METHOD AND ARTICLE OF MANUFACTURE FOR DISTRIBUTING IP CORES and SYSTEM, METHOD AND ARTICLE OF MANUFACTURE FOR SUCCESSIVE COMPILATIONS USING INCOMPLETE PARAMETERS, each assigned to common assignee Celoxica Ltd. and filed Jan. 29, 2001, which are herein incorporated by reference for all purposes.

Collaborative Design

FIG. 2E illustrates a process 230 for providing one or more modules conforming to a hardware design specification. In operation 231, a user specification for at least a portion of a hardware design is received. One or more modules conforming to the specification are identified in operation 232. Preferably, the module is written in the Handel-C (or other) programming language. This can, of course, also include identifying a source of the modules. The module(s) are retrieved in operation 233 and, in operation 234, are sent to the user. The user is then able to compile the modules into an integrated whole. The module can be used to configure a configurable hardware device such as an FPGA. Note that the modules can also be used in a scheme of software/hardware co-design.

An amount of money can be charged for performing any of receiving the user specification, identifying the module(s), retrieving the module(s), sending the module(s) to the user, providing a bidding service (as described below), identifying a contractor (as described below), etc. Preferably, price information for the at least one module is provided to the user. As an option, the user can be allowed to bid on a price for obtaining the module.

The module or modules can be retrieved from a library of existing code and/or from a contractor or subcontractor available for hire. The contractor can be allowed to bid on a price for obtaining the module(s), and can receive the module(s) from a third party.

Network-Based Revenue Generation System

FIG. 2F illustrates a system 240 for generating revenue by providing hardware configuration-related services. As shown, a facilitating organization 241 interfaces directly with a customer 242. An auction subsystem 243 performs online auctions for hardware configuration modules. A reverse-auction subsystem 244 conducts reverse auctions for hardware configuration modules. A fee is charged for accessing a library 245 of pre-existing hardware modules. Application Service Provider (ASP) 246 services are provided for a fee. Contractor 247 services are also provided for a fee. Note that a “module” as used in this document can include any portion up to and including the entire instruction set necessary to completely configure/reconfigure hardware, or any portion thereof.

Auction

FIG. 2G illustrates a process 250 for conducting an auction for a hardware configuration module utilizing a network. In operation 251, a description of a hardware configuration module desired to be purchased is received from a customer. This description can be merely an identifier of the module selected from a website, for example. In operation 252, bid prices for the module are received from a plurality of customers. Bidding is terminated in operation 253 upon occurrence of a specified event such as the expiration of a predetermined amount of time or upon a bid price exceeding a desired minimum. One or more auction winners are selected from among the customers in operation 254.

In one aspect of the present invention, the description of the module is an identification of the module selected by the customer from a list of modules available for sale. Such a list can be presented to the user via a web page, an Application Service Provider (ASP), an auctioning service such as eBAY™, etc. Also note that the module may be the only item on the list. The module can be stored in a library of hardware configuration modules.

In another aspect of the present invention, the description of the module is a hardware design specification. In other words, a customer sends his or her design criteria and the auction system matches the criteria to a precompiled (proprietary or third-party (vendors, contractors, developers, etc.) held/owned) module and/or selects a supplier (contractor, developer, etc.) to generate the module. It does not matter that the module is not yet in existence. The selected supplier will create the module upon that customer being selected as an auction winner. The supplier can create the module from scratch, can combine existing sub-modules to generate the module, or a combination of both. Also, the supplier can select sub-suppliers for generating sub-modules according to portions of the hardware design specification. The sub-modules are then integrated to create the module to be sent to the customer.

An auction is a method of selling goods through the process of competition. At an auction, buyers, who are referred to as bidders, make competitive bids for goods, and sellers designate goods, which are up for sale to the highest bidder. Sellers who conduct the process of bidding are referred to as auctioneers.

The important principle in auctioning is to allow buyers the initiative of determining the market price through mutual competition, rather than having the price set by the seller. When a seller determines the market price, he is quoting his opinion on the value of goods, and then possibly negotiating with the individual buyer. This is one of the reasons why the auction method has often been used traditionally for auctioning of scarce valuable items, whose exact market prices are difficult to determine. In recent years the techniques of auctioning have begun to become increasingly favorable for commodities transactions on the Internet.

Examples of auctioning that can be performed by the present invention follow.

1. The Ascending Order or an English Auction: the bidders quote successively higher prices in order to determine the best price for the goods. The goods are sold to the highest bidder. Thus, the order of the bids are ascending in terms of the price level.

The starting bid may be decided either by the auctioneer or by one of the potential buyers. Many variations are possible on the English auction, e.g., providing fixed price advances for each bid, or providing minimums on each advance.

An example of an ascending auction is the Interval Auction. Here, the bidding must be conducted in a certain time interval. This time interval gives bidders reasonable time to consider their bids. For example, it may be pre decided that the auction will start at 3 p.m., and the final decision on the auction will be made at 3:30 p.m. This gives the buyers 30 minutes to ponder and to raise their bids before a final decision is made. The following are the tradeoffs in adjusting the time interval for an auction:

A. If the time-interval is too long, the auction is too slow and the rate of sales will slow down.

If the time-interval is too short, the bidders will not have sufficient time to bid against each other and sufficiently raise the price.

2. The Descending Auction or a Dutch Auction: the auctioneer starts by quoting a high price and successively recites lower bids at regular intervals, until one of the bidders accepts that price. It is important to understand that quoting a good initial price is critical to the success of the descending auction. If the initial price which is quoted is too high, then the auctioneer may spend too much time reciting bids which are not useful. If the initial bid price is too low, then the auctioneer may be unable to obtain the best price for the goods.

3. The Simultaneous Bidding or a Japanese Auction: all bids are made by prospective buyers at the same time. The highest bid is taken to be the price at which the goods are finally sold. This technique is often utilized for the sale of fish in Tokyo.

In simultaneous bidding, it is possible for one buyer to make multiple bids for a given item. For example, a bidder may provide the following three bids for a given item: $50, $20, and $10. If it turns out that the highest bid that any other buyer in the system has made is $18, then the bid for $20 may be awarded to the buyer. This kind of technique reduces the chances that a bidder may overpay because of the lack of knowledge about the bids made by other bidders.

Similarly, in a Haphazard Bidding system, the bidders are unaware of the exact nature of the bids made by others. An example of such a scheme is the written tender scheme in which bids are made in writing and posted to an auction official. The best bid is picked from among these. In a haphazard bidding systems, sometimes considerable temptation may exist for the seller to move the auction to its advantage, since the buyers are not aware of each other's bids.

The present invention can also utilize a technique for conducting auctions at dynamically adjusting time intervals. The time intervals for the auctions are adjusted in such a way that auctions are not so slow, that buyer's timed bids are excluded. At the same time, the auctions are adjusted not to be so fast that bidders do not have time to bid against each other sufficiently. This creates a dynamic adjustment in the trade-offs of the time intervals to perform the bidding.

A method of the present invention performs continuous auctions over a computer network system consisting of multiple clients/buyers which are computer systems connected via a network to a server/seller which is a computer system comprising a CPU, a disk and memory. The seller makes information about the type of sale items, the number of sale items, minimum bid price, and time limits for bids to be submitted. Each buyer responds by entering a bid and such bid's duration within the time limits set by the seller into the auction system through buyers' computer terminals. Additionally, a buyer's bid entry time is saved by the auction system.

To schedule the next auction, the estimated time interval to the next auction decision is determined by selecting premium buyers whose bids are above a certain predefined market premium and calculating a maximum time before which a certain percentage of bids of these premium buyers will not expire. The target queue length is then calculated by using average bid response intervals for the premium bidders and the target queue length. The current queue length is compared to the target queue length in order to readjust the target time at which the next auction winner will be selected.

At least one auction winner, whose bid is within the bid duration is selected through a dynamically adjusted customer selection method. This dynamically adjusted customer selection method finds all buyers whose bids are higher than a predetermined amount set by a seller. The method then computes arrival and defection times of these selected buyers, based on each buyer's bid entry time and the buyer' bid duration, in order to determine these buyers who have the lowest value of the sum of the arrival and defection times. Based on these computations and the buyer's intended purchase volume the winners are declared.

In the present invention, a bid made by a given buyer may be valid across multiple auctions. A bidder not only specifies the price that he is willing to pay, but also the maximum time for which such a bid is valid. For example, assuming that a bid made by a buyer is valid for a period of one hour and that decisions on auctions are made at the rate of one every 15 minutes, then if a buyer's bid expires before that bid is declared as the winner, then this is said to be a defection or an expiry. A bidder is allowed to renew the defection bid. Whenever the bidder renews the defection bid, the new maximum time for which that bid is valid must also be specified.

The method of the present invention can also define automated time-interval auctions, in which the times at which the auctions are conducted are specific to the information provided by the buyers who make the bids. The information provided by the bidders is as follows:

1. The amount of the bid.

2. The time at which the bid is entered. This information need not be explicitly provided by the bidder. When a bid is submitted, the system clock automatically records the time at which the bid was made.

3. The time duration for which the bid is valid. A bid can be valid across multiple auction sessions.

The time-interval of the auction is determined by the nature of the times at which the bids of the buyers and the sellers in the system are registered. If there are many bidders in the system whose bids are valid for long periods of time, then the time intervals between auctions are kept large. On the other hand, when there are many bidders in the system whose bids are valid for short periods of time, then the time-intervals of the auctions are kept short. This is done in order to reduce the rate of expiring of bids from high bidders. The time interval between successive auctions takes into account both the bids of the buyers as well as that of the sellers.

The process of the present invention includes:

1. determining time intervals between auctions, using the information provided by bidders about the amount of each bid,

2. determining the time at which a buyer entered the system, and

3. determining the time for which each bid is valid.

The automated system of the present invention optimizes the auctioneers' objective function of keeping the buyers bidding against each other, while making sure that the premium bidders do not defect. Thus, the speeds of the auction decisions are dynamically adjusted in correspondence with the times that bidders are willing to wait in the system. Therefore, when there is a large number of bidders in the system who are bidding high, then the rate at which each auction decision is made will be increased by the automated system, otherwise the rate of bidding will be reduced.

Reverse-Auction

FIG. 2H depicts a process 260 for conducting a network-based reverse-auction for a hardware configuration module. In operation 261, a hardware design specification is received from a customer utilizing a network. A bid price is received in operation 262.

The bid price represents the amount of money that the customer is willing to pay for a hardware design module conforming to the design specification. The user will use the hardware design module for configuring a configurable hardware device such as an FPGA device. In operation 263, a determination is made as to whether the bid price is acceptable. The bid is accepted in operation 264 if the bid price is acceptable and the module is sent to the customer. The customer is notified in operation 265 if the bid price is not acceptable.

In one aspect of the present invention, the bid price is determined to be acceptable if the bid price is above a predetermined minimum price. The hardware design specification can be submitted to a plurality of suppliers (vendors, contractors, developers, etc.) of modules. The suppliers are allowed to accept or reject the bid price. The bid price is acceptable if one or more of the suppliers accepts the bid price. The bid is not acceptable if none of the suppliers accepts the bid price. As an option, some or all of the suppliers can be allowed to bid for sub-modules that are used for creating the module.

In another aspect of the present invention, the hardware design specification identifies a pre-existing hardware design module. In yet another aspect of the present invention, the hardware design specification is generated online by the customer selecting parameters from a graphical user interface. For example, the user can select the parameters from a list, can “mix-and-match” the parameters from different sources, can selects some parameters and enter others, etc.

Library-Based

FIG. 2I illustrates a process 270 for generating revenue by charging for access to a library having a pre-compiled hardware configuration module therein. A plurality of hardware configuration modules are stored in a library in operation 271. A customer is prompted for hardware configuration criteria, which can include such things as desired functionality, a desired clock speed, a price, a description of an I/O or other device that will be attached to the hardware to be configured, etc. in operation 272. In operation 273, a module is selected from the library based on the criteria. In operation 274, the selected module is sent to the customer over a network, on a disc, etc. The customer is charged an amount of money for the service and/or for the module in operation 275. This amount may also include royalties, etc.

In one aspect of the present invention, the listing also includes modules stored in additional libraries. The customer can be a contractor using the module to generate a hardware description. The customer can also be a reseller of hardware configuration modules. The customer can be allowed to submit a bid price for the module in an auction-type system. As an option, the bid can be submitted to an auction system that is managed by a third party such as eBAY™.

As an option, a listing of modules stored in the library can be provided to the customer. The customer is then allowed to select the module from the list. As another option, the customer is prompted for further criteria if multiple modules match the criteria. Preferably, the customer is allowed to select multiple modules, where the user is prompted for further criteria for selecting one of the multiple modules. A help function can be provided.

Application Service Providers (ASP's)

FIG. 2J depicts a process 280 for providing hardware configuration data for generating revenue. In operation 281, a customer design specification for a configurable hardware device is sent to an Application Service Provider (ASP). The ASP analyzes the design specification in operation 282. The ASP selects hardware configuration modules based on the design specification in operation 283. In operation 284, the ASP compiles the modules into a file. The file is received from the ASP in operation 285 and in operation 286 is sent to the customer's computer or the actual device over a network, on a disk, etc. The file may also be sent directly to the customer. In operation 287, the customer is charged an amount of money for the file. The amount can also include any fee the ASP charges.

Preferably, the ASP is transparent to the customer. In other words, the company providing the service is the only one that maintains a direct relationship with the customer.

In one aspect of the present invention, the ASP determines whether components of the design specification are compatible. A website of the ASP may provide options which the user can select for generating the design specification. Preferably, the ASP runs a run-time compiler that compiles the modules. The preferred compiler is a run-time version of the Handel-C compiler. As an option, the ASP can retrieve a portion of the modules from a remote site such as a server farm or third party site.

Contractor

FIG. 2K depicts a process 290 for providing a hardware configuration module for generating revenue. In operation 291, a customer design specification for a configurable hardware device is sent to a contractor. The contractor analyzes the design specification in operation 292. In operation 293, the contractor generates at least one hardware configuration module based on the design specification. The contractor compiles the modules into a file in operation 294. In operation 295, the file is sent to the customer's computer or the actual device over a network, on a disk, etc. The customer is charged an amount of money for the file and/or service in operation 296. The amount can also include any fee the contractor charges. Note that the customer can be charged directly by the contractor and/or by a third party such as a general contractor or a procurementm service.

Preferably, the contractor is transparent to the customer. In other words, the company providing the service is the only one that maintains a direct relationship with the customer. The contractor has no direct contact with the customer.

In one aspect of the present invention, the contractor determines whether components of the design specification are compatible. The contractor can obtain modules generated by a sub-contractor. The contractor can also retrieve modules from a remote site such as a server farm or third party site. The contractor can also be allowed to bid on modules.

Services to Third Party Service Providers

Another embodiment of the present invention includes a process for a hardware configuration data service. A provider of hardware configuration modules (e.g., a contractor, sub-contractor, owner of a module library, reseller, etc.) is provided with access to customer information such as a customer bid, a customer request, a customer hardware design specification, etc. The provider is charged an amount of money for the access. A billing service is provided. The billing service is for charging the customer for a module selected for the customer by the provider. Note that “selected” encompasses everything from mere selection of the module for delivery to the customer to a complete generation of the module from a design specification.

In one aspect of the present invention, a listing of modules of the provider is output to the customer. The customer is allowed to select the module from the listing. In another aspect of the present invention, the provider is allowed to access a module library for selecting the module. The provider can be charged an amount of money for accessing the module library and/or the module itself. In a further aspect of the present invention, a module library of the provider is hosted. The provider is charged an amount of money for the hosting.

The customer information can include a customer bid, a customer request, and/or a customer hardware design specification, for example. Preferably, the customer information is analyzed to determine whether the provider can provide a module. For example, a user hardware specification can be prequalified to make sure that it is compatible with the contractor's module. Note that all communications with the provider and between the customer and provider can be done securely using an encryption technology known in the art, such as SSL.

Network-Configurable Hardware

This section will detail the development of a flexible multimedia device according to an illustrative embodiment of the present invention using hardware that can be reconfigured over a network connection and runs software applications built directly in silicon.

The illustrative platform developed for this purpose is called the Multimedia Terminal (MMT). It features no dedicated stored program and no Central Processing Unit (CPU). Instead, programs are implemented in Field Programmable Gate Arrays (FPGA) which are used both to control peripherals and to process data in order to create CPU-like flexibility using only reconfigurable logic and a software design methodology.

FPGAs can be used to create soft hardware that runs applications without the overhead associated with microprocessors and operating systems. Such hardware can be totally reconfigured over a network connection to provide enhancements, fixes, or a completely new application. Reconfigurability avoids obsolescence by allowing the flexibility to support evolving standards and applications not imagined when hardware is designed. This also allows manufacturers to use Internet Reconfigurable Logic to remotely access and change their hardware designs at any time regardless of where the units reside.

The MMT according to one exemplary embodiment of the present invention achieves flexible reconfigurability by using two independent one-million gate Xilinx XCV1000 Virtex FPGAs. One of the FPGAs remains statically configured with networking functionality when the device is switched on. The other FPGA is reconfigured with data provided by the master. The two FPGAs communicate directly via a 36-bit bus with 4 bits reserved for handshaking and two 16-bit unidirectional channels as set forth in U.S. Patent Application entitled SYSTEM, METHOD, AND ARTICLE OF MANUFACTURE FOR DATA TRANSFER ACROSS CLOCK DOMAINS, Attorney Docket Number EMB1P015 and filed Jan. 29, 2001 and assigned to common assignee, and which is incorporated herein by reference for all purposes. The protocol ensures that reliable communication is available even when the two FPGAs are being clocked at different speeds.

The other components of the MMT are an LCD touch screen, audio chip, 10-Mbps Ethernet, parallel and serial ports, three RAM banks and a single non-volatile flash memory chip.

FPGA reconfiguration can be performed by using one of two methods. The first method implements the Xilinx selectmap programming protocol on the static FPGA which can then program the other. The second method supplies reconfiguration data from the network interface or from the flash memory on the MMT. Reconfiguration from flash memory is used only to load the GUI for a voice-over-internet protocol (VoIP) telephone into the slave FPGA upon power-up, when an application has finished, or when configuration via the network fails. Network-based reconfiguration uses the Hypertext Transfer Protocol (HTTP) over a TCP connection to a server. A text string containing a file request is sent by the MMT to the server which then sends back the reconfiguration data (a bitfile).

There has thus been presented a flexible architecture that can run selected applications in an FPGA. Now will be described methods ofr writing all those applications and how to do it in a reasonable amount of time. Hardware Description Languages (HDL) are well-suited to creating interface logic and defining hardware designs with low-level timing issues. However, HDL may not be suitable for networking, VoIP, MP3s and video games.

To meet the challenges of the system described above, the MMT design can be done using Handel-C. It is based on ANSI-C and is quickly learned by anyone that has done C software development. Extensions have been put in to support parallelism, variables of arbitrary width, and other features familiar in hardware design, but it very much targets software design methodologies. Unlike some of the prior art C-based solutions that translate C into an HDL, the Handel-C compiler directly synthesizes an EDIF netlist that can be immediately placed and routed and put onto an FPGA.

The default application that runs on the illustrative embodiment of the MMT upon power-up is a Voice over Internet Protocol (VoIP) telephone complete with GUI. The voice over internet protocol consists of a call state machine, a mechanism to negotiate calls, and a Real Time Protocol (RTP) module for sound processing. A combination of messages from the GUI and the call negotiation unit are used to drive the state machine. The protocol implemented by the call negotiation unit is a subset of H.323 Faststart (including H225 and Q931). This protocol uses TCP to establish a stream-based connection between the two IP telephones. The RTP module is responsible for processing incoming sound packets and generating outgoing packets sent over UDP.

Algorithms for protocols such as RTP, TCP, IP and UDP can be derived from existing public domain C sources. The source code can be optimized to use features available in Handel-C such as parallelism; this is useful for network protocols which generally require fields in a packet header to be read in succession and which can usually be performed by a pipeline with stages running in parallel. Each stage can be tested and simulated within a single Handel-C environment and then put directly into hardware by generating an EDIF netlist. Further optimizations and tuning can be performed quickly simply by downloading the latest version onto the MMT over the network.

Because of the flexibility of the architecture and to take advantage of Internet reconfigurability, a mixed-bag of applications can be developed that all run in hardware on the MMT. Among them are a fully-functional MP3 player with GUI, several video games, and some impressive graphics demonstrations that were all developed using Handel-C. These applications are hosted as bitfiles on a server that supplies these files upon demand from the user of the MMT over a network connection.

Interface

In accordance with the invention, an intuitive interface is provided for defining and transferring configuration files from a computer to a device in reconfigurable logic

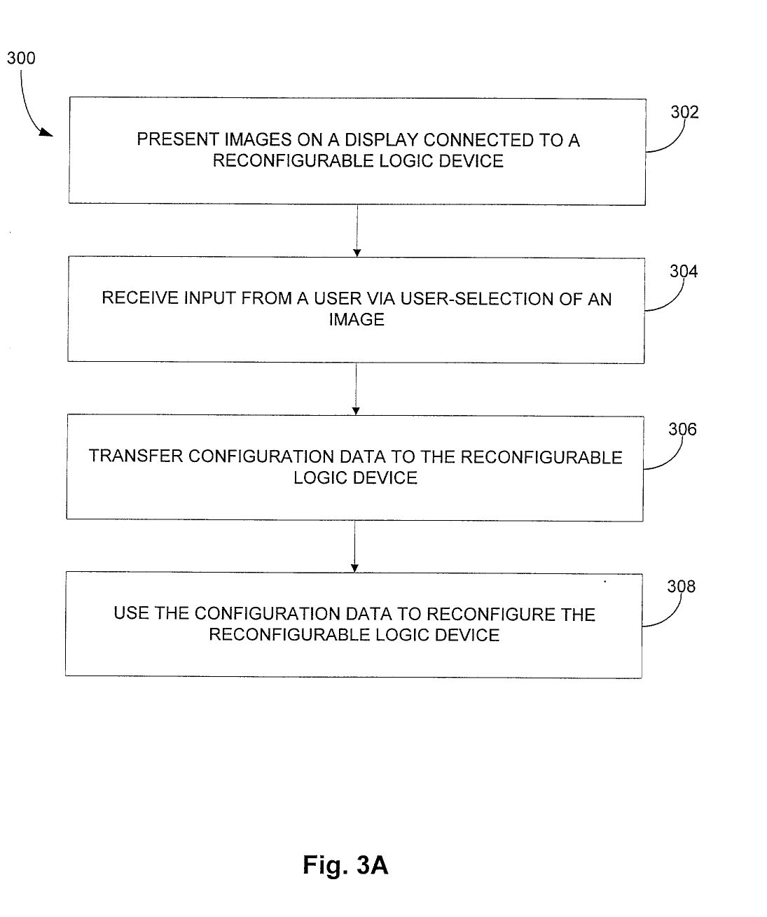

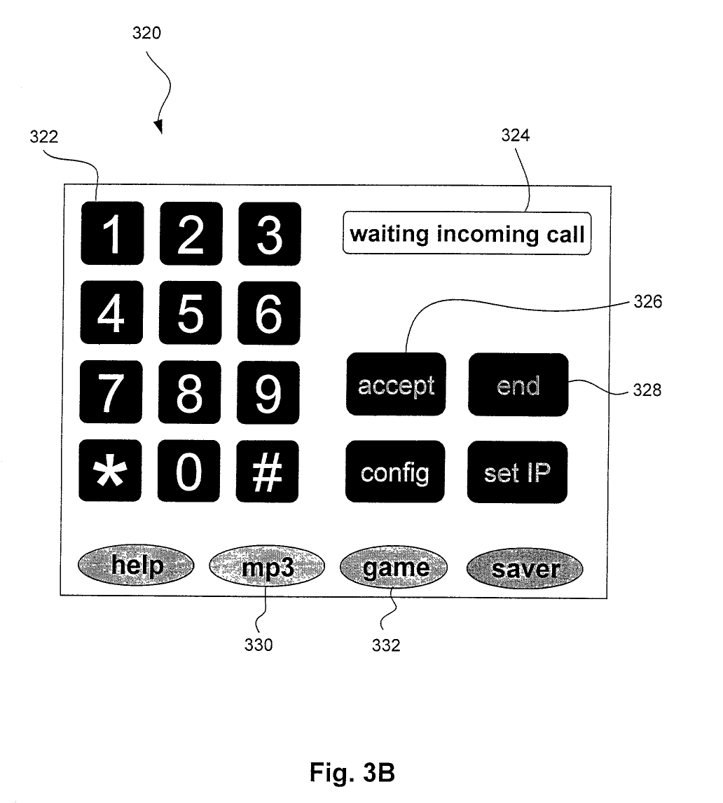

FIG. 3 is a flow diagram of a process 300 for providing an interface for transferring configuration data to a reconfigurable logic device, such as a Field Programmable Gate Array (FPGA), Programmable Logic Device (PLD), or Complex Programmable Logic Device (CPLD). In operation 302, images are presented on a display connected to a reconfigurable logic device. In operation 304, the user is allowed to input a command to configure the reconfigurable logic device by selecting one or more of the images. The configuration data is transferred from a computer to the reconfigurable logic device in operation 306 where it is used to reconfigure the reconfigurable logic device in operation 308.

Other embodiments include a touch sensitive Liquid Crystal Display (LCD), buttons presented as bitmapped images to guide a user, interactive configuration of the device and its components and provides downloading via the Internet and a wireless network.

In a preferred embodiment, the reconfigurable logic device is capable of saving the configuration data for later reuse. In another embodiment, the display is operable for inputting commands to control operation of the reconfigurable logic device.

### EXAMPLE 1

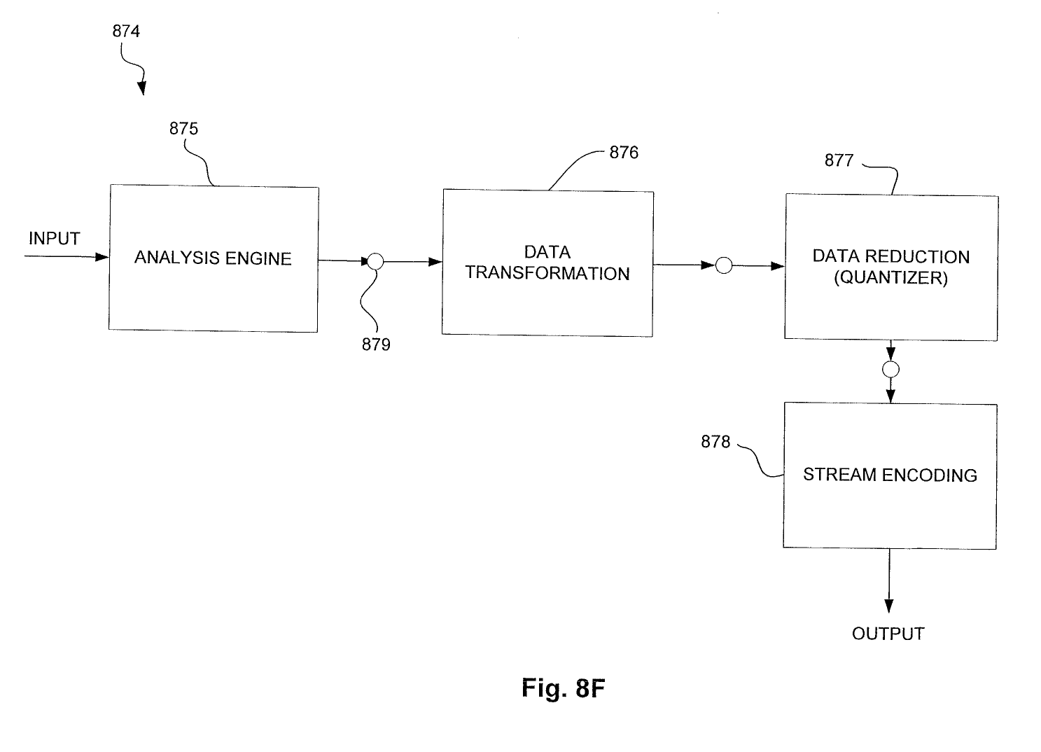

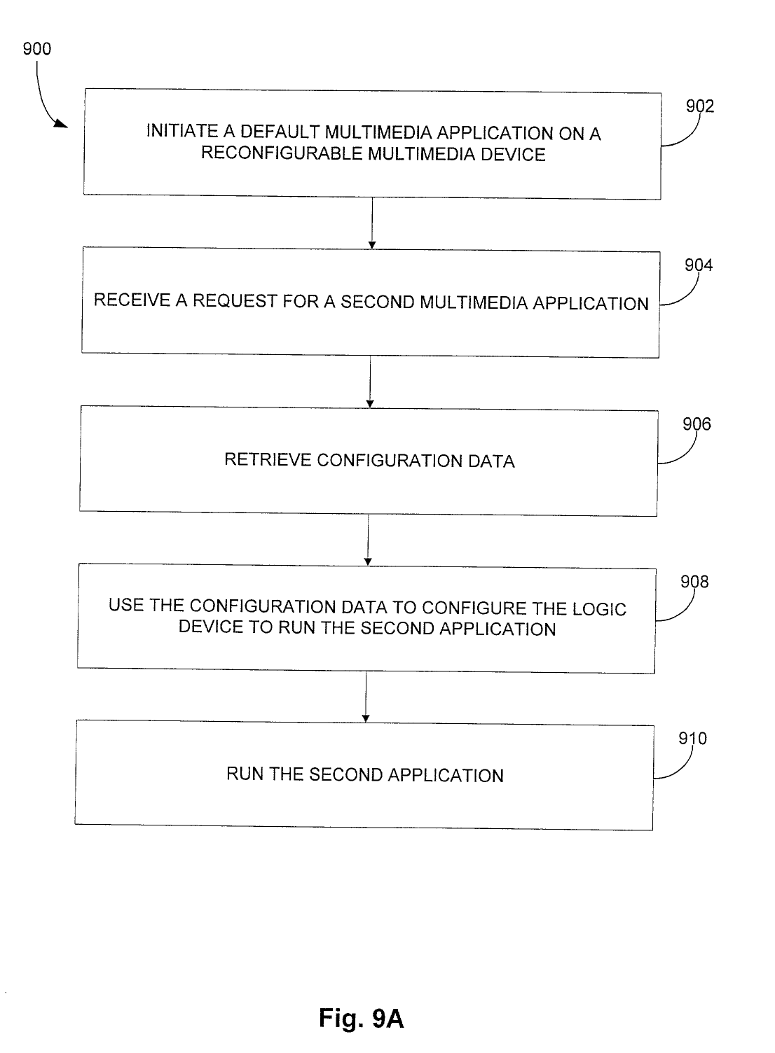

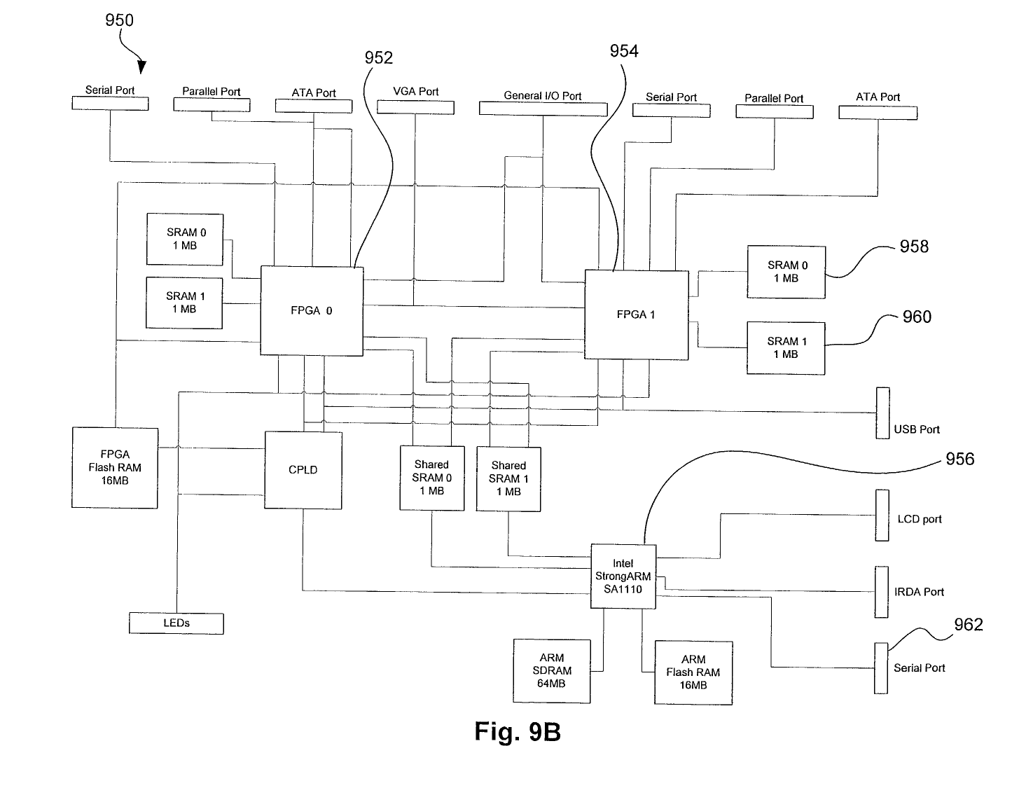

FIG. 3B depicts a display 320 according to one embodiment of the present invention. The display is connected to a reconfigurable logic device, such as the one described below with respect to FIGS. 9-15. As an option, the display could be integrated with the device.

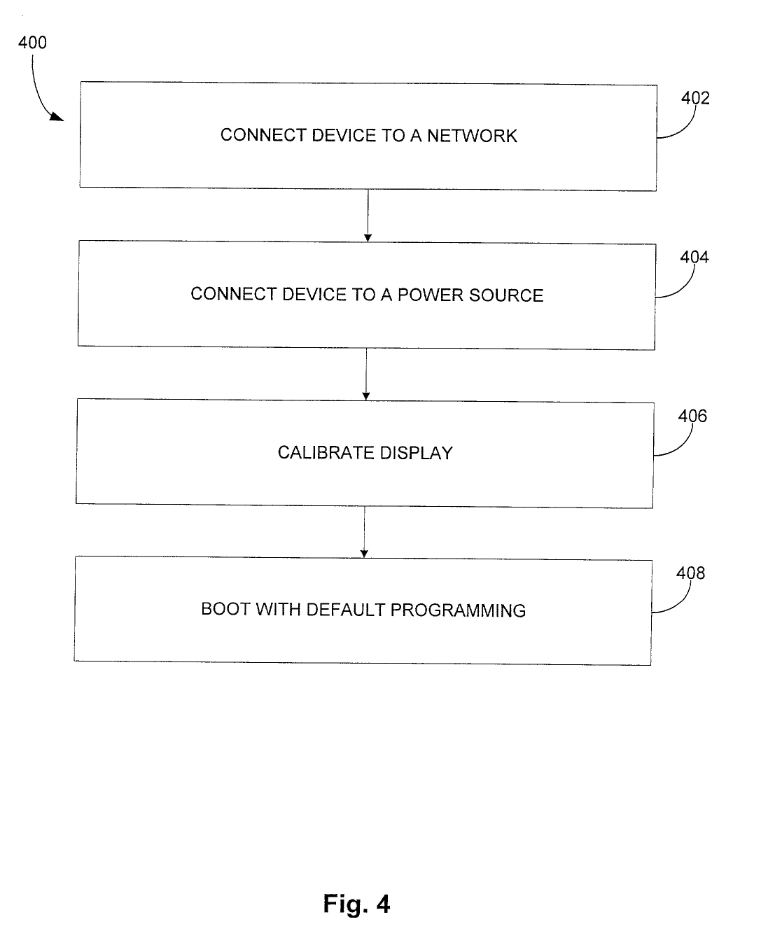

An exemplary procedure 400 for initiating the device is shown in FIG. 4. The device is connected to a network in operation 402 and a power source in operation 404. The display is calibrated in operation 406. In operation 408, on connecting power, the device boots with a default programming. In this example, the device boots as an IP phone, ready to accept/receive calls.

Referring again to FIG. 3B, the display includes several bitmapped buttons with which a user can input commands for use during a session of Internet telephony. Keypad buttons 322 are used to enter IP addresses to place a call. The status window 324 displays the status of the device.

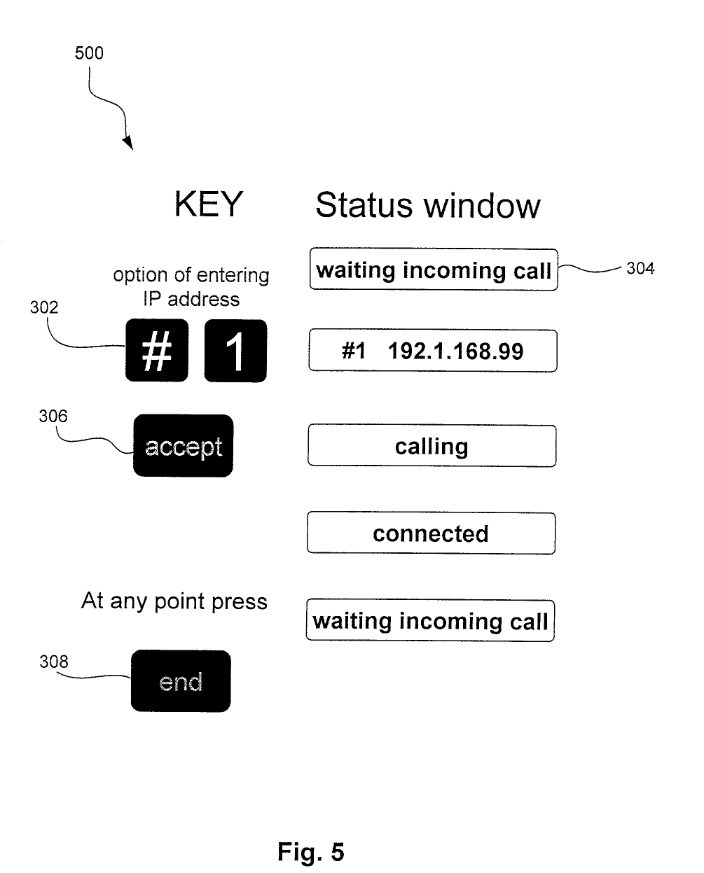

In accordance with the present invention, a hardware-based reconfigurable Internet telephony system can be provided. The system includes a first Field Programmable Gate Array (FPGA) that is configured with networking functionality. A user interface is in communication with the first FPGA for presenting information to a user and receiving commands from a user. A microphone in communication with the first FPGA receives voice data from the user. A communications port is in communication with the first FPGA and the Internet. The first FPGA is configured to provide a call state machine, a call negotiation mechanism, and a Real Time Protocol (RTP) module for sound processing. See the discussion relating to FIGS. 5-7 for more detailed information about how to place a call.

According to one embodiment of the present invention, a stream-based connection is generated between the system and another Internet telephony system. In another embodiment of the present invention, a second FPGA is configured for running a second application. In such an embodiment, the first FPGA can preferably configure the second FPGA.

In an embodiment of the present invention, the RTP module processes incoming sound packets and generates outgoing sound packets. In a preferred embodiment, the user interface includes a touch screen.

FIG. 5 depicts a process 500 for using the device to place a call. (The process flow is from top to bottom.) The number key is pressed and then the IP address to be called is entered. As the numbers are typed, they appear in the status window. Once the number is entered, the accept button 306 is pressed to make the connection. The word “calling” appears in the status window to denote that the connection is pending. Upon making the connection, “connected” appears in the status window. To end the call, the end button 328 is pressed.

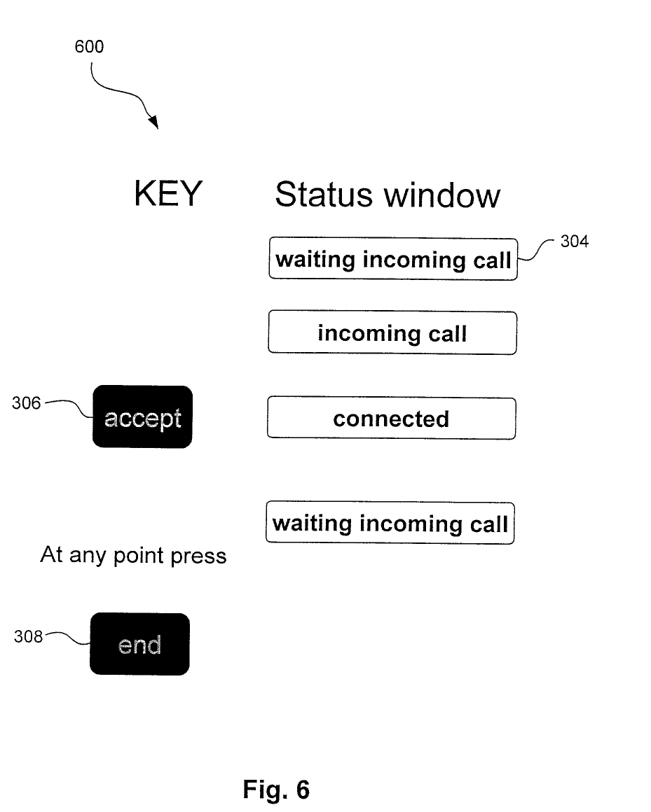

FIG. 6 illustrates the process 600 to answering a call. The status window displays “incoming call” and the device may sound a tone. The user selects the accept button to answer the call. Selection of the end button terminates the call.

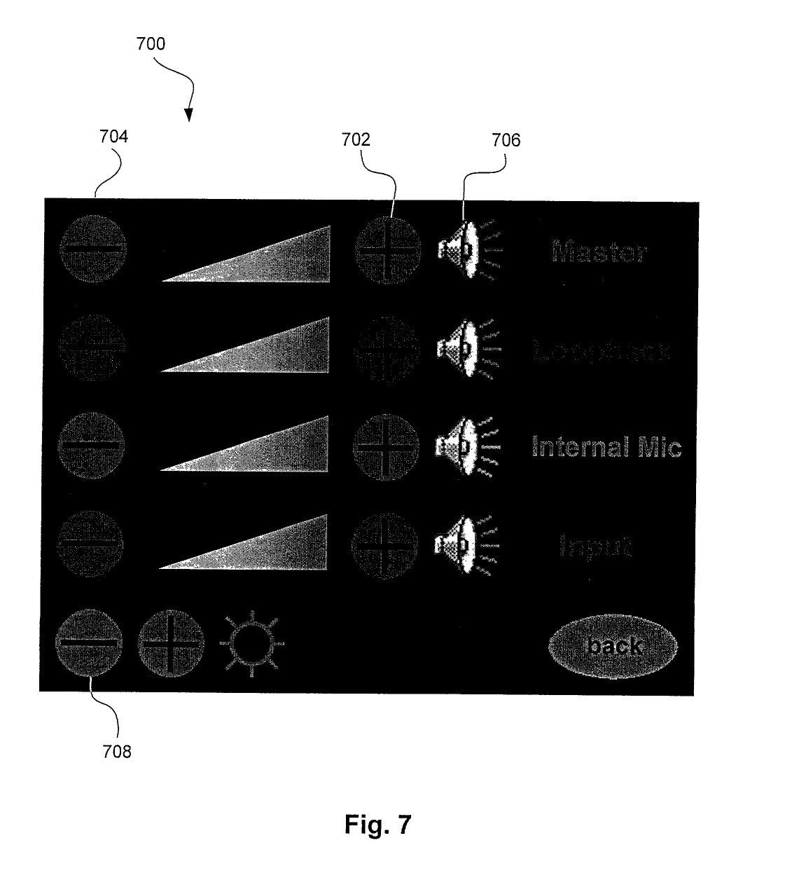

FIG. 7 depicts a configuration screen 700 for setting various parameters of the telephony functions. The buttons 702, 704 having the plus and minus signs are used to increase and decrease speaker volume, microphone volume, etc. Mute buttons 706 and display brightness buttons 708.

One skilled in the art will recognize that the device operates much like a traditional telephone and therefore, can include many of the features found in such telephones.

The screen shown in FIG. 3B includes several buttons other than those discussed above. Selecting the MP3 button 330 initiates a download sequence ordering the device to request configuration information to reconfigure the device to play audio in the MP3 format. Once the configuration information is received, the device reconfigures itself to play MP3 audio. See the following section, entitled “MP3 Decoder and Encoder” for more information about the MP3 functions of the present invention.

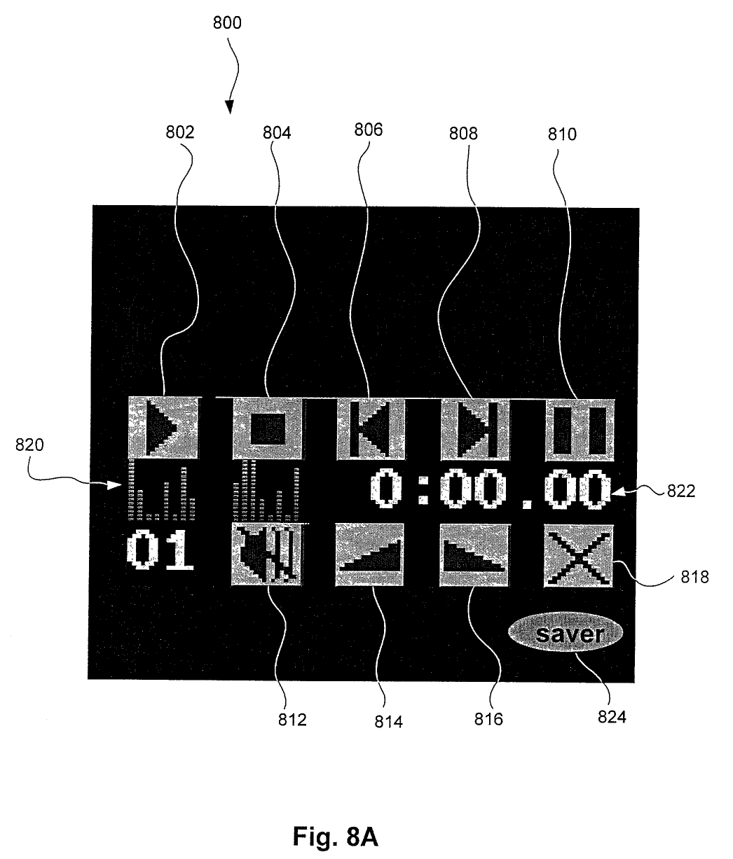

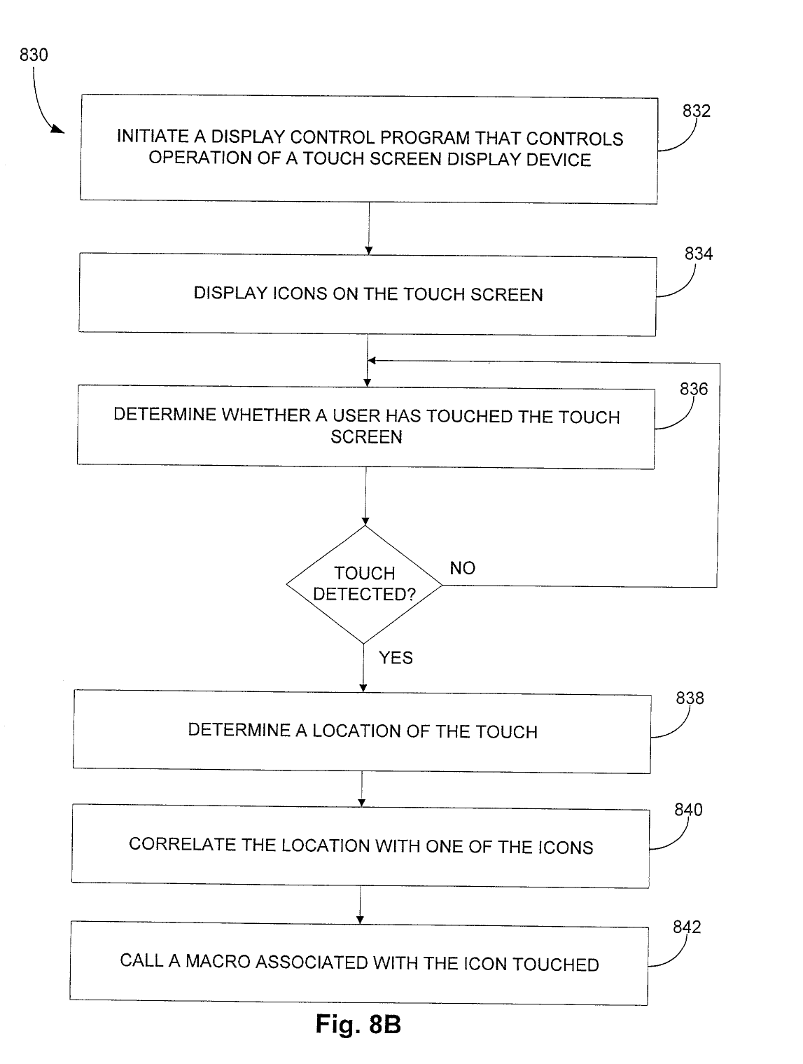

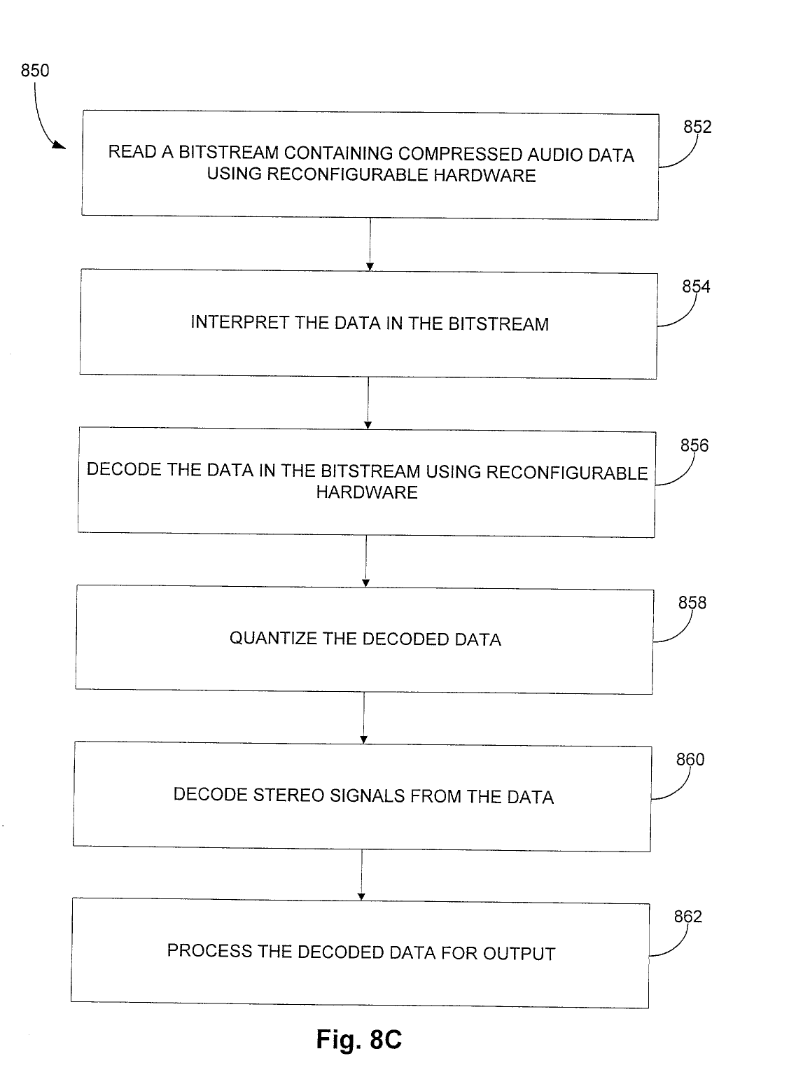

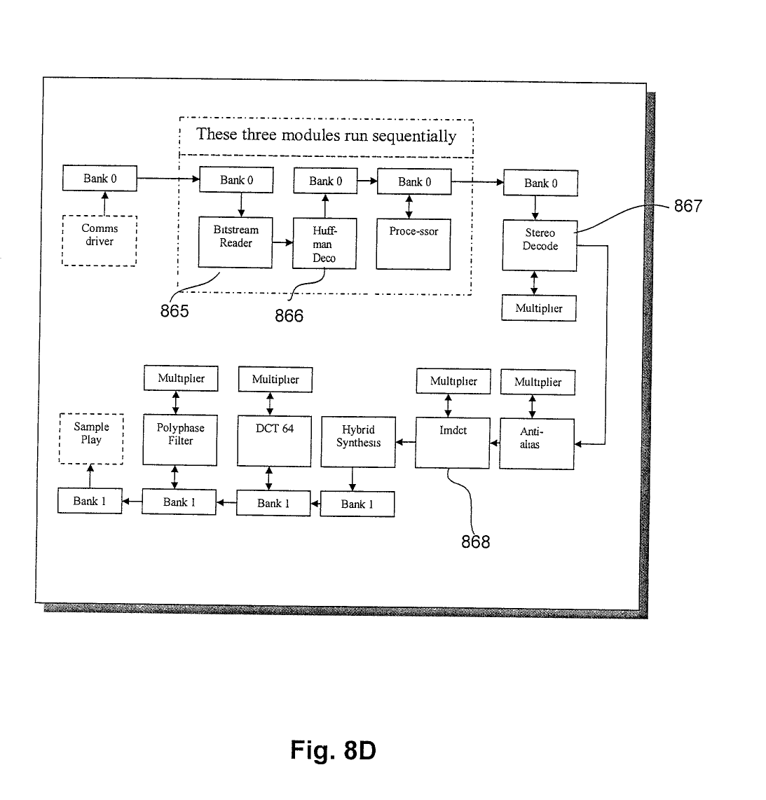

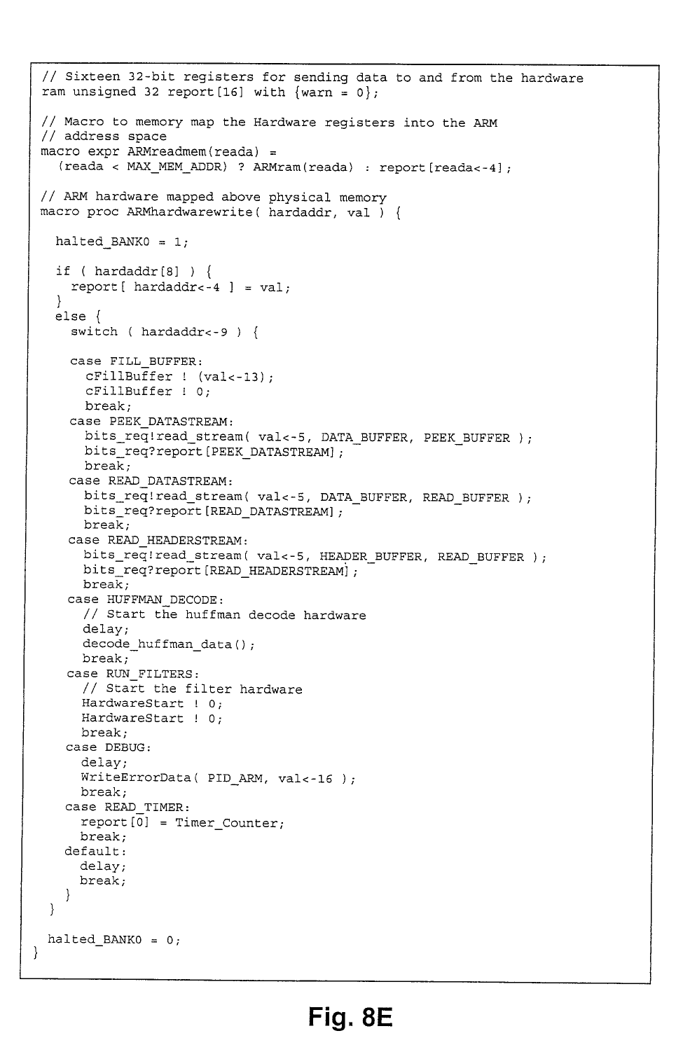

Upon reconfiguration, the display presents the screen 800 shown in FIG. 8A. The various buttons displayed include a play button 802, a stop button 804, track back and track forward buttons 806, 808, a pause button 810, a mute button 812, volume up and down buttons 814, 816 and an exit button 818 that returns to the default program, in this case, the IP telephony program. A graphical spectrum analyzer 820 and a track timer 822 can also be included.

Upon selection of the saver button 824, the configuration information is stored for reconfiguration of the device without requiring a download, if the device has access to sufficient storage for the information.

Referring again to FIG. 3, selection of the game button 332 initiates a download sequence ordering the device to request configuration information to reconfigure the device to allow playing of a game.

Audio Decoder and Encoder

While the present invention can be used to encode/decode audio data in a variety of ways and formats, the following description of the present invention will be set forth, for illustrative purposes, with a focus on encoding and decoding of MP3 audio.

The Decoder

GUI

FIG. 8A, described above, illustrates a graphical user interface for an MP3 decoder/player according to a preferred embodiment of the present invention.

Operation

FIG. 8B depicts a process 830 for providing a user interface for a decoder of audio data in the MPEG 1 Layer III (MP3) format. In operation 832, a display control program that controls operation of a touch screen display device is initiated. The touch screen is coupled to a reconfigurable logic device capable of decoding MP3 audio. In operation 834, a plurality of icons are displayed on the touch screen. A user selects one of the icons by touching the icon on the touch screen. A determination is made in operation 836 as to whether a user has touched the touch screen. If no touch is detected, a period of time is allowed to pass and another check is made. Note that the period between checks need not be uniform. Further, the checking process can be continuous, with no time period between checks. If a touch is detected, a location of the touch is determined in operation 838. The location of the touch is correlated with one of the icons in operation 840. In operation 842, a macro associated with the icon touched is called. The macro is utilized for processing a command for controlling the reconfigurable logic device. Note that the same or similar interface can be used with other similar devices, such as an encoder of audio or decoder of video data, for example.

In one embodiment of the present invention, the reconfigurable logic device includes at least one Field Programmable Gate Array (FPGA). As an option, the display control program can be implemented in the reconfigurable logic device. In other words, the display control program may be programmed in programmable logic, and/or can be software processed by a processor emulated in the reconfigurable logic device.

Preferably, the icons represent functions such as play, pause, stop, skip track forward, skip track back, and change volume. To increase speed, the icons can be positioned on bit boundary pixels. Also preferably, when the reconfigurable logic device is reconfigured to decode audio data in the MP3 format, the display control program is called.

Following are several macros that can be written in Handel C or other hardware description language for controlling the GUI and/or the MP3 decoder/player.

div10—A simple macro to divide by ten, used when calculating the track number of tracks.

reset_counters—Resets all counters to zero, to the beginning of the track.

mp3_play, mp3_stop, mp3_pause, mp3_quit,—Calls the relevant mp3 macros to stop, play, pause or quit the mp3 player.

mp3_skipf, mp3skipb—Skips forward of backwards by one track, by first stopping the current track, resetting the counters and starting the next track.

mp3_mute, mp3_volup, mp3_voldown—Calls the relevant mp3 functions to adjust the volume.

update_tracktime—uses the COUNTER_CLOCK_SPEED define to count the current track time. One second is COUNTER_CLOCK_SPEED clock cycles.

run_interface—runs the main display of the GUI. It contains macros for the display, the touch screen buttons, and the spectrum analyzers in parallel.

display—Checks the syncgen scan position for its location, and displays the relevant icon using the icon ROMs. The icons are kept as monochrome bitmaps at a scaling of the actual size. To increase speed, the icons are positioned on bit boundary pixels; scan positions can be tested by dropping the least significant pixels. The sixteen spectrum analyzers can be kept in two 8×8 ROMs, to reduce the number of individual icons.

update_buttons—This macro runs continuously. It first checks for a touch on the touch screen, then checks its location (i.e. which buttons have been pressed. It then calls the relevant macro to process the command.

mp3interface—The main GUI function. When the GUI is run from the same FPGA as other programs, it must account for time when the mp3 player is not running. There is therefore delay code whilst the mp3 is not running. When the GUI is needed, this calls the run_interface macro once, which controls the rest of the GUI program.

Audio Decode

FIG. 8C illustrates a process 850 for decoding compressed audio data, such as audio data compressed in MPEG 1 Layer III (MP3) format. In operation 852, a bitstream is read utilizing reconfigurable hardware, where the bitstream includes compressed audio data. The data in the bitstream is interpreted in operation 854, and in operation 856, is decoded utilizing reconfigurable hardware. Note that the decoding hardware can be a portion of the hardware that reads the bitstream, or can be an entirely separate piece of hardware that is in communication with the reading hardware. The decoded data is quantized in operation 858. Stereo signals of the decoded data are decoded in operation 860. The decoded data is processed for output in operation 862.

In one embodiment of the present invention, the reconfigurable hardware includes one or more Field Programmable Gate Arrays (FPGAs). In another embodiment of the present invention, a processor is emulated in reconfigurable logic. The processor interprets the data in the bitstream and dequantizes the decoded data in software. The processor can also be used to control the reconfigurable hardware.

In an embodiment of the present invention, the processing of the decoded data for output includes transforming the decoded data into an intermediate form utilizing Inverse Modified Discrete Cosine Transform (IMDCT) filters, and transforming the data in the intermediate form to a final form utilizing polyphase filters.

In a preferred embodiment, several of the operations are performed in parallel in a pipeline. This makes the decoding very fast. Ideally, a locking system manages access to resources during performance of the operations.

The MP3 Decoder Algorithms

FIG. 8D illustrates the discrete modules and data flow in the MP3 decoder according to a preferred embodiment of the present invention. The MP3 decoder according to a preferred embodiment of the present invention has eight identifiable stages in producing the final audio signal. These are split between pure hardware implementations, and some software on a lightweight embedded RISC processor core, preferably implemented in Handel-C. They are: Bitstream Reader 865, Bitstream Interpreter, Huffman Decoder 866, Dequantizer, Stereo Decoding 867, Antialiasing, IMDCT 868, Polyphase filter bank.

Details of their function are outlined below:

Bitstream Reader

The bitstream reader is implemented in hardware, to allow one bitstream read to be implemented per clock cycle. Between 1 and 32 or more bits can be written per call.

Bitstream Interpreter

The code for parsing the bitstream, extracting information about the frame currently being decoded etc. is handled by the processor core. This code extracts information such as sample frequency, bitrate of the bitstream, stereo encoding method and the Huffman tables to use for extracting the audio data.

Huffman Decoder

The Huffman decoder for MP3 is implemented with a number of fixed tables, optimized for maximum compression of the audio data. The decoder is implemented in hardware, controlled by the processor. It in turn uses the bitstream reading hardware.

Dequantizer

The dequantizer takes the quantized frequency band output from the Huffman decoder, and along with scaling information encoded in the frame side-information, scales (using a large look-up table) the data into a floating-point form. This is implemented in software on the processor

Stereo Decoding

The stereo decoding algorithm takes the dequantized frame information from the processor memory bank, converts it from floating point to fixed point and decodes Mixed-Stereo signals for the filter banks.

IMDCT

A bank of IDCT (Inverse Modified Discrete Cosine Transform) filters is used to transform the frequency data into an intermediate form before the final polyphase filtering stage.

Polyphase Filter Bank

The polyphase filter bank takes the IMDCT output and transforms the intermediate frequency data into the final sample. This is the most multiply intensive of the transformations and so has a heavily optimized algorithm.

Decoder Architecture

The MMT-based MP3 player uses the following shared resources:

Memory banks 0 and 1

Audio chip

Shared pins between the two FPGAs

Touch screen driver

One fixed-point multiplier on the FPGA.

The player has been designed so that most of the modules run in parallel in a pipeline. However there are limited resources available to be shared between these various processes. Thus a locking system has been implemented using mutual exclusion processes and the resources partitioned carefully amongst the competing processes. The bitstream reading, Huffman decoding, processor and stereo decoding have been allocated to Memory Bank 0.

The locking on Bank 0 has been designed so that the resource is automatically granted to the processor unless the other processes specifically request it. To implement this, the processor has a halt signal, so that it can run continuously until the memory is requested by one of the three other processes. The next time the processor tries to fetch a new instruction it stops, signals that it is halted and the resource lock is granted to the waiting process. On completion of the process, the halt signal is unset and the processor continues.

The filter banks require both scratch space and multiplication resources and thus both compete for Bank 1 and the multiplier.

The processor is in overall control of the hardware, deciding what parameters to pass to the filter banks and the Huffman decoder. In order to pass data to and from the various other processes, the hardware has been mapped into the address space above the physical memory (1 Meg). The hardware control logic include 16 32-bit registers, which can be used to supply parameters to the hardware, or read back data from the hardware (for instance—the Huffman tables to use for a particular frame are passed to the hardware through some these status registers, and the total number of bits read while decoding returned in another register for the processor to read). Control logic for the hardware has also been mapped into a number of addresses. Thus to start the Huffman decoding process, the processor writes to the appropriate address and then is stalled until decoding completes. Similarly the processor writes to another address to start the filter banks, but as these can run simultaneously (not having any resources in common with which to conflict), the processor can continue immediately the start signal is sent.

The example code in FIG. 8E shows the implementation of the memory-mapped hardware control.

As well as the hardware (FPGA configuration) for the decoder, there is also an amount of code for the processor which must be loaded into the flash memory. Processing has been partitioned between the hardware and the processor according to two criteria. Firstly, some code is written for the processor because it is control-heavy but does not need to run particularly fast (thus saving space on the FPGA) but also some code has been partitioned onto the processor so that, with minor changes to the program code, the decoder can be changed so that it can handle MPEG2 audio streams—and thus be used in conjuction with a video decoder for full movie playing.

Usage

The MP3 decoder core is designed to occupy one FPGA on the board set forth below in the section entitled Illustrative Reconfigurable Logic Device, and to receive commands and bitstream data from the other FPGA via communications implemented on the shared pins. The protocol is defined below as well.

When the MP3 decoder starts up, it performs internal initialization, and then sends a request for program code to the other FPGA. Having done this, it then does nothing until a command is sent. On receipt of a PLAY instruction, it will send requests for MP3 bitstream as required, and play the audio. When the audio stream is complete, the server FPGA should send a STOP command.

One skilled in the art will understand the general concepts of audio and video encoding and decoding (compressing and decompressing). For those requiring more information, detailed information about MPEG, MP3 and the MP3 decoding process (including the reference source code) is available on the Internet at: http://www.mpeg.org/.

The MP3 Encoder

Encoding MP3 according to the present invention is the reverse of the encoding process set forth above. The compression process involves a number of steps: Firstly the audio data is sampled, and transformed via the filter banks into the frequency domain. This frequency data is then quantized and redundant data discarded using an appropriate psychoacoustic model. After this the resulting data is compressed further using Huffman encoding and encoded into a fixed rate bitstream depending upon the compression rate chosen. Typical compression ratios for MP3 are 8-10 times that of the original raw sample data, making it a perfect format for distribution of music over the Internet.

The present invention provides much greater speed than is currently available in software. Thus, live audio can be converted to an MP3 bitstream in real time with full quality. This can be used to present live broadcasts in streaming audio, such as a live concert or voice over Internet for IP telephony and gaming. For example, a preferred embodiment is able to compress data at 32 times a real time data input rate. Other applications enabled include fast archiving of a Compact Disc (CD) collection.

FIG. 8F illustrates a system 874 for encoding (compressing) audio data such as compression into MPEG 1 Layer III (MP3) format. An analysis engine 875 implemented in reconfigurable hardware analyzes audio data. A transformation engine 876 utilizing filter banks transforms the audio data into a frequency domain. A data reduction engine 877 (quantizer) quantizes the transformed audio data for discarding redundant data. The audio data is further compressed using table based encoding, such as Huffman encoding. A stream encoder 878 implemented in reconfigurable hardware encodes the quantized audio data into a fixed rate bitstream.

In one embodiment of the present invention, the reconfigurable hardware includes at least one Field Programmable Gate Array (FPGA). Preferably, the analysis engine, the transformation engine, the data reduction engine, and the stream encoder operate simultaneously and in parallel in a pipeline. If sufficient speed is achieved, the bit rate in or out of the system can be increased to improve quality.

Buffers 879 such as ping pong buffers can be used between the analysis engine, the transformation engine, the data reduction engine, and the stream encoder for controlling a flow of the data through the system. (See FIG. 8F.)

In another embodiment, the data analysis, data transformation, data quantization, and stream encoding are each performed simultaneously in substantially the same time period. In other words, granules or frames of data in each of the stages in the pipeline at any given time are processed in the same amount of time.

Also, Huffman tables can be analyzed in parallel, and one of the Huffman tables is selected for the Huffman encoding. The selection can be based on giving the best sound quality, most compression (table that results in the least amount of bits), etc. Thus the present invention provides better quality sound because of the enhanced processing capabilities. Further, the Huffman table can be selected in real time during a live broadcast to provide the most compression, thereby reducing the quantity of data that is transmitted during the broadcast.

In yet another embodiment of the present invention, the data analysis, data transformation, data quantization, and stream encoding are performed in real time for encoding live audio data. In a further embodiment of the present invention, video data is also encoded such as in MPEG or AVI format.

Multimedia Device

FIG. 9A depicts a process 900 for providing a hardware-based reconfigurable multimedia device. In operation 902, a default multimedia application is initiated on a reconfigurable multimedia logic device, which can be a device similar to that discussed with respect to FIGS. 9B-15 below. A request for a second multimedia application is received from a user in operation 904. Configuration data is retrieved from a data source in operation 906, and, in operation 908, is used to configure the logic device to run the second multimedia application. In operation 910, the second multimedia application is run on the logic device.

According to the present invention, the multimedia applications can include an audio application, a video application, a voice-based application, a video game application, and/or any other type of multimedia application.

In one embodiment of the present invention, the configuration data is retrieved from a server located remotely from the logic device utilizing a network such as the Internet.

In another embodiment of the present invention, the logic device includes one or more Field Programmable Gate Arrays (FPGAs). Ideally, a first FPGA receives the configuration data and uses the configuration data to configure a second FPGA. Another embodiment of the present invention includes first and second FPGAs that are clocked at different speeds. In a preferred embodiment, the default multimedia application and the second multimedia application are both able to run simultaneously on the logic device, regardless of the number of FPGAs.

Illustrative Reconfigurable Logic Device

A reconfigurable logic device according to a preferred embodiment of the present invention includes a bi-directional 16 bit communications driver for allowing two FPGAs to talk to each other. Every message from one FPGA to the other is preceded by a 16 bit ID, the high eight bits of which identify the type of message (AUDIO, FLASH, RECONFIGURATION etc . . . ) and the low identify the particular request for that hardware (FLASH_READ etc . . . ). The id codes are processed in the header file fp0server.h, and then an appropriate macro procedure is called for each type of message (e.g. for AUDIO AudioRequest is called) which then receives and processes the main body of the communication.

Preferably, the FPGAs are allowed to access external memory. Also preferably, arbitration is provided for preventing conflicts between the FPGAs when the FPGAs access the same resource. Further, the need to stop and reinitialize drivers and hardware when passing from one FPGA to the other is removed.

As an option, shared resources can be locked from other processes while communications are in progress. This can include communications between the FPGAs and/or communication between an FPGA and the resource.

In one embodiment of the present invention, an application on one of the FPGAs is allowed to send a command to another of the FPGAs. In another embodiment of the present invention, one or more of the FPGAs is reconfigured so that it can access the resource.

In use, the server process requires a number of parameters to be passed to it. These are:

PID: Used for locking shared resources (such as the FLASH) from other processes while communications are in progress.

usendCommand, uSendLock: A channel allowing applications on FPO to send commands to applications on FP1 and a one-bit locking variable to ensure the data is not interleaved with server-sent data.

uSoundOut, uSoundIn: Two channels mirroring the function of the audio driver. Data sent to uSoundOut will be played (assuming the correct code in FP1) out of the MMT2000 speakers, and data read from uSoundIn is the input to the MMT2000 microphone. The channels are implemented in such a way that when the sound driver blocks, the communication channel between FPGAs is not held up.

MP3Run: A one bit variable controlling the MP3 GUI. The server will activate or deactivate the MP3 GUI on receipt of commands from FP1.

ConfigAddr: A 23 bit channel controlling the reconfiguration process. When the flash address of a valid FPGA bitfile is sent to this channel, the server reconfigures FP1 with the bitmap specified.

The data transfer rate between the two FPGAs in either direction is preferably about 16 bits per 5 clock cycles (in the clock domain of the slowest FPGA), for communicating between FPGAs that may be running at different clock rates.

Several Handel-C macros which may be generated for use in various implementations of the present invention are set forth in Table 1. The document “Handel-C Language Reference Manual: version 3,” incorporated by reference above, provides more information about generating macros in Handel-C.

TABLE 1

| Filename | Type | Macro Name | Purpose |
|---|---|---|---|
| Fp0server.h | Resource server | Fp0server() | Resource server for FP0 for the |
| | | | MMT2000 IPPhone/MP3 |
| | | | project |
| Audiorequest.h | Audio Server | AudioRequest() | Audio server for allowing |
| | | | sharing of sound hardware |
| Flashrequest.h | Data server | FlashRequest() | Server for allowing FP1 access |
| | | | to the FLASH memory |
| Mp3request.h | MP3 server | MP3Request() | Server to control the MP3 |
| | | | application and feed it MP3 |
| | | | bitstream data when requested. |
| Reconfigurerequest.h | Reconfiguration | Reconfigurerequest() | Allows FP1 to request to be |
| | hardware | | reconfigured, at an application |
| | | | exit. |
| Fpgacomms.h | Communications | Fpgacomms() | Implements two unidirectional |
| | hardware | | 16 bit channels for |
| | | | communicating between the |
| | | | two FPGAs |

Illustrative Device Development Platform

FIG. 9B is a diagrammatic overview of a board 950 of the resource management device according to an illustrative embodiment of the present invention. It should be noted that the following description is set forth as an illustrative embodiment of the present invention and, therefore, the various embodiments of the present invention should not be limited by this description. As shown, the board can include two Xilinx Virtex™ 2000e FPGAs 952, 954, an Intel StrongARM SA1110 processor 956, a large amount of memory 958, 960 and a number of I/O ports 962. Its main features are listed below:

Two XCV 2000e FPGAs each with sole access to the following devices:

Two banks (1 MB each) of SRAM (256K×32 bits wide)

Parallel port

Serial port

ATA port

The FPGAs share the following devices:

VGA monitor port

Eight LEDs

2 banks of shared SRAM (also shared with the CPU)

USB interface (also shared with the CPU)

The FPGAs are connected to each other through a General Purpose I/O (GPIO) bus, a 32 bit SelectLink bus and a 32 bit Expansion bus with connectors that allow external devices to be connected to the FPGAs. The FPGAs are mapped to the memory of the StrongARM processor, as variable latency I/O devices.

The Intel StrongARM SA1110 processor has access to the following:

64 Mbytes of SDRAM

16 Mbytes of FLASH memory

LCD port

IRDA port

Serial port

It shares the USB port and the shared SRAM with the FPGAs.

In addition to these the board also has a Xilinx XC95288XL CPLD to implement a number of glue logic functions and to act as a shared RAM arbiter, variable rate clock generators and JTAG and MultiLinx SelectMAP support for FPGA configuration.

A number of communications mechanisms are possible between the ARM processor and the FPGAs. The FPGAs are mapped into the ARM's memory allowing them to be accessed from the ARM as through they were RAM devices. The FPGAs also share two 1 MB banks of SRAM with the processor, allowing DMA transfers to be performed. There are also a number of direct connections between the FPGAs and the ARM through the ARM's general purpose I/O (GPIO) registers.

The board is fitted with 4 clocks, 2 fixed frequency and 2 PLLs. The PLLs are programmable by the ARM processor.

The ARM is configured to boot into Angel, the ARM onboard debugging monitor, on power up and this can be connected to the ARM debugger on the host PC via a serial link. This allows applications to be easily developed on the host and run on the board.

There are a variety of ways by which the FPGAs can be configured. These are:

By an external host using JTAG or MultiLinx SelectMAP

By the ARM processor, using data stored in either of the Flash RAMs or data acquired through one to the serial ports (USB, IRDA or RS232).

By the CPLD from power-up with data stored at specific locations in the FPGA FlashRAM.

By one of the other FPGAs.

Appendices A and B set forth the pin definition files for the master and slave FPGAs on the board. Appendix C describes a parallel port interface that gives full access to all the parallel port pins. Appendix D discusses a macro library for the board of the present invention.

StrongARM

The board is fitted with an Intel SA1110 Strong ARM processor. This has 64 Mbytes of SDRAM connected to it locally and 16 Mbytes of Intel StrataFLASH™ from which the processor may boot. The processor has direct connections to the FPGAs, which are mapped to its memory map as SRAM like variable latency I/O devices, and access to various I/O devices including USB, IRDA, and LCD screen connector and serial port. It also has access to 2 MB of SRAM shared between the processor and the FPGAs.

Memory Map

The various devices have been mapped to the StrongARM memory locations as shown in Table 2:

TABLE 2

| Address Location | Contents |
|---|---|
| 0x00000000 | Flash Memory 16 MB 16 bits wide. |
| 0x08000000 | CPLD see CPLD section for list of registers |
| 0x10000000 | Shared RAM bank 1 256K words x32 |
| 0x18000000 | Shared RAM bank 0 256K words x32 |
| 0x40000000 | FPGA access (nCS4) |
| 0x48000000 | FPGA access (nCS5) |
| 0xC0000000 | SDRAM bank 0 |
| 0xD0000000 | SDRAM bank 1 |

The suggested settings for the StrongARM's internal memory configuration registers are shown in Table 3:

TABLE 3

| Register | Value |
|---|---|
| MDCNFG | 0x A165 A165 |
| MDREF | 0x 8230 02E1 |
| MDCADS0 | 0x 5555 5557 |
| MDCAS1 | 0x 5555 5555 |
| MDCAS2 | 0x 5555 5555 |
| MSC0 | 0x 2210 4B5C |
| MSC1 | 0x 0009 0009 |
| MSC2 | 0x 2210 2210 |

Where the acronyms are defined as:

MDCNFG—DRAM configuration register

MSC0, 1, 2—Static memory control registers for banks 0, 1, 2

MDREF—DRAM refresh control register

MDCAS—CAS rotate control register for DRAM banks

The CPU clock should be set to 191.7 MHz (CCF=9). Please refer to the StrongARM Developers Manual, available from Intel Corporation, for further information on how to access these registers.

Flash Memory

The Flash RAM is very slow compared to the SRAM or SDRAM. It should only be used for booting from; it is recommended that code be copied from Flash RAM to SDRAM for execution. If the StrongARM is used to update the Flash RAM contents then the code must not be running from the Flash or the programming instructions in the Flash will get corrupted.

SDRAM

A standard 64 MB SDRAM SODIMM is fitted to the board and this provides the bulk of the memory for the StrongARM. Depending upon the module fitted the SDRAM may not appear contiguous in memory.

Shared RAM Banks

These RAM banks are shared with both FPGAs. This resource is arbitrated by the CPLD and may only be accessed once the CPLD has granted the ARM permission to do so. Requesting and receiving permission to access the RAMs is carried out through CPLD register 0x10. Refer to the CPLD section of this document for more information about accessing the CPLD and its internal registers from the ARM processor. See Appendix D.

FPGA Access

The FPGAs are mapped to the ARM's memory and the StrongARM can access the FPGAs directly using the specified locations. These locations support variable length accesses so the FPGA is able to prevent the ARM from completing the access until the FPGA is ready to receive or transmit the data. To the StrongARM these will appear as static memory devices, with the FPGAs having access to the Data, Address and Chip Control signals of the RAMs.

The FPGAs are also connected to the GPIO block of the processor via the SAIO bus. The GPIO pins map to the SAIO bus is shown in Table 4.

TABLE 4

| GPIO pins | SAIO lines |
|---|---|
| 0, 1 | 0, 1 |
| 10, 11 | 2, 3 |
| 17-27 | 4-14 |

Of these SAIO[0:10] connect to the FPGAs and SAIO[0:14] connect to connector CN25 on the board. The FPGAs and ARM are also able to access 2 MB of shared memory, allowing DMA transfers between the devices to be performed.

I/O Devices

The following connectors are provided:

LCD Interface connector with backlight connector

IRDA connector (not 5V tolerant)

GPIO pins (not 5V tolerant)

Serial port

Reset button to reboot the StrongARM

The connections between these and the ARM processor are defined below in Tables 5-8:

TABLE 5
ARM - LCD connections (CN27)

| LCD connector | | |
|---|---|---|
| pin no. | ARM pin | Description |
| 10..6 | LCD0..4 | BLUE0..4 |
| 18..16 | LCD5..7 | GREEN0..2 |
| 15..13 | GPIO2..GPIO4 | GREEN3..5 |
| 24..20 | GPIO5..GPIO9 | RED0..RED4 |
| 27 | LCD_FCLK | 16 |
| 28 | LCD_LCLK | 17 |
| 29 | LCD_PCLK | 18 |
| 4 | LCD_BIAS | 19 |
| 2, 3, (1) | | +5V |
| (1), 5, 11, 12, 19, | | GND |
| 25, 26, 30 | | |

TABLE 6
ARM IRDA connections (CN8A)

| IRDA | | |
|---|---|---|
| connector pin no. | ARM pin | Description |
| 2 | RxD2 | |
| 1 | TxD2 | |
| 3 | GPIO12 | |
| 4 | GPIO13 | |
| 5 | GPIO14 | |
| 6, 8 | | GND |
| 7 | | +3.3V |

TABLE 7
ARM GPIO - CN20AP connections

| CN20AP pin no. | GPIO pins |
|---|---|
| 2, 3 | 0, 1 |
| 4, 5 | 10, 11 |
| 6-16 | 17-27 |
| 17, 19 | +3.3V |
| 18, 20 | GND |

TABLE 8
ARM - Serial Port connections (CN23)

| Serial Port | | |
|---|---|---|
| connector pin no. | ARM pin | Description |
| 2 | RxD1 | |
| 8 | RxD3 | |
| 3 | TxD1 | |
| 7 | TxD3 | |
| 1, 4, 6, 9 | | Not connected |
| 5 | | GND |

The serial port is wired in such away that two ports are available with a special lead if handshaking isn't required.

Angel

Angel is the onboard debug monitor for the ARM processor. It communicates with the host PC over the serial port (a null modem serial cable will be required). The ARM is setup to automatically boot into Angel on startup—the startup code in the ARM's Flash RAM will need to be changed if this is not required.

When Angel is in use 32 MBs of SDRAM are mapped to 0x00000000 in memory and are marked as cacheable and bufferable (except the top 1 MB). The Flash memory is remapped to 0x40000000 and is read only and cacheable. The rest of memory is mapped one to one and is not cacheable or bufferable.

Under Angel it is possible to run the FPGA programmer software which takes a bitfile from the host machine and programs the FPGAs with it. As the .bit files are over 1 MB in size and a serial link is used for the data transfer this is however a very slow way of configuring the FPGAs.

Virtex FPGA's

Two Virtex 2000e FPGAs are fitted to the board. They may be programmed from a variety of sources, including at power up from the FLASH memory. Although both devices feature the same components they have different pin definitions; Handel-C header files for the two FPGAs are provided. One of the devices has been assigned ‘Master’, the other ‘Slave’. This is basically a means of identifying the FPGAs, with the Master having priority over the Slave when requests for the shared memory are processed by the CPLD. The FPGA below the serial number is the Master.

One pin on each of the FPGAs is defined as the Master/Slave define pin. This pin is pulled to GND on the Master FPGA and held high on the Slave. The pins are:

Master FPGA: C9

Slave FPGA: D33

The following part and family parameters should be used when compiling a Handel-C program for these chips:

set family=Xilinx4000E;

set part=“XV2000e-6-fg680”;

Clocks

Two socketed clock oscillator modules may be fitted to the board. CLKA is fitted with a 50 MHz oscillator on dispatch and the CLKB socket is left to be fitted by the user should other or multiple frequencies to required. A +5V oscillator module should be used for CLKB.

Two on board PLLs, VCLK and MCLK, provide clock sources between 8 MHz and 100 MHz (125 MHz may well be possible). These are programmable by the ARM processor. VCLK may also be single stepped by the ARM.

This multitude of clock sources allows the FPGAs to be clocked at different rates, or to let one FPGA have multiple clock domains.

The clocks are connected to the FPGAs, as described in Table 9 and Appendices A and B:

TABLE 9

| | Master FPGA | Slave FPGA |
|---|---|---|
| Clock | pin | pin |
| CLKA | A20 | D21 |
| CLKB | D21 | A20 |
| VCLK | AW19 | AU22 |
| MCLK | AU22 | AW19 |

Programming the FPGAs

The FPGAs may be programmed from a variety of sources:

Parallel III cable JTAG

MultiLinx JTAG

MultiLinx SelectMAP

ARM processor

From the other FPGA

Power up from FLASH memory (FPGA FLASH memory section).

When using any of the JTAG methods of programming the FPGAs you must ensure that the Bitgen command is passed the option “-g startupclk:jtagclk”. You will also need a .jed file for the CPLD or a .bsd file, which may be found in “Xilinx\xc9500x1data\xc95288XL_tq144.bsd”. The StrongARM also requires a .bsd file, which may be found on the Intel website http://developer.intel.com/design/strong/bsdl/sa/1110_b1.bsd. When downloaded this file will contain HTML headers and footers which will need to be removed first. Alternatively, copies of the required .bsd files are included on the supplied disks.

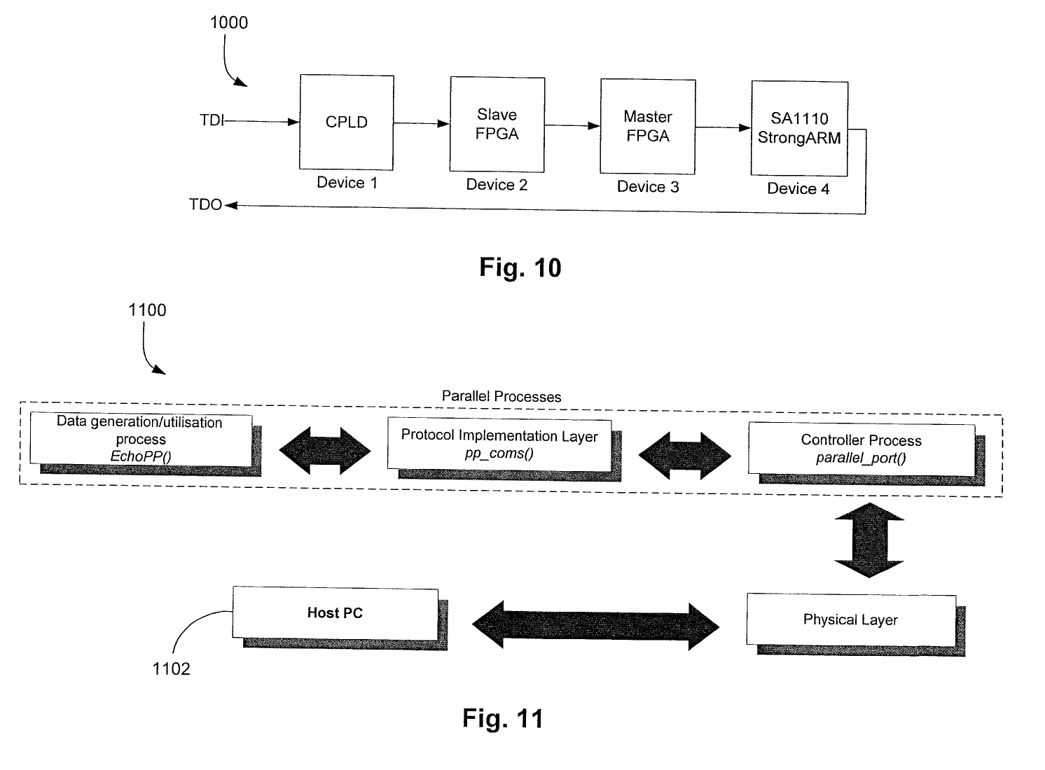

The JTAG chain 1000 for the board is shown in FIG. 10.

The connections when using the Xilinx Parallel III cable and the ‘JTAG Programmer’ are set forth in Table 10:

TABLE 10
Parallel III Cable JTAG

| CN24 pin number | JTAG Connector |
|---|---|
| 1 | TMS |
| 2 | cut pin |
| 3 | TDI |
| 4 | TDO |
| 5 | not used |
| 6 | TCK |
| 7 | not used |
| 8 | GND |
| 9 | POWER |

With the Xilinx cables it may be easier to fit the flying ends into the Xilinx pod so that a number of cables may be connected to the board in one go.

MultiLinx JTAG

The board has support for programming using MultiLinx. CN3 is the only connector required for JTAG programming with MultiLinx and is wired up as described in Table 11. (Note that not used signals may be connected up to the MultiLinx if required.)

TABLE 11

| CN3 pin number | MultiLinx | CN3 pin number | MultiLinx |
|---|---|---|---|
| 1 | not used | 2 | Vcc |
| 3 | RD(TDO) | 4 | GND |
| 5 | not used | 6 | not used |
| 7 | not used | 8 | not used |
| 9 | TDI | 10 | not used |
| 11 | TCK | 12 | not used |
| 13 | TMS | 14 | not used |
| 15 | not used | 16 | not used |
| 17 | not used | 18 | not used |
| 19 | not used | 20 | not used |

MultiLinx SelectMAP

JP3 must be fitted when using MulitLinx SelectMap to configure the FPGAs. This link prevents the CPLD from accessing the FPGA databus to prevent bus contention. This also prevents the ARM accessing the FPGA Flash memory and from attempting FPGA programming from power up. Connectors CN3 and CN4 should be used for Master FPGA programming and CN10 and CN11 for programming the Slave FPGA. See Tables 12-13.

TABLE 12

| CN3/CN10 pin | | CN3/CN10 pin | |
|---|---|---|---|
| number | MultiLinx | number | MultiLinx |
| 1 | not used | 2 | +3v3 |
| 3 | not used | 4 | GND |
| 5 | not used | 6 | not used |
| 7 | not used | 8 | CCLK |
| 9 | not used | 10 | DONE |
| 11 | not used | 12 | not used |
| 13 | not used | 14 | nPROG |
| 15 | not used | 16 | nINIT |
| 17 | not used | 18 | not used |
| 19 | not used | 20 | not used |

TABLE 13

| CN4/CN11 pin | | CN4/CN11 pin | |
|---|---|---|---|
| number | MultiLinx | number | MultiLinx |
| 1 | CS0 | 2 | D0 |
| 3 | not used | 4 | D1 |
| 5 | not used | 6 | D2 |
| 7 | not used | 8 | D3 |
| 9 | not used | 10 | D4 |
| 11 | not used | 12 | D5 |
| 13 | RS(RDWR) | 14 | D6 |
| 15 | not used | 16 | D7 |
| 17 | DY/BUSY | 18 | not used |
| 19 | not used | 20 | not used |

In practice MultiLinx SelectMap was found to be a very tiresome method of programming the FPGAs due to the large number of flying leads involved and the fact that the lack of support for multi FPGA systems means that the leads have to connected to a different connector for configuring each of the FPGA.

ARM Processor

The ARM is able to program each FPGA via the CPLD. The FPGAs are set up to be configured in SelectMap mode. Please refer to the CPLD section of this document and Xilinx Datasheets on Virtex configuration for more details of how to access the programming pins of the FPGAs and the actual configuration process respectively. An ARM program for configuring the FPGAs with a bit file from the host PC under Angel is supplied. This is a very slow process however as the file is transferred over a serial link. Data could also be acquired from a variety of other sources including USB and IRDA or the onboard Flash RAMs and this should allow an FPGA to be configured in under 0.5 seconds.

Configuring one FPGA from the other FPGA

One FPGA is able to configure the other through the CPLD in a manner similar to when the ARM is configuring the FPGAs. Again, please refer to the CPLD section of this document and the Xilinx data sheets for more information.

Configuring on power up from Flash Memory

The board can be set to boot the FPGAs using configuration data stored in this memory on power up. The following jumpers should be set if the board is required to boot from the Flash RAM:

JP1 should be fitted if the Master FPGA is to be programmed from power up

JP2 should be fitted if the Slave FPGA is to be programmed from power up.

If these jumpers are used the Flash RAM needs to be organized as shown in Table 14:

TABLE 14

| | | |
|---|---|---|
| Open | Open | All of FLASH memory available for FLASH data |
| Fitted | Open | Master FPGA configuration data to start at |
| | | address 0x0000 |
| Open | Fitted | Slave FPGA configuration data to start at |
| | | address 0x0000 |
| Fitted | Fitted | Master FPGA configuration data to start at |
| | | address 0x0000 followed by slave FPGA |
| | | configuration data. |

The configuration data must be the configuration bit stream only, not the entire .bit file. The bit file contains header information which must first be stripped out and the bytes of the configuration stream as stored in the .bit file need to be mirrored—i.e. a configuration byte stored as 00110001 in the bit file needs to be applied to the FPGA configuration data pins are 10001100.

For more information on configuration of Xilinx FPGAs and the bit format refer to the appropriate Xilinx datasheets.

FPGA FLASH Memory

16 MB of Intel StrataFLASH™ Flash memory is available to the FPGAs. This is shared between the two FPGAs and the CLPD and is connected directly to them. The Flash RAM is much slower than the SRAMs on the board, having a read cycle time of 120 ns and a write cycle of around 80 ns.

The FPGAs are able to read and write to the memory directly, while the ARM processor has access to it via the CPLD. Macros for reading and writing simple commands to the Flash RAM's internal state machine are provided in the klib.h macro library (such as retrieving identification and status information for the RAM), but it is left up to the developer to enhance these to implement the more complex procedures such as block programming and locking. The macros provided are intended to illustrate the basic mechanism for accessing the Flash RAM.

When an FPGA requires access to the Flash RAM it is required to notify the CLPD by setting the Flash Bus Master signal low. This causes the CPLD to tri-state its Flash RAM pins to avoid bus contention. Similarly, as both FPGAs have access to the Flash RAM over a shared bus, care has to be taken that they do not try and access the memory at the same time (one or both of the two FPGAs may be damaged if they are driven against each other). It is left up to the developer to implement as suitable arbitration system if the sharing of this RAM across both FPGAs is required.

The connections between this RAM and the FPGAs are set forth in Table 15:

TABLE 15

| Flash RAM pin | Master FPGA | Slave FPGA pin |
|---|---|---|
| nBYTE | C18 | B24 |
| F bus master pin | C17 | C26 |

Local SRAM

Each FPGA has two banks of local SRAM, arranged as 256K words×32 bits. They have an access time of 15 ns.

In order to allow single cycle accesses to these RAMs it is recommended that the external clock rate is divided by 2 or 3 for the Handel-C clock rate. I.e. include the following line in your code:

set clock=external_divide “A20” 2; // or higher

For an external_divide 2 clock rate the RAM should be defined as:

macro expr sram_local_bank0_spec =

{

offchip = 1,
wegate = 1,
data = DATA_pins,
addr = ADDRESS_pins,
cs = { “E2”, “F1”, “J4”, “F2”,

“H3”},

we = { “H4” },
oe = { “E1” }

};

If the clock is divided by more than 2 replace the wegate parameter with

westart=2,

welength=1,

The connections to these RAMs are as follows:

TABLE 16

| | Master | | Master | |
|---|---|---|---|---|
| | FPGA | Slave FPGA | FPGA | Slave FPGA |
| SRAM Pin | SRAM 0 | SRAM 0 | SRAM 1 | SRAM 1 |
| D31 | W1 | AA39 | AT3 | AR37 |
| D30 | AB4 | AB35 | AP3 | AR39 |
| D29 | AB3 | Y38 | AR3 | AR36 |
| D28 | W2 | AB36 | AT2 | AT38 |
| D27 | AB2 | Y39 | AP4 | AR38 |
| D26 | V1 | AB37 | AR2 | AP36 |
| D25 | AA4 | AA36 | AT1 | AT39 |
| D24 | V2 | W39 | AN4 | AP37 |
| D23 | AA3 | AA37 | AR1 | AP38 |
| D22 | U1 | W38 | AN3 | AP39 |
| D21 | W3 | W37 | AP2 | AN36 |
| D20 | U2 | V39 | AN2 | AN38 |
| D19 | W4 | W36 | AP1 | AN37 |
| D18 | T1 | U39 | AM4 | AN39 |
| D17 | V3 | V38 | AN1 | AM36 |
| D16 | T2 | U38 | AM3 | AM38 |
| D15 | V4 | V37 | AL4 | AM37 |
| D14 | V5 | T39 | AM2 | AL36 |
| D13 | U3 | V36 | AL3 | AM39 |
| D12 | R2 | T38 | AM1 | AL37 |
| D11 | U4 | V35 | AL2 | AL38 |
| D10 | P1 | R39 | AL1 | AK36 |
| D9 | U5 | U37 | AK4 | AL39 |
| D8 | P2 | U36 | AK2 | AK37 |
| D7 | T3 | R38 | AK3 | AK38 |
| D6 | N1 | U35 | AK1 | AJ36 |
| D5 | N2 | P39 | AJ4 | AK39 |
| D4 | T4 | T37 | AJ1 | AJ37 |
| D3 | M1 | P38 | AJ3 | AJ38 |
| D2 | R3 | T36 | AH2 | AH37 |
| D1 | M2 | N39 | AJ2 | AJ39 |
| D0 | R4 | N38 | AH3 | AH38 |
| A17 | L1 | R37 | AG1 | AH39 |
| A16 | L2 | M39 | AG4 | AG38 |
| A15 | N3 | R36 | AF2 | AG36 |
| A14 | K1 | M38 | AG3 | AG39 |
| A13 | N4 | P37 | AF1 | AG37 |
| A12 | K2 | L39 | AF4 | AF39 |
| A11 | M3 | P36 | AF3 | AF36 |
| A10 | J1 | N37 | AE2 | AE38 |
| A9 | L3 | L38 | AE4 | AF37 |
| A8 | J2 | N36 | AE’ | AF38 |
| A7 | L4 | K39 | AE3 | AE39 |
| A6 | H1 | M37 | AD2 | AE36 |
| A5 | K3 | K38 | AD4 | AD38 |
| A4 | H2 | L37 | AD1 | AE37 |
| A3 | K4 | J39 | AC1 | AD39 |
| A2 | G1 | L36 | AB1 | AD36 |
| A1 | G2 | J38 | AC5 | AC38 |
| A0 | J3 | K37 | AA2 | AC39 |
| CS | E2, F1, J4, | J36, H38, | AB5, AC4, | AB38, |
| | F2, H3 | J37, K36, | AA1, AC3, | AD37, |
| | | H39 | Y1 | AB39, |
| | | | | AC35, |
| | | | | AC37 |
| WE | H4 | G38 | Y2 | AA38 |
| OE | E1 | G39 | AC2 | AC36 |
| D31 | W1 | AA39 | AT3 | AR37 |

Shared SRAM

Each FPGA has access two banks of shared SRAM, again arranged as 256K words×32 bits. These have a 16ns access time. A series of quick switches are used to switch these RAMs between the FPGAs and these are controlled by the CPLD which acts as an arbiter. To request access to a particular SRAM bank the REQUEST pin should be pulled low. The code should then wait until the GRANT signal is pulled low by the CPLD in response.

The Handel-C code to implement this is given below:

// define the Request and Grant interfaces for the Shared SRAM

unsigned 1 shared_bank0_request=1;

unsigned 1 shared_bank1_request=1;

interface bus_out( )

sharedbk0reg(shared_bank0_request) with

sram_shared_bank0_request_pin;

interface bus_out( )

sharedbk1reg(shared_bank1_request) with

sram_shared_bank1_request_pin;

interface bus_clock_in(unsigned 1)

shared_bank0_grant( ) with

sram_shared_bank0_grant_pin;

interface bus_clock_in(unsigned 1)

shared_bank1_grant( ) with

sram_shared_bank1_grant_pin;

// Access to a shared RAM bank

{

shared_bank0_request=0;

while (shared_bank0_grant.in) delay;

}

// perform accesses . . .

// release bank

shared_bank0_request=1;

The RAMs should be defined in the same manner as the local RAMs. (See above.)

The connections to the shared RAMs are given in Table 17:

TABLE 17

| Shared | Master FPGA | Slave FPGA | Master | Slave FPGA |
|---|---|---|---|---|
| SRAM | Shared SRAM | Shared | FPGA Shared | Shared |
| pin | 0 | SRAM 0 | SRAM 1 | SRAM 1 |
| D31 | AA39 | W1 | AR37 | AT3 |
| D30 | AB35 | AB4 | AR39 | AP3 |
| D29 | Y38 | AB3 | AR36 | AR3 |
| D28 | AB36 | W2 | AT38 | AT2 |
| D27 | Y39 | AB2 | AR38 | AP4 |
| D26 | AB37 | V1 | AP36 | AR2 |
| D25 | AA36 | AA4 | AT39 | AT1 |
| D24 | W39 | V2 | AP37 | AN4 |
| D23 | AA37 | AA3 | AP38 | AR1 |
| D22 | W38 | U1 | AP39 | AN3 |
| D21 | W37 | W3 | AN36 | AP2 |
| D20 | V39 | U2 | AN38 | AN2 |
| D19 | W36 | W4 | AN37 | AP1 |
| D18 | U39 | T1 | AN39 | AM4 |
| D17 | V38 | V3 | AM36 | AN1 |
| D16 | U38 | T2 | AM38 | AM3 |
| D15 | V37 | V4 | AM37 | AL4 |
| D14 | T39 | V5 | AL36 | AM2 |
| D13 | V36 | U3 | AM39 | AL3 |
| D12 | T38 | R2 | AL37 | AM1 |
| D11 | V35 | U4 | AL38 | AL2 |
| D10 | R39 | P1 | AK36 | AL1 |
| D9 | U37 | U5 | AL39 | AK4 |
| D8 | U36 | P2 | AK37 | AK2 |
| D7 | R38 | T3 | AK38 | AK3 |
| D6 | U35 | N1 | AJ36 | AK1 |
| D5 | P39 | N2 | AK39 | AJ4 |
| D4 | T37 | T4 | AJ37 | AJ1 |
| D3 | P38 | M1 | AJ38 | AJ3 |
| D2 | T36 | R3 | AH37 | AH2 |
| D1 | N39 | M2 | AJ39 | AJ2 |
| D0 | N38 | R4 | AH38 | AH3 |
| A17 | R37 | L1 | AH39 | AG1 |
| A16 | M39 | L2 | AG38 | AG4 |
| A15 | R36 | N3 | AG36 | AF2 |
| A14 | M38 | K1 | AG39 | AG3 |
| A13 | P37 | N4 | AG37 | AF1 |
| A12 | L39 | K2 | AF39 | AF4 |
| A11 | P36 | M3 | AF36 | AF3 |
| A10 | N37 | J1 | AE38 | AE2 |
| A9 | L38 | L3 | AF37 | AE4 |
| A8 | N36 | J2 | AF38 | AE1 |
| A7 | K39 | L4 | AE39 | AE3 |
| A6 | M37 | H1 | AE36 | AD2 |
| A5 | K38 | K3 | AD38 | AD4 |
| A4 | L37 | H2 | AE37 | AD1 |
| A3 | J39 | K4 | AD39 | AC1 |
| A2 | L36 | G1 | AD36 | AB1 |
| A1 | J38 | G2 | AC38 | AC5 |
| A0 | K37 | J3 | AC39 | AA2 |
| CS | J36, H39, K36, | E2, H3, F2, | AC37, AD37, | AB5, AC3, |
| | H38, J37 | J4, F1 | AB38, AC35. | Y1, AA1, |
| | | | AB39 | AC4 |
| OE | G39 | E1 | AC36 | AC2 |
| RE- | A17 | A25 | D18 | C25 |
| QUEST | | | | |
| GRANT | B17 | B25 | E18 | D25 |

Connections to the StrongARM Processor

The FPGAs are mapped to the StrongARMs memory as variable latency I/O devices, and are treated as by the ARM as though they were 1024 entry by 32 bit RAM devices. The address, data and control signals associated with these RAMs are attached directly to the FPGAs. The manner in which the FPGAs interact with the ARM using these signals is left to the developer.

The connections are as shown in Table 18:

TABLE 18

| ARM pin | Master FPGA pin | Slave FPGA pin |
|---|---|---|
| ARMA9 | A33 | C11 |
| ARMA8 | C31 | B11 |
| ARMA7 | B32 | C12 |
| ARMA6 | B31 | A11 |
| ARMA5 | A32 | D13 |
| ARMA4 | D30 | B12 |
| ARMA3 | A31 | C13 |
| ARMA2 | C30 | D14 |
| ARMA0 | D29 | C14 |
| ARMD31 | F39 | G3 |
| ARMD30 | H37 | G4 |
| ARMD29 | F38 | D2 |
| ARMD28 | H36 | F3 |
| ARMD27 | E39 | D3 |
| ARMD26 | G37 | F4 |
| ARMD25 | E38 | D1 |
| ARMD24 | G36 | C5 |
| ARMD23 | D39 | A4 |
| ARMD22 | D38 | D6 |
| ARMD21 | F36 | B5 |
| ARMD20 | D37 | C6 |
| ARMD19 | E37 | A5 |
| ARMD18 | C38 | D7 |
| ARMD17 | B37 | B6 |
| ARMD16 | F37 | C7 |
| ARMD15 | D35 | A6 |
| ARMD14 | B36 | D8 |
| ARMD13 | C35 | B7 |
| ARMD12 | A36 | C8 |
| ARMD11 | D34 | A7 |
| ARMD10 | B35 | D9 |
| ARMD9 | C34 | B8 |
| ARMD8 | A35 | A8 |
| ARMD7 | D33 | C9 |
| ARMD6 | B34 | B9 |
| ARMD5 | C33 | D10 |
| ARMD4 | A34 | A9 |
| ARMD3 | B33 | B10 |
| ARMD2 | D32 | C10 |
| ARMD1 | C32 | D11 |
| ARMD0 | D31 | A10 |
| ARMnWE | A30 | B13 |
| ARMnOE | C29 | D15 |
| ARMnCS4 | A29 | A13 |
| ARMnCS5 | B29 | C15 |
| ARMRDY | B28 | B14 |

Some of the ARM's general purpose I/O pins are also connected to the FPGAs. These go through connector CN25 on the board, allowing external devices to be connected to them (see also ARM section). See Table 19.

TABLE 19

| SAIO bus | ARM GPI/O | Master | Slave |
|---|---|---|---|
| (ARMGPIO) | pins | FPGA pin | FPGA pin |
| SAIO10 | 23 | B9 | B34 |
| SAIO9 | 22 | D10 | C33 |
| SAIO8 | 21 | A9 | A34 |
| SAIO7 | 20 | C10 | D32 |
| SAIO6 | 19 | B10 | B33 |
| SAIO5 | 18 | D11 | C32 |
| SAIO4 | 17 | A10 | D31 |
| SAIO3 | 11 | C11 | A33 |
| SAIO2 | 10 | B11 | C31 |
| SAIO1 | 1 | C12 | B32 |
| SAIO0 | 0 | A11 | B31 |

CPLD Interfacing

Listed in Table 20 are the pins used for setting the Flash Bus Master signal and FP_COMs. Refer to the CPLD section for greater detail on this.

TABLE 20

| | | |
|---|---|---|
| Bus Master pin | C17 | C26 |
| FP_COM pins | B16, E17, A15 | B26, C27, A27 |
| [MSB..LSB] | | |

Local I/O Devices Available to Each FPGA

ATA Port

33 FPGA I/O pins directly connect to the ATA port. These pins have 100Ω series termination resistors which make the port 5V IO tolerant. These pins may also be used as I/O if the ATA port isn't required. See Table 21.

TABLE 21

| ATA line no. | ATA port | Master FPGA | Slave FPGA pin |
|---|---|---|---|
| ATA0 | 1 | AV4 | AT33 |
| ATA1 | 4 | AU6 | AW36 |
| ATA2 | 3 | AW4 | AU33 |
| ATA3 | 6 | AT7 | AV35 |
| ATA4 | 5 | AW5 | AT32 |
| ATA5 | 8 | AU7 | AW35 |
| ATA6 | 7 | AV6 | AU32 |
| ATA7 | 10 | AT8 | AV34 |
| ATA8 | 9 | AW6 | AV32 |
| ATA9 | 12 | AU8 | AW34 |
| ATA10 | 11 | AV7 | AT31 |
| ATA11 | 14 | AT9 | AU31 |
| ATA12 | 13 | AW7 | AV33 |
| ATA13 | 16 | AV8 | AT30 |
| ATA14 | 15 | AU9 | AW33 |
| ATA15 | 18 | AW8 | AU30 |
| ATA16 | 17 | AT10 | AW32 |
| ATA17 | 20 | AV9 | AT29 |
| ATA18 | 21 | AU10 | AV31 |
| ATA19 | 23 | AW9 | AU29 |
| ATA20 | 25 | AT11 | AW31 |
| ATA21 | 28 | AV10 | AV29 |
| ATA22 | 27 | AU11 | AV30 |
| ATA23 | 29 | AW10 | AU28 |
| ATA24 | 31 | AU12 | AW30 |
| ATA25 | 32 | AV11 | AT27 |
| ATA26 | 33 | AT13 | AW29 |
| ATA27 | 34 | AW11 | AV28 |
| ATA28 | 35 | AU13 | AU27 |
| ATA29 | 36 | AT14 | AW28 |
| ATA30 | 37 | AV12 | AT26 |
| ATA31 | 38 | AU14 | AV27 |
| ATA32 | 39 | AW12 | AU26 |

| | |
|---|---|
| GND | 2, 19, 22, 24, 26, 30, 40 |

Parallel Port

A conventional 25 pin D-type connector and a 26 way box header are provided to access this port. The I/O pins have 100Ω series termination resistors which also make the port 5V I/O tolerant. These pins may also be used as I/O if the parallel port isn't required. See Table 22. See also Appendix C.

TABLE 22

| PP line no. | Parallel port pin | Master FPGA pin | Slave FPGA pin |
|---|---|---|---|
| PPO0 | 1 | A8 | A35 |
| PPO1 | 14 | B8 | C34 |
| PPO2 | 2 | D9 | B35 |
| PPO3 | 15 | A7 | D34 |
| PPO4 | 3 | C8 | A36 |
| PPO5 | 16 | B7 | C35 |
| PPO6 | 4 | D8 | B36 |
| PPO7 | 17 | A6 | D35 |
| PPO8 | 5 | C7 | F37 |
| PPO9 | 6 | B6 | B37 |
| PPO10 | 7 | D7 | C38 |
| PPO11 | 8 | A5 | E37 |
| PPO12 | 9 | C6 | D37 |
| PPG13 | 10 | B5 | F36 |
| PPO14 | 11 | D6 | D38 |
| PPO15 | 12 | A4 | D39 |
| PPO16 | 13 | C5 | G36 |

| | |
|---|---|
| GND | 18, 19, 20, 21, 22, 23, 24, 25 |

Serial Port

A standard 9 pin D-type connector with a RS232 level shifter is provided. This port may be directly connected to a PC with a Null Modem cable. A box header with 5V tolerant I/O is also provided. These signals must NOT be connected to a standard RS232 interface without an external level shifter as the FPGAs may be damaged. See Table 23.

TABLE 23

| Serial line no. | Serial port pin no. | Master FPGA pin | Slave FPGA pin |
|---|---|---|---|
| Serial 0 (CTS) | 8 (CTS) | AV3 | AT34 |
| Serial 1 (RxD) | 2 (RxD) | AU4 | AU36 |
| Serial 2 (RTS) | 7 (RTS) | AV5 | AU34 |
| Serial 3 (TxD) | 3 (TxD) | AT6 | AV36 |

| | |
|---|---|
| GND | 5 |
| Not connected | 1, 4, 6, 9 |

Serial Header

Each FPGA also connects to a 10 pin header (CN9/CN16). The connections are shown in Table 24:

TABLE 24

| (CN9/CN16) | Master | Slave |
|---|---|---|
| Header pin no. | FPGA pin | FPGA pin |
| 1 | D1 | E38 |
| 2 | F4 | G37 |
| 3 | D3 | E39 |
| 4 | F3 | H36 |
| 5 | D2 | F38 |
| 6 | G4 | H37 |
| 7 | G3 | F39 |

| | |
|---|---|
| 8, 9 | GND |
| 10 | +5V |

Shared I/O Devices

These divices are shared between the two FPGAs and great care should be taken as to which device at any given time.

VGA Monitor

A standard 15 pin High Density connector with an on-board 4 bit DAC for each colour (Red, Green, Blue) is connected to the FPGAs as set forth in Table 25:

TABLE 25

| VGA line | Master FPGA pin | Slave FPGA pin |
|---|---|---|
| VGA11 (R3) | AV25 | AT16 |
| VGA10 (R2) | AT24 | AW14 |
| VGA9 (R1) | AW25 | AU16 |
| VGA8 (R0) | AU24 | AV15 |
| VGA7 (G3) | AW24 | AR17 |
| VGA6 (G2) | AW23 | AW15 |
| VGA5 (G1) | AV24 | AT17 |
| VGA4 (G0) | AV22 | AU17 |
| VGA3 (B3) | AR23 | AV16 |
| VGA2 (B2) | AW22 | AR18 |
| VGA1 (B1) | AT23 | AW16 |
| VGA0 (B0) | AV21 | AT18 |
| VGA13 | AW26 | AW13 |
| VGA12 | AU25 | AV14 |

LEDs

Eight of the twelve LEDs on the board are connected directly to the FPGAs. See Table 26.

TABLE 26

| LED | Master FPGA pin | Slave FPGA pin |
|---|---|---|
| D5 | AT25 | AU15 |
| D6 | AV26 | AV13 |
| D7 | AW27 | AT15 |
| D8 | AU26 | AW12 |
| D9 | AV27 | AU14 |
| D10 | AT26 | AV12 |
| D11 | AW28 | AT14 |
| D12 | AU27 | AU13 |

GPIO Connector

A 50 way Box header with 5V tolerant I/O is provided. 32 data bits (‘E’ bus) are available and two clock signals. The connector may be used to implement a SelectLink to another FPGA. +3V3 and +5V power supplies are provided via fuses. See Table 27.

TABLE 27

| | GPI/O | | |
|---|---|---|---|
| Expansion | header pin | Master | Slave FPGA |
| bus line | no. | FPGA pin | pin |
| E0 | 11 | AT15 | AW27 |
| E1 | 13 | AV13 | AV26 |
| E2 | 15 | AU15 | AT25 |
| E3 | 17 | AW13 | AW26 |
| E5 | 23 | AT16 | AV25 |
| E6 | 25 | AW14 | AT24 |
| E7 | 27 | AU16 | AW25 |
| E8 | 31 | AV15 | AU24 |
| E9 | 33 | AR17 | AW24 |
| E10 | 35 | AW15 | AW23 |
| E11 | 37 | AT17 | AV24 |
| E12 | 41 | AU17 | AV22 |
| E13 | 43 | AV16 | AR23 |
| E14 | 45 | AR18 | AW22 |
| E15 | 47 | AW16 | AT23 |
| E16 | 44 | AT18 | AV21 |
| E17 | 42 | AV17 | AU23 |
| E18 | 40 | AU18 | AW21 |
| E19 | 38 | AW17 | AV23 |
| E20 | 34 | AT19 | AR22 |
| E21 | 32 | AV18 | AV20 |
| E22 | 30 | AU19 | AW20 |
| E23 | 28 | AW18 | AV19 |
| E24 | 24 | AU21 | AU21 |
| E25 | 22 | AV19 | AW18 |
| E26 | 20 | AW20 | AU19 |
| E27 | 18 | AV20 | AV18 |
| E28 | 14 | AR22 | AT19 |
| E29 | 12 | AV23 | AW17 |
| E30 | 10 | AW21 | AU18 |
| E31 | 8 | AU23 | AV17 |

| | |
|---|---|
| CLKA | 5 (CLK 3 on diagrams) |
| CLKB | 49 (CLK 4 on diagrams) |
| +5V | 1, 2 |
| +3V3 | 3, 4 |
| GND | 6, 7, 9, 16, 19, 26, 29, 36, 39, 46, 48, 50 |

SelectLink Interface

There is another 32 bit general purpose bus connecting the two FPGAs which may be used to implement a SelectLink interface to provide greater bandwidth between the two devices. The connections are set forth in Table 28:

TABLE 28

| | Master | Slave |
|---|---|---|
| SelectLink Line | FPGA pin | FPGA pin |
| SL0 | AV28 | AW11 |
| SL1 | AW29 | AT13 |
| SL2 | AT27 | AV11 |
| SL3 | AW30 | AU12 |
| SL4 | AU28 | AW10 |
| SL5 | AV30 | AU11 |
| SL6 | AV29 | AV10 |
| SL7 | AW31 | AT11 |
| SL8 | AU29 | AW9 |
| SL9 | AV31 | AU10 |
| SL10 | AT29 | AV9 |
| SL11 | AW32 | AT10 |
| SL12 | AU30 | AW8 |
| SL13 | AW33 | AU9 |
| SL14 | AT30 | AV8 |
| SL15 | AV33 | AW7 |
| SL16 | AU31 | AT9 |
| SL17 | AT31 | AV7 |
| SL18 | AW34 | AU8 |
| SL19 | AV32 | AW6 |
| SL20 | AV34 | AT8 |
| SL21 | AU32 | AV6 |
| SL22 | AW35 | AU7 |
| SL23 | AT32 | AU8 |
| SL24 | AV35 | AT7 |
| SL25 | AU33 | AW4 |
| SL26 | AW36 | AU6 |
| SL27 | AT33 | AV4 |
| SL28 | AV36 | AT6 |
| SL29 | AU34 | AV5 |
| SL30 | AU36 | AU4 |
| SL31 | AT34 | AV3 |

USB

The FPGAs have shared access to the USB chip on the board. As in the case of the Flash RAM, the FPGA needs to notify the CPLD that it has taken control of the USB chip by setting the USBMaster pin low before accessing the chip. For more information on the USB chip refer to the USB section of this document.

TABLE 29

| | | |
|---|---|---|
| USBMaster | D17 | D26 |
| USBMS | C16 | D27 |
| nRST | B15 | B27 |
| IRQ | D16 | C28 |
| A0 | A14 | A28 |
| nRD | B14 | B28 |
| nWR | C15 | B29 |
| nCS | A13 | A29 |
| D7 | D15 | C29 |
| D6 | B13 | A30 |
| D5 | C14 | D29 |
| D4 | A12 | B30 |
| D3 | D14 | C30 |
| D2 | C13 | A31 |
| D1 | B12 | D30 |
| D0 | D13 | A32 |

CPLD

The board is fitted with a Xilinx XC95288XL CPLD which provides a number of Glue Logic functions for shared RAM arbitration, interfacing between the ARM and FPGA and configuration of the FPGAs. The later can be used to either configure the FPGAs from power up or when one FPGA re-configures the other (Refer to section ‘Programming the FPGAs’). A full listing of ABEL code contained in the CPLD can be found in Appendix D.

Shared SRAM Bank Controller

The CPLD implements a controller to manage the shared RAM banks. A Request—Grant system has been implemented to allow each SRAM bank to be accessed by one of the three devices. A priority system is employed if more than one device requests the SRAM bank at the same time.

| | |
|---|---|
| Highest priority: | ARM |
| | Master FPGA |
| Lowest priority: | Slave FPGA |

The FPGAs request access to the shared SRAM by pulling the corresponding REQUEST signals low and waiting for the CPLD to pull the GRANT signals low in response. Control is relinquished by setting the REQUEST signal high again. The ARM processor is able to request access to the shared SRAM banks via some registers within the CPLD—refer to the next section.

CPLD Registers for the ARM

The ARM can access a number of registers in the CPLD, as shown in Table 30:

TABLE 30

| 0x00 | This is an address indirection register for register 1 which used | |
|---|---|---|
| | for the data access. | |
| | 0 | Write only FLASH Address A0-A7 |
| | 1 | Write only FLASH Address A8-A15 |
| | 2 | Write only FLASH Address A16-A24 |
| | 3 | Read / Write FLASH data (Access time must be at least |
| | 150ns) | |
| | 5 | Write Only USB control (RST / MS) |
| | | D0: USB RESET |
| | | D1: USB Master Slave |

| | |
|---|---|
| 0x04 | Data for register 0 address expanded data |
| 0x08 | Master FPGA access |
| 0x0C | Slave FPGA access |
| 0x10 | SRAM Arbiter |
| | D0: Shared SRAM bank 0 Request (high to request, low to |
| | relinquish) |
| | D1: Shared SRAM bank 1 Request (high to request, low to |
| | relinquish) |
| | D4: Shared SRAM bank 0 Granted (High Granted Low not |
| | Granted) |
| | D5: Shared SRAM bank 1 Granted (High Granted Low not |
| | Granted) |
| 0x14 | Status / FPGA control pins (including PLL control) |
| | Write |
| | D0: Master FPGA nPROGRAM pin |
| | D1: Slave FPGA nPROGRAM pin |
| | D2: Undefined |
| | D3: Undefined |
| | D4: PLL Serial clock pin |
| | D5: PLL Serial data pin |
| | D6: PLL Feature Clock |
| | D7: PLL Internal Clock select |
| | Read |
| | D0: Master FPGA DONE Signal |
| | D1: Slave FPGA DONE signal |
| | D2: FPGA INIT Signal |
| | D3: FLASH status Signal |
| | D4: Master FPGA DOUT Signal |
| | D5: Slave FPGA DOUT Signal |
| | D6: USB IRQ Signal |
| 0x18 | USB Register 0 |
| 0x1C | USB Register 1 |

CPLD Registers for the FPGA's

The FPGAs can access the CPLD by setting a command on the FPCOM pins. Data is transferred on the FPGA (Flash RAM) databus. See Table 31.

TABLE 31

| | |
|---|---|
| 0x0 | Write to Control Register |
| | D0: Master FPGA Program signal (inverted) |
| | D1: Slave FPGA Program signal (inverted) |
| | D2: Master FPGA chip select signal (inverted) |
| | D3: Slave FPGA chip select signal (inverted) |
| 0x3 | Sets configuration clock low |
| 0x5 | Read Status Register |
| | D0: Master FPGA DONE signal |
| | D1: Slave FPGA DONE signal |
| | D2: FPGA INIT signal |
| | D3: FLASH status signal |
| | D4: Master FPGA DOUT signal |
| | D5: Slave FPGA DOUT signal |
| | D6: USB IRQ signal |
| 0x7 | No Operation |

These commands will mainly be used when one FPGA reconfigures the other. Refer to the FPGA configuration section and the appropriate Xilinx datasheets for more information.

CPLD LEDs

Four LED's are directly connected to the CPLD. These are used to indicate the following:

D0 DONE LED for the Master FPGA Flashes during programming

D1 DONE LED for the Slave FPGA Flashes during programming

D2 Not used

D3 Flashes until an FPGA becomes programmed

Other Devices

USB

The board has a SCAN Logic SL11H USB interface chip, capable of full speed 12 Mbits/s transmission. The chip is directly connected to the FPGAs and can be accessed by the ARM processor via the CLPD (refer to the CPLD section of this document for further information). The datasheet for this chip is available at http://www.scanlogic.com/pdf/s111h/s111hspec.pdf

PSU

This board maybe powered from an external 12V DC power supply through the 2.1 mm DC JACK. The supply should be capable of providing at least 2.4 A.

Handel-C Library Reference

Introduction

This section describes the Handel-C libraries written for the board. The klib.h library provides a number of macro procedures to allow easier access to the various devices on the board, including the shared memory, the Flash RAM, the CPLD and the LEDs. Two other libraries are also presented, parallel_port.h and serial_port.h, which are generic Handel-C libraries for accessing the parallel and serial ports and communicating over these with external devices such as a host PC.

Also described is an example program which utilizes these various libraries to implement an echo server for the parallel and serial ports.

Also described here is a host side implementation of ESL's parallel port data transfer protocol, to be used with the data transfer macros in parallel_port.h.

The klib.h Library

Shared RAM Arbitration

A request—grant mechanism is implemented to arbitrate the shared RAM between the two FPGAs and the ARM processor. Four macros are provided to make the process of requesting and releasing the individual RAM banks easier.

KRequestMemoryBank0( );

KRequestMemoryBank1( );

KReleaseMemoryBank0( );

KReleaseMemoryBank1( );

Arguments

None.

Return Values

None.

Execution Time

KRequestMemoryBank#( ) requires at least one clock cycle. KReleaseMemoryBank#( ) takes one clock cycle.

Description

These macro procedures will request and relinquish ownership of their respective memory banks. When a request for a memory bank is made the procedure will block the thread until access to the requested bank has been granted.

Note: The request and release functions for different banks may be called in parallel with each other to gain access to or release both banks in the same cycle.

Flash RAM Macros

These macros are provided as a basis through which interfacing to the Flash RAM can be carried out. The macros retrieve model and status information from the RAM to illustrate how the read/write cycle should work. Writing actual data to the Flash RAM is more complex and the implementation of this is left to the developer.

KSetFPGAFBM( )

KReleaseFPGAFBM( )

Arguments

None.

Return Values

None.

Execution Time

Both macros require one clock cycle.

Description

Before any communication with the Flash RAM is carried out the FPGA needs to let the CPLD know that it is taking control of the Flash RAM. This causes the CLPD to tri-state the Flash bus pins, avoiding resource contention. KSetFPGAFBM( ) sets the Flash Bus Master (FBM) signal and KReleaseFPGAFBM( ) releases it. This macro is generally called by higher level macros such as KReadFlash( ) or KWriteFlash( ).

Note: These two procedures access the same signals and should NOT be called in parallel to each other.

KEnableFlash( )

KDisableFlash( )

Arguments

None.

Return Values

None.

Execution Time

Both macros require one clock cycle.

Description

These macros raise and lower the chip-select signal of the Flash RAM and tri-state the FPGA Flash RAM lines (data bus, address bus and control signals). This is necessary if the Flash RAM is to be shared between the two FPGAs as only one chip can control the Flash at any give time. Both FPGAs trying to access the Flash RAM simultaneously can cause the FPGAs to ‘latch up’ or seriously damage the FPGAs or Flash RAM chip. This macro is generally called by higher level macros such as KReadFlash( ) or KWriteFlash( ).

Note: These macros access the same signals and should NOT be called in parallel with each other.

KWriteFkash(address, data)

KReadFlash(address, data)

Arguments

24 bit address to be written or read.

8 bit data byte.

Return Values

KReadFlash( ) returns the value of the location specified by address in the data parameter.

Execution Time

Both procedures take 4 cycles.

The procedures are limited by the timing characteristics of the Flash RAM device. A read cycle takes at least 120 ns, a write cycle 100 ns. The procedures have been set up for a Handel-C clock of 25 MHz.

Description

The macros read data from and write data to the address location specified in the address parameter.

Note: These macros access the same signals and should NOT be called in parallel with each other.

KSetFlashAddress(address)

Arguments

24 bit address value.

Return Values

None.

Execution Time

This macro requires one clock cycle.

Description

The macro sets the Flash address bus to the value passed in the address parameter. This macro is used when a return value of the data at the specified location is not required, as may be the case when one FPGA is configuring the other with data from the Flash RAM since the configuration pins of the FPGAs are connected directly to the lower 8 data lines of the Flash RAM.

KReadFlashID(flash_component_ID, manufacturer_ID)

KReadFlashStatus(status)

Arguments

8 bit parameters to hold manufacturer, component and status information.

Return Values

The macros return the requested values in the parameters passed to it.

Execution Time

KReadFlashStatus( ) requires 10 cycles, KReadFlashID( ) requires 14 cycles.

Description

The macros retrieve component and status information from the Flash RAM. This is done by performing a series of writes and reads to the internal Flash RAM state machine.

Again, these macros are limited by the access time of the Flash RAM and the number of cycles required depends on rate the design is clocked at. These macros are designed to be used with a Handel-C clock rate of 25 MHz or less.

Although a system is in place for indicating to the CPLD that the Flash RAM is in use (by using the KSetFPGAFBM( ) and KReleaseFPGAFBM( ) macros) it is left up to the developers to devise a method of arbitration between the two FPGAs. As all the Flash RAM lines are shared between the FPGAs and there is no switching mechanism as in the shared RAM problems will arise if both FPGAs attempt to access the Flash RAM simultaneously.

Note: These macros access the same signals and should NOT be called in parallel with each other. Also note that these macros provide a basic interface for communication with the Flash RAM. For more in-depth please refer to the Flash RAM datasheet.

CPLD Interfacing

The following are macros for reading and writing to the CPLD status and control registers:

KReadCPLDStatus(status)

KWriteCPLDControl(control)

Arguments

8 bit word

Return Values

KReadStatus( ) returns an 8 bit word containing the bits of the CPLD's status register. (Refer to the CPLD section for more information)

Execution Time

Both macros require six clock cycles, at a Handel-C clock rate of 25MHz or less.

Description

These macros read the status register and write to the control register of the CPLD.

KSetFPCOM(fp_command)

Arguments

3 bit word.

Return Values

None.

Execution Time

This macro requires three clock cycles, at a Handel-C clock rate of 25 MHz or less.

Description

This macro is provided to make the sending of FP_COMMANDs to the CPLD easier. FP_COMMANDs are used when the reconfiguration of one FPGA from the other is desired (refer to the CPLD section for more information).

The different possible fp_command (s) are set forth in Table 32:

TABLE 32

| | |
|---|---|
| FP_SET_IDLE | Sets CPLD to idle |
| FP_READ_STATUS | Read the status register of the CPLD |
| FP_WRITE_CONTROL | Write to the control register of the CPLD |
| FP_CCLK_LOW | Set the configuration clock low |
| FP_CCLK_HIGH | Set the configuration clock high |

e.g.

KSetFPCOM(FP_READ_STATUS);

KSetFPCOM(FP_SET_IDLE);

Note: These macros access the same signals and should NOT be called in parallel with each other.

LEDs

KSetLEDs(maskByte)

Arguments

8 bit word.

Return Values

None.

Execution Time

One clock cycle.

Description

This macro procedure has been provided for controlling the LEDs on the board. The maskByte parameter is applied to the LEDs on the board, with a 1 indicating to turn a light on and a 0 to turn it off. The MSB of maskByte corresponds to D12 and the LSB to D5 on the board.

Note: Only one of the FPGAs may access this function. If both attempt to do so the FPGAs will drive against each other and may ‘latch-up’, possibly damaging them.

Using the Parallel Port

Introduction

The library parallel_port.h contains routines for accessing the parallel port. This implements a parallel port controller as an independent process, modeled closely on the parallel port interface found on an IBM PC. The controller allows simultaneous access to the control, status and data ports (as defined on an IBM PC) of the parallel interface. These ports are accessed by reading and writing to channels into the controller process. The reads and writes to these channels are encapsulated in other macro procedures to provide an intuitive API.

FIG. 11 shows a structure of a Parallel Port Data Transmission System 1100 according to an embodiment of the present invention. An implementation of ESL's parallel data transfer protocol has also been provided, allowing data transfer over the parallel port, to and from a host computer 1102. This is implemented as a separate process which utilizes the parallel port controller layer to implement the protocol. Data can be transferred to and from the host by writing and reading from channels into this process. Again macro procedure abstractions are provided to make the API more intuitive.

A host side application for data transfer under Windows95/98 and NT is provided. Data transfer speeds of around 100 Kbytes/s can be achieved over this interface, limited by the speed of the parallel port.

Accessing the Parallel Port Directly.

The 17 used pins of the port have been split into data, control and status ports as defined in the IBM PC parallel port specification. See Table 33.

TABLE 33

| Port Name | Pin number |
|---|---|
| Data Port | |
| Data 0 | 2 |
| Data 1 | 3 |
| Data 2 | 4 |
| Data 3 | 5 |
| Data 4 | 6 |
| Data 5 | 7 |
| Data 6 | 8 |
| Data 7 | 9 |
| Status Port | |
| nACK | 10 |
| Busy | 11 |
| Paper Empty | 12 |
| Select | 13 |
| nError | 15 |
| Control Port | |
| nStrobe | 1 |
| nAutoFeed | 14 |
| Initialise Printer | 16 |
| (Init) | |
| nSelectIn | 17 |

The parallel port controller process needs to be run in parallel with those part of the program wishing to access the parallel port. It is recommended that this is done using a par{ } statement in the main( ) procedure.

The controller procedure is:

parallel_port( pp_data_send_channel,

pp_data_read_channel,
pp_control_port_read,
pp_status_port_read,
pp_status_port_write);

where the parameters are all channels through which the various ports can be accessed.

Parallel Port Macros

It is recommended that the following macros be used to access the parallel port rather than writing to the channels directly.

PpWriteData(byte)

PpReadData(byte)

Arguments

Unsigned 8 bit word.

Return Values

PpReadData( ) returns the value of the data pins in the argument byte.

Execution Time

Both macros require one clock cycle.

Description

These write the argument byte to the register controlling the data pins of the port, or return the value of the data port within the argument byte respectively, with the MSB of the argument corresponding to data[7]. Whether or not the value is actually placed on the data pins depends on the direction settings of the data pins, controlled by bit 6 of the status register.

PpReadControl(control_port)

Arguments

Unsigned 4 bit word.

Return Values

PpReadControl( ) returns the value of the control port pins in the argument byte.

Execution Time

This macro requires one clock cycle.

Description

This procedure returns the value of the control port. The 4 bit nibble is made up of [nSelect_in @ Init @ nAutofeed @ nStrobe], where nSelect_in is the MSB.

PpReadStatus(status_port)

PpSetStatus(status_port)

Arguments

Unsigned 6 bit word.

Return Values

PpReadStatus( ) returns the value of the status port register in the argument byte.

Execution Time

This macro requires one clock cycle.

Description

These read and write to the status port. The 6 bit word passed to the macros is made up of [pp_direction @ busy @ nAck @ PE @ Select @ nError], where pp_direction indicates the direction of the data pins (i.e. whether they are in send [1] or receive [0] mode). It is important that this bit is set correctly before trying to write or read data from the port using PpWriteData( ) or PpReadData( ).

Note: All of the ports may be accessed simultaneously, but only one operation may be performed on each at any given time. Calls dealing with a particular port should not be made in parallel with each other.

Transferring Data to and from the Host PC

The library parallel_port.h also contains routines for transferring data to and from a host PC using ESL's data transfer protocol. The data transfer process, pp_coms( ), which implements the transfer protocol should to be run in parallel to the parallel port controller process, again preferably in the main par{ } statement. A host side implementation of the protocol, ksend.exe, is provided also.

pp_coms(pp_jsend_chan,—channel to write data to when sending

pp_recv_chan,—channel to read data from when receiving

pp_command,—channel to write commands to

pp_error)—channel to receive error messaged from.

The following macros provide interfaces to the data transfer process:

OpenPP(error)—open the parallel port for data transfer

ClosePP(error)—close the port

Note: Make sure that the host side application, ksend.exe, is running. The macros will try and handshake with the host and will block (or timeout) until a response is received. Also note that the following macros all access the same process and should NOT be called in parallel with each other.

Arguments

Unsigned 2 bit word.

Return Values

The argument will return an error code indicating the success or failure of the command.

Execution Time

This macro requires one clock cycle.

Description

These two macros open and close the port for receiving or sending data. They initiate a handshaking procedure to start communications with the host computer.

SetSendMode(error)—set the port to send mode

SetRecvMode(error)—set the port to receive mode

Arguments

Unsigned 2 bit word.

Return Values

The argument will return an error code indicating the success or failure of the command.

Execution Time

This macro requires one clock cycle.

Description

These set the direction of data transfer and the appropriate mode should be set before attempting to send or receive data over the port.

SendPP(byte, error)—send a byte over the port

ReadPP byte, error)—read a byte from the port

Arguments

Unsigned 8 bit and unsigned 2 bit words.

Return Values

ReadPP( ) returns the 8 bit data value read from the host in the byte parameter. Both macros will return an error code indicating the success or failure of the command.

Execution Time

How quickly these macros execute depend on the Host. The whole sequence of handshaking actions for each byte need to be completed before the next byte can be read or written.

Description

These two macros will send and receive a byte over the parallel port once this has been initialized and placed in the correct mode.

The procedures return a two bit error code indicating the result of the operation. These codes are defined as:

| | |
|---|---|
| #define PP_NO_ERROR | 0 |
| #define PP_HOST_BUFFER_NOT_FINISHED | 1 |
| #define PP_OPEN_TIMEOUT | 2 |

Note: SendPP and ReadPP will block the thread until a byte is transmitted or the timeout value is reached. If you need to do some processing while waiting for a communication use a ‘prialt’ statement to read from the global pp_yecv_chan channel or write to the pp_send_chan channel.

Typical macro procedure calls during Read/Write

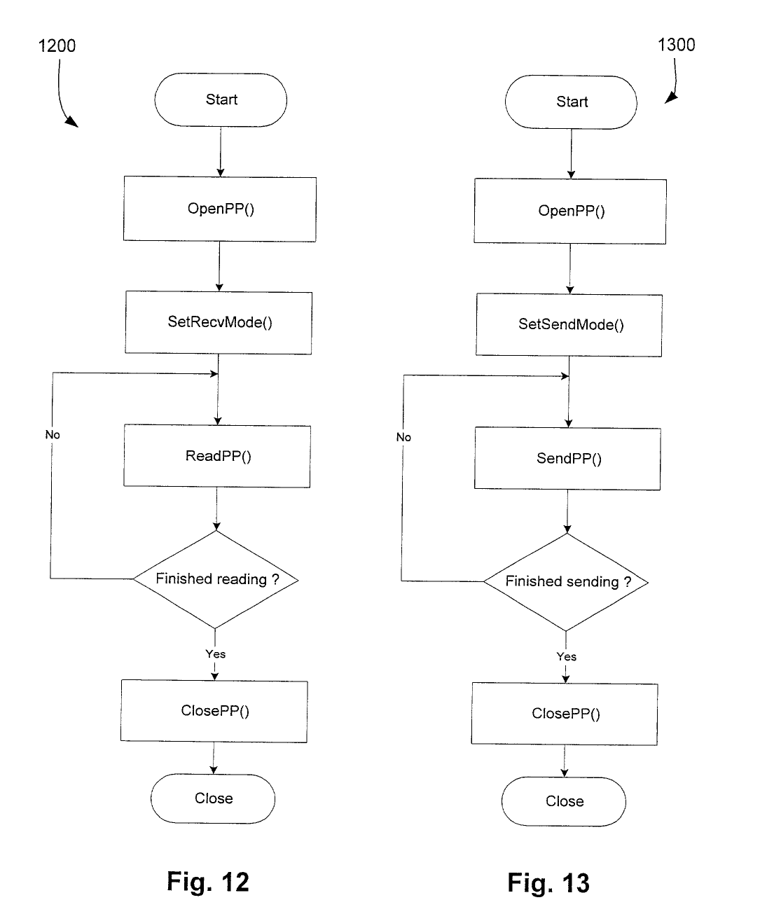

FIG. 12 is a flowchart that shows the typical series of procedure calls 1200 when receiving data. FIG. 13 is a flow diagram depicting the typical series of procedure calls 1300 when transmitting data.

The Ksend Application

The ksend.exe application is designed to transfer data to and from the board FPGAs over the parallel port. It implements the ESL data transfer protocol. It is designed to communicate with the pp_coms( ) process running on the FPGA. This application is still in the development stage and may have a number of bugs in it.

Two versions of the program exist, one for Windows95/98 and one for WindowsNT. The NT version requires the GenPort driver to be installed. Refer to the GenPort documentation for details of how to do this.

In its current for the ksend application is mainly intended for sending data to the board, as is done in the esl_boardtest program. It is how ever also able to accept output form the board. Again, please refer to the application note or the ksend help (invoked by calling ksend without any parameters) for further details.

Serial Port

Introduction

Each FPGA has access to a RS232 port allowing it to be connected to a host PC. A driver for transferring data to and from the FPGAs from over the serial port is contained in the file serial_port.h.

RS232A Interface

There are numerous ways of implementing RS232 interfacing, depending on the capabilities of the host and device and what cables are used. This interface is implemented for a cross wired null modem cable which doesn't require any hardware handshaking—the option of software flow control is provided, though this probably won't be necessary as the FPGA will be able to deal with the data at a much faster rate than the host PC can provide it. When soft flow control is used the host can stop and start the FPGA transmitting data by sending the XON and XOFF tokens. This is only necessary when dealing with buffers that can fill up and either side needs to be notified.

Serial Port Macros

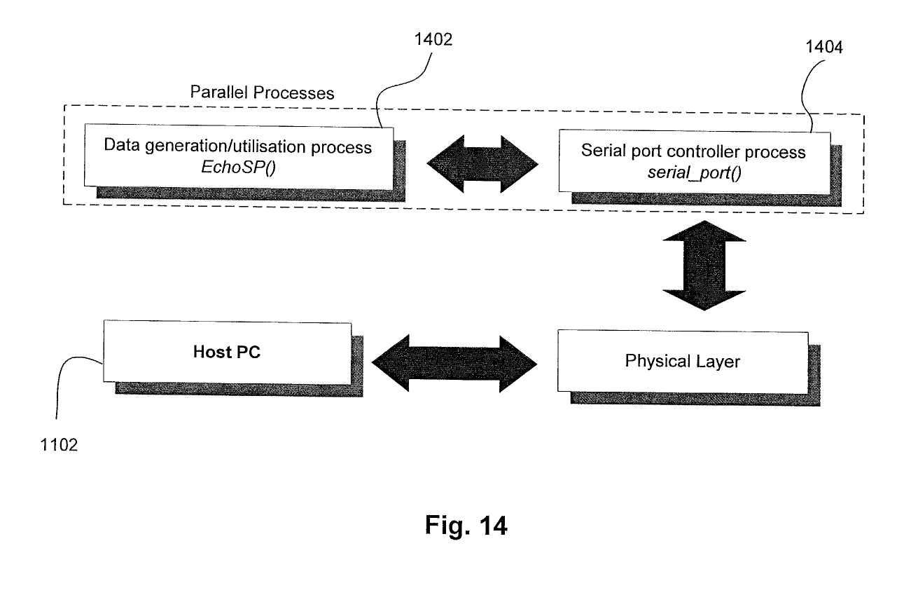

Serial port communications have been implemented as a separate process that runs in parallel to the processes that wish to send/ receive data. FIG. 14 is a flow diagram illustrating several processes 1402, 1404 running in parallel.

The serial port controller process is

serial_port(sp_input, sp_output);

where sp_input and sp_output are n bit channels through which data can be read or written out form the port. These reads and writes are again encapsulated in separate macro procedures to provide the user with a more intuitive API.

SpReadData(byte)—read a data byte from the port

SpWriteData(byte)—write a byte to the port

Arguments

n bit words, where n is the number of data bits specified.

Return Values

SpReadData( ) returns an n bit value corresponding to the transmitted byte in the argument.

Execution Time

The execution time depends to the protocol and the baud rate being used.

Description

These procedures send and receive data over the serial port using the RS232 protocol. The exact communications protocol must be set up using a series of #defines before including the serial_port.h library. To use an 8 data bit, 1 start and 1 stop bit protocol at 115200 baud on a null modem cable with no flow control the settings would be:

#define BAUD_RATE 115200

#define START_BIT ((unsigned 1)0)

#define STOP_BIT ((unsigned 1)1)

#define NUM_DATA_BITS 8

Other options are:

For soft flow control:

#define SOFTFLOW

#define XON <ASCII CHARACTER CODE>

#define XOFF <ASCII CHARACTER CODE>

RTS/CTS flow control:

#define HARDFLOW

The default settings are:

| | |
|---|---|
| Baud rate | 9600 |
| Start bit | 0 |
| Stop bit | 1 |
| Num. data bits | 8 |
| XON | 17 |
| XOFF | 19 |
| Flow control off | |

Any of the standard baud rate settings will work provided that the Handel-C clock rate is at least 8 times higher than the baud rate. Also ensure that the macro CLOCK_RATE is defined, this is generally found in the pin definition header for each of the FPGAs.

e.g.

#define CLOCK_RATE 25000000 // define the

clock rate

Example Program

Shown here is an example Handel-C program that illustrates how to use the parallel and serial port routines found in the serial_port.h and parallel_port.h libraries. The program implements a simple echo server on the serial and parallel ports. The SetLEDs( ) function from the klib.h library is used to display the ASCII value received over the serial port on the LEDs in binary.

// Include the necessary header files

#define MASTER

#ifdef MASTER

#include “KompressorMaster.h”

#else

#include “KompressorSlave.h”

#endif

#include “stdlib.h”

#include “parallel_port.h”

#include “klib.h”

// Define the protocol and include the file

#define BAUD_RATE 9600

#define NUM_DATA_BITS 8

#define NULLMODEM

#include “serial_port.h”

//////////////////////////////////
// Process to echo any data received by the parallel
port
// to verify it is working properly
macro proc EchoPP()
{

unsigned 8 pp_data_in;
unsigned 2 error with {warn = 0};
unsigned 1 done;
OpenPP(error); // initiate contact with host
while(!done)

{
// read a byte
SetRecvMode(error);
ReadPP(pp_data_in, error);
// echo it
SetSendMode(error);
WritePP(pp_data_in, error);
}

ClosePP(error); // close connection

}
//////////////////////////////////
// Process to echo any data received by the serial
port
// to verify it is working properly. We are always
// listening on the serial port so there is no need
to open it.
macro proc EchoSP()
{

unsigned 8 serial_in_data;
while (1)

{
SpReadData(serial_in_data); // read a byte

from the serial port

SetLEDs(serial_in_data);
SpWriteData(serial_in_data); // write it

back out

}

delay; // avoid combinational cycles

}
void main(void)
{

while(1)

{
par
{
EchoPP(); //Parallel port thread
EchoSP(); // Serial port thread
////// Start the services ////////
// Parallel Port stuff
pp_coms(pp_send_chan, pp_recv_chan,

pp_command, pp_error);

parallel_port(pp_data_send_channel,

pp_data_read_channel,

pp_control_port_read,

pp_status_port_read,pp_status_port_write);

// Serial port stuff //
serial_port(sp_input, sp_output);
}
}

}

The code can be compiled for either FPGA by simple defining or un-defining the ASTER macro—lines 1 to 5

More Information

Useful information pertaining to the subjects of this described herein can be found in the following: The Programmable Logic Data Book, Xilinx 1996; Handel-C Preprocessor Reference Manual, Handel-C Compiler Reference Manual, and Handel-C Language Reference Manual, Embedded Solutions Limited 1998; and Xilinx Datasheets and Application notes, available from the Xilinx website http://www.xilinx.com, and which are herein incorporated by reference.

Illustrative Embodiment

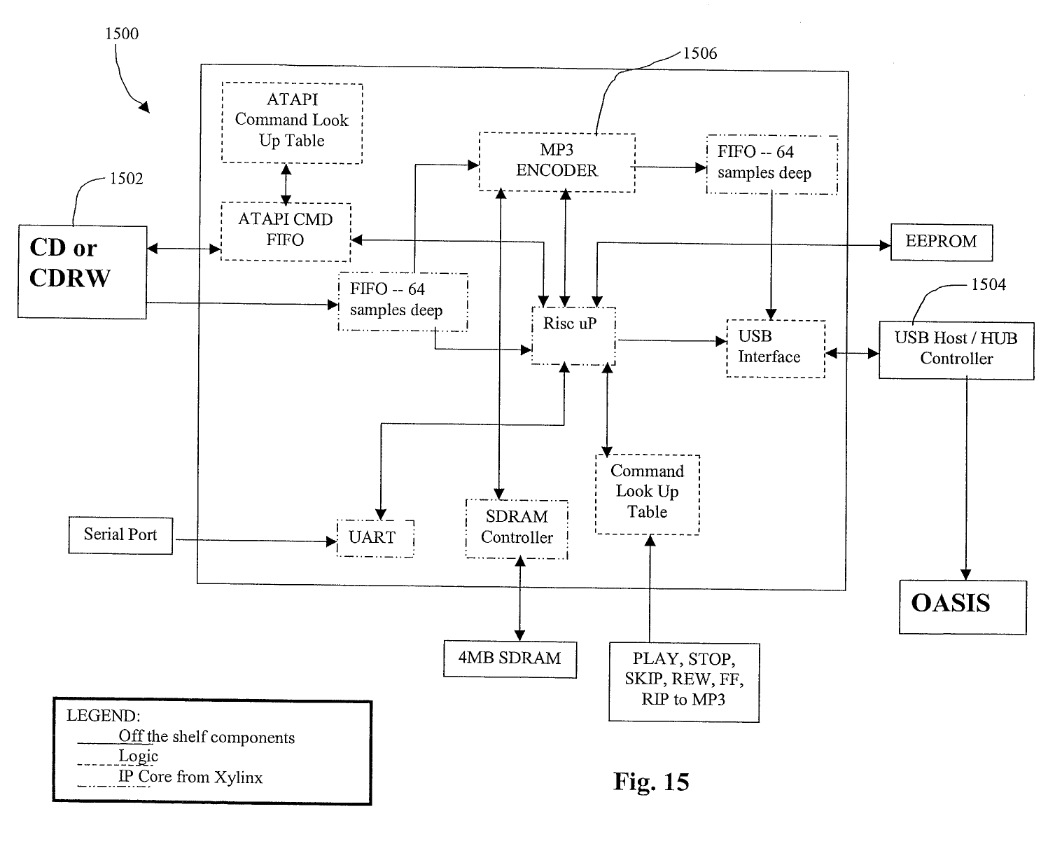

According to an embodiment of the present invention, a device encapsulates the Creative MP3 encoder engine in to an FPGA device. FIG. 15 is a block diagram of an FPGA device 1500 according to an exemplary embodiment of the present invention. The purpose of the device is to stream audio data directly from a CD 1502 or CDRW into the FPGA, compress the data, and push the data to a USB host 1504 which delivers it to the OASIS(Nomad 2) decoder. The entire operation of this device is independent of a PC.

The design of the FPGA uses the “Handel-C” compiler, described above, from Embedded Solutions Limited (ESL). The EDA tool provided by ESL is intended to rapidly deploy and modify software algorithms through the use of FPGAs without the need to redevelop silicon. Therefore the ESL tools can be utilized as an alternative to silicon development and can be used in a broader range of products.

Feature Overview

The FGPA preferably contains the necessary logic for the following:

MP3 Encoder 1506

User Command Look Up Table

play

pause

eject

stop

skip song (forward/reverse)

scan song (forward/reverse)

record (rip to MP3)->OASIS Unit

ATAPI

command and control

command FIFO

data bus

command bus

(2) 64 sample FIFOs (16 bit*44.100 kHz)

Serial Port (16550 UART) optionally EEPROM Interface (I2C & I2S)

USB Interface to host controller

SDRAM controller

32-bit ARM or RISC processor

In addition to the FPGA the following is preferably provided:

USB Host/Hub controller (2 USB ports)

4 MB SDRAM

128K EEPROM

9-pin serial port

6 control buttons.

40-Pin IDE Interface for CD or CDRW

Interfaces

ATAPI (IDE) Interface

User Interface

USB Interface

Network-Based Configuration

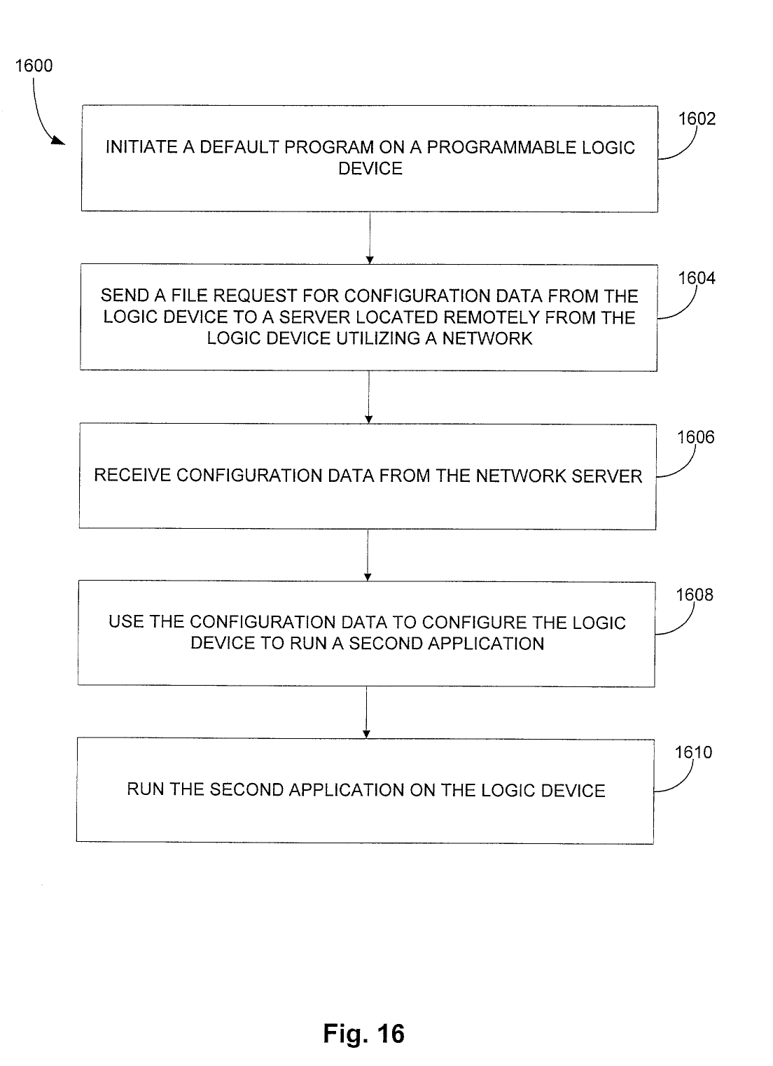

FIG. 16 illustrates a process 1600 for network-based configuration of a programmable logic device. In operation 1602, a default application is initiated on a programmable logic device. In operation 1604, a file request for configuration data from the logic device is sent to a server located remotely from the logic device utilizing a network. The configuration data is received from the network server in operation 1606, and can be in the form of a bitfile for example. In operation 1608, the configuration data is used to configure the logic device to run a second application. The second application is run on the logic device in operation 1610.

According to one embodiment of the present invention, the logic device includes one or more Field Programmable Gate Arrays (FPGAs). Preferably, a first FPGA receives the configuration data and uses that data to configure a second FPGA. The first and second FPGAs can be clocked at different speeds.

According to another embodiment of the present invention, the default application and the second application are both able to run simultaneously on the logic device. The logic device can further include a display screen, a touch screen, an audio chip, an Ethernet device, a parallel port, a serial port, a RAM bank, a non-volatile memory, and/or other hardware components.

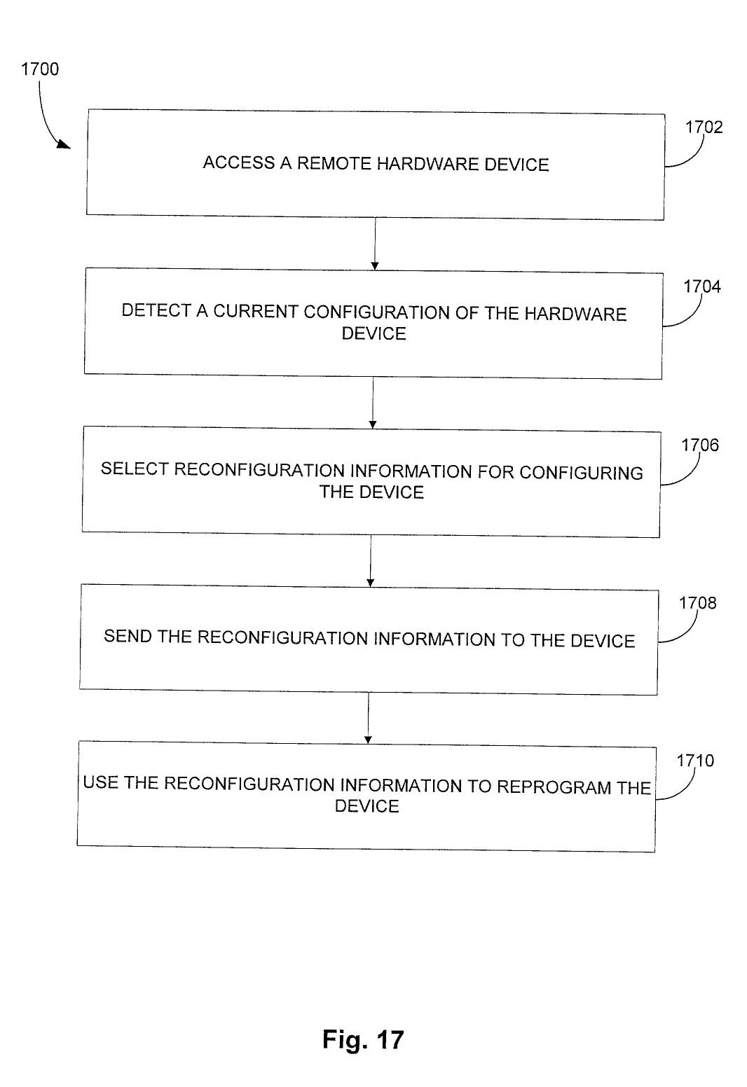

FIG. 17 illustrates a process 1700 for remote altering of a configuration of a hardware device. A hardware device is accessed in operation 1702 utilizing a network such as the Internet, where the hardware device is configured in reconfigurable logic. In operation 1704, a current configuration of the hardware device is detected prior to selecting reconfiguration information. Reconfiguration information is selected in operation 1706, and in operation 1708, is sent to the hardware device. In operation 1710, the reconfiguration information is used to reprogram the reconfigurable logic of the hardware device for altering a configuration of the hardware device.

The reconfiguration of the hardware device can be performed in response to a request received from the hardware device. In an embodiment of the present invention, the hardware device is accessed by a system of a manufacturer of the hardware device, a vendor of the hardware device, and/or an administrator of the hardware device.

In another embodiment of the present invention, the logic device includes at least one Field Programmable Gate Array (FPGA). Preferably, a first FPGA receives the reconfiguration information and uses the reconfiguration information for configuring a second FPGA.

Illustrative Embodiment

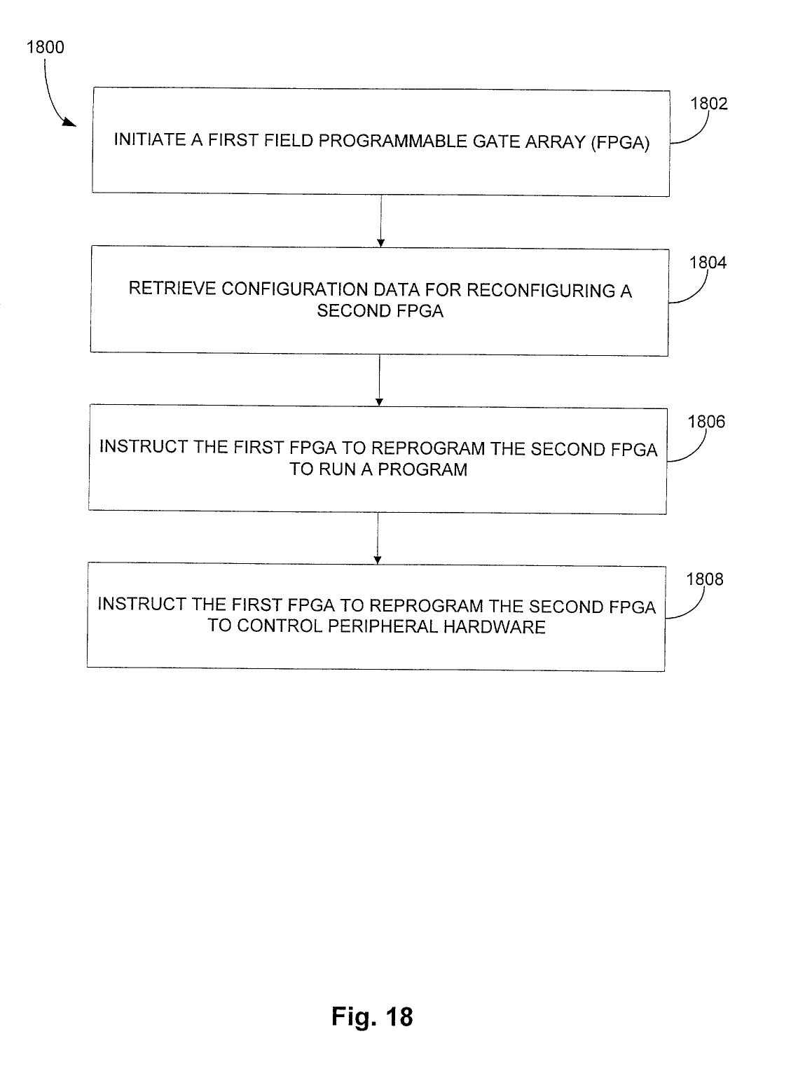

FIG. 18 illustrates a process 1800 for processing data and controlling peripheral hardware. In operation 1802, a first Field Programmable Gate Array (FPGA) of a reconfigurable logic device is initiated. The first FPGA is configured with programming functionality for programming a second FPGA of the logic device in accordance with reconfiguration data. The reconfiguration data for configuring the second FPGA is retrieved in operation 1804. In operation 1806, the first FPGA is instructed to utilize the reconfiguration data to program the second FPGA to run an application. In operation 1808, the first FPGA is instructed to user the reconfiguration data to program the second FPGA to control peripheral hardware incident to running the application.

In one embodiment of the present invention, data stored in nonvolatile memory is utilized for configuring the first FPGA with the programming functionality upon initiation of the first FPGA. In another embodiment of the present invention, the configuration data is retrieved from a server located remotely from the logic device utilizing a network. The configuration data can be received in the form of a bitfile.

The first and second FPGA's can be clocked at different speeds. Preferably, the logic device also includes a display screen, a touch screen, an audio chip, an Ethernet device, a parallel port, a serial port, a RAM bank, and/or a non-volatile memory.

Further Embodiments and Equivalents

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for generating revenue by charging for access to a library having a pre-compiled hardware configuration module therein, comprising the steps of:
(a) storing a plurality of hardware configuration modules in a library;
(b) prompting a customer for hardware configuration criteria;
(c) selecting a module from the library based on the criteria;
(d) sending the selected module to the customer; and
(e) charging the customer an amount of money.

2. A method as recited in claim 1, wherein the listing further includes modules stored in additional libraries.

3. A method as recited in claim 1, wherein the customer is a contractor using the module to generate a hardware description.

4. A method as recited in claim 1, wherein the customer is a reseller of hardware configuration modules.

5. A method as recited in claim 1, wherein the customer is allowed to submit a bid price for the module.

6. A method as recited in claim 5, wherein the bid is submitted to an auction system managed by a third party.

7. A method as recited in claim 1, wherein a listing of modules stored in the library is provided to a customer, wherein the customer is allowed to select the module from the list.

8. A method as recited in claim 1, wherein the hardware configuration criteria includes at least one of a desired functionality, a desired clock speed, a price, and a description of an I/O device.

9. A method as recited in claim 1, wherein the customer is prompted for further criteria if more than one module match the criteria.

10. A method as recited in claim 1, wherein the customer is allowed to select multiple modules, wherein the user is prompted for further criteria for selecting one of the multiple modules.

11. A method as recited in claim 1, wherein a help function is provided.

12. A computer program product for generating revenue by charging for access to a library having a pre-compiled hardware configuration module therein, comprising:
(a) computer code for storing a plurality of hardware configuration modules in a library;
(b) computer code for prompting a customer for hardware configuration criteria;
(c) computer code for selecting a module from the library based on the criteria;
(d) computer code for sending the selected module to the customer; and
(e) computer code for charging the customer an amount of money.

13. A computer program product as recited in claim 12, wherein the listing further includes modules stored in additional libraries.

14. A computer program product as recited in claim 12, wherein the customer is a contractor using the module to generate a hardware description.

15. A computer program product as recited in claim 12, wherein the customer is a reseller of hardware configuration modules.

16. A computer program product as recited in claim 12, wherein the customer is allowed to submit a bid price for the module.

17. A computer program product as recited in claim 16, wherein the bid is submitted to an auction system managed by a third party.

18. A computer program product as recited in claim 12, wherein a listing of modules stored in the library is provided to a customer, wherein the customer is allowed to select the module from the list.

19. A computer program product as recited in claim 12, wherein the hardware configuration criteria includes at least one of a desired functionality, a desired clock speed, a price, and a description of an I/O device.

20. A computer program product as recited in claim 12, wherein the customer is prompted for further criteria if more than one module match the criteria.

21. A computer program product as recited in claim 12, wherein the customer is allowed to select multiple modules, wherein the user is prompted for further criteria for selecting one of the multiple modules.

22. A computer program product as recited in claim 12, wherein a help function is provided.

23. A system for generating revenue by charging for access to a library having a pre-compiled hardware configuration module therein, comprising:
(a) logic for storing a plurality of hardware configuration modules in a library;
(b) logic for prompting a customer for hardware configuration criteria;
(c) logic for selecting a module from the library based on the criteria;
(d) logic for sending the selected module to the customer; and
(e) logic for charging the customer an amount of money.

24. A system as recited in claim 23, wherein the listing further includes modules stored in additional libraries.

25. A system as recited in claim 23, wherein the customer is a contractor using the module to generate a hardware description.

26. A system as recited in claim 23, wherein the customer is a reseller of hardware configuration modules.

27. A system as recited in claim 23, wherein the customer is allowed to submit a bid price for the module.

28. A system as recited in claim 27, wherein the bid is submitted to an auction system managed by a third party.

29. A system as recited in claim 23, wherein a listing of modules stored in the library is provided to a customer, wherein the customer is allowed to select the module from the list.

30. A system as recited in claim 23, wherein the hardware configuration criteria includes at least one of a desired functionality, a desired clock speed, a price, and a description of an I/O device.

31. A system as recited in claim 23, wherein the customer is prompted for further criteria if more than one module match the criteria.

32. A system as recited in claim 23, wherein the customer is allowed to select multiple modules, wherein the user is prompted for further criteria for selecting one of the multiple modules.

33. A system as recited in claim 23, wherein a help function is provided.
